(19) United States
(12) Patent Application Publication
(10) Pub. No.: US 2026/0321279 A1
(43) Pub. Date: Oct. 15, 2026

(54) Comprehensive real-time system for detecting, analyzing, and responding to harmful verbal attacks

(71) Applicant: ABHIJIT ANANT TELANG, Pune (IN)

(72) Inventor: ABHIJIT ANANT TELANG, Pune (IN)

(21) Appl. No.: 19/219,527

(22) Filed: May 27, 2025

Related U.S. Application Data
(60) Provisional application No. 63/785,923, filed on Apr. 9, 2025.

(51) Int. Cl. G10L 25/63; G10L 17/26; G10L 21/02; G10L 25/90

(52) U.S. Cl. CPC G10L 25/63; G10L 17/26; G10L 21/02; G10L 25/90

(57) ABSTRACT

The present invention discloses a multifaceted and comprehensive system for detecting, analyzing, and responding to harmful verbal attacks in real time. The system comprises a sound acquisition unit with directional microphones and digitization circuits to isolate voices. A attack behavior detection module analyzes speech for abuse indicators through tone, volume, pitch, and language patterns. Integrated with this is a person detector comprising a speaker identification module, aggressor-target classifier, voice signature matcher, speaker role tracker, and an identity correlation engine that links voiceprints to metadata including time, device, and location. A context module adapts detection sensitivity based on situational cues. A profiling engine maintains behavioral histories and aggression tactics, while a predictive simulator anticipates escalation risks. Real-time mitigation is provided via an intervention unit that blocks or censors harmful speech. Insights are displayed on cross-platform interfaces, including wearables, to enhance safety and awareness in personal, social, and professional interactions.

### TECHNICAL FIELD OF THE INVENTION

This application claims the benefit of U.S. Provisional Application No. 63/785,923 filed on Apr. 9, 2025. The present invention relates to the field of voice-based behavioral analysis and real-time communication monitoring. Particularly, the invention relates to a multifaceted and comprehensive system for detecting, analyzing, and responding to harmful verbal attacks.

### PREAMBLE TO THE DESCRIPTION

The following specification particularly describes the invention and the manner in which it is performed.

### BACKGROUND OF THE INVENTION

In the contemporary landscape of human communication, verbal attacks play a critical role across personal, professional, and digital environments. However, the rise of harmful verbal behavior-ranging from psychological abuse and harassment to aggressive distraction and manipulation-poses significant risks to individual well-being, workplace culture, and social harmony.

While advancements have been made in speech recognition, sentiment analysis, and natural language processing, these technologies are typically designed for general-purpose infotainment applications including transcription, virtual assistants, or sentiment tagging. They assume that the verbiage directed at consumer or user is non-toxic and pure communicational in nature. They lack the depth required to identify complex aggression patterns, contextual triggers, emotional tone shifts, and manipulative vocal tactics that characterize harmful verbal exchanges.

To date, there are no comprehensive, real-time solutions that holistically detect, analyze, and respond to harmful verbal attacks by combining acoustic signal processing, behavioral profiling, contextual classification, and adaptive intervention. There have been attempts to detect and monitor toxic content on online forums including on various social media platforms, however, not so much about the acoustic ones expressed verbally. The toxicities and malafide intent including causing confusion, misleading interpretation, distraction, psychological manipulation can have potentially devastating short term and long term consequences including but not limited to mischaracterization, damage to image overall impacting personal and professional interactions. So far, the audio analysis is restricted to learning about, replicating, filtering, amplifying and enhancing the signal for faithful and nuanced rendering on a variety of devices. There have been some novel approaches to this unaddressed problem lately. For instance, the prior art US20190220483A1 proposes an online multi-stage voice content moderation wherein a toxicity scorer is configured to provide a toxicity score as learnt by a machine learning system trained on pre-existing toxicity score datasets, in accordance with a content policy, for the speech content associated with a given user, wherein threshold based options are provided to introduce automated triggering of moderation. This prior art further mentions updating of toxicity scores based on moderator feedback. The toxicity categories mentioned in the prior art range from use of adult language, racial hate speech, violent speech, assault speech, gender hatred speech, misrepresentation, manipulation, bullying etc. The proposed system relies on a supervised learning approach with labeled toxicity datasets where both raw and weighted scores are computed as per content policy guidelines. Finally, the proposed system provides visual indications on speaking times by speakers, session start/end times, plotting length of toxicity indicators as a function of toxicity score, displaying portions of toxic speeches from session timeline, speaker identification, and corresponding links to including content per speaker/session. The prior art lacks however, specific insights and prescriptive advice into how systematic verbal aggression and manipulation manifests, changes, evolves over time/location/action of targeted individual and his/her situation including being in company of someone or being alone, whether at workplace or at home, whether during the day or in the night, whether doing a specific activity including exercise, work, play, dinner/lunch and more so, It further lacks the ability to use statistical and machine learning based insight generation to discover how the identified attack types are rendered, that is in terms of modulation based on pitch, tone, volume, use of phonetic resemblance). It further lacks the discovery and association with modus operandi including mind control tactics achieved through using methodical time based repetitions/enchantments, instructions or commands that are intended to condition target's behaviour, and which are interspersed into the verbiage. Other mind control tactics including alterations or alternation in tone, pitch, and volume respectively, echoing, jockeying on target's voice characteristics including on volume, tone, and pitch respectively so as to impact work and quality of life. Further the prior art lacks in automated profiling of various attackers based on an associative and variance analysis of how their attacks vary based on time, location, activity of target and the situational context of target, how such attacks have evolved over time, whether an attacker has engaged in one or more forms of attacks and how such is influenced by both target's situation and activity as well as collaboration if any, with other attackers. Lastly, the prior art concerns itself with online, multi-user platforms and corresponding user interactivity sessions. It does not concern itself with how an automated detection, analysis and profiling of various verbal attacks can be made to function inside assemblies of wearable devices so as to provide timely intervention including zapping, optionally reporting and providing synesthetically visual display indications of verbal attacks throughout the day as the user moves around and goes about in life. Prior art does not envisage itself providing insights including who has/have stalked or followed you recently, what leader/follower assemblies of attackers have emerged, how verbal attack selection has changed for a given attacker, what kind of attacks grow during the evenings/night versus rest of the day, which activity of targeted person attracts a peculiar form of attack and the odds, and so on and so forth. In such a situation, the attackers are not restricted to online forums only but can include any person who happens to be around the targeted person's whereabouts and activity at the time. Hence the prior art lacks the comprehensive, real time overview comprising insights and notifications to act on, on a wearable device of choice including but not limited to a smart glass or smart watch. Finally, Prior Art lacks in ability to predict and simulate what kind of attacks to anticipate on a given time, location and activity, and in a specific situation including being alone or in company of, and further, who if present in the vicinity, is most likely to engage in such attacks.

Therefore, there is a need for a multifaceted and comprehensive system for detecting, analyzing, and responding to harmful verbal attacks in real time

### OBJECT OF THE INVENTION

The principal object of the invention is to provide a multifaceted voice-based analysis framework that detects, classifies, and responds to harmful verbal attacks, including terrorizing, sloganing or propagandism, threats, harassment, shaming/bullying, distraction, disinformation, and psychological abuse including mind control in real time.

Another object of the invention is to enable the identification of distinct voice signatures and assign unique identifiers to aggressors and targets for individualized profiling and behavior tracking.

Yet another objective of the invention is to provide dynamic classification of verbal attacks based on phrase recognition and their renderings thereof based on tone, pitch, volume, and, supported by emotional and contextual cues.

Yet another objective of the invention is to uniquely identify a given voice, distinguishing aggressors from targets, and linking voice signatures with contextual metadata for accurate behavioral tracking

Another objective of the invention is to create and continuously update behavior profiles for aggressors and targets using behavioral, linguistic, and contextual metadata.

Yet another objective of the invention is to enable detection of recurring aggression tactics, including repetition, mocking, sound jockeying, and emotional alternation through specialized analysis modules.

Another objective of the invention is to incorporate real-time response mechanisms, including selective muting or blocking and reporting of harmful speech in its entirety or relevant snippets thereof using predefined behavioral thresholds.

Another objective of the invention is to forecast future verbal attack likelihoods using predictive modeling based on historical aggression patterns witnessed given a targeted person's situational context including but not limited to time, location, activity, and social behavior dynamics including whether alone or in company at the time.

Yet another objective of the invention is to provide multi-platform support for monitoring, alerting, and visualizing verbal or audio attack insights across mobile devices, desktops, and wearable displays including but not limited to headphones, earplugs, smart glasses, and smart watches.

These and other objects and characteristics of the present invention will become apparent from the further disclosure to be made in the detailed description given below.

### SUMMARY OF THE INVENTION

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter

One aspect of the present invention is to provide a multifaceted voice-based detection and response framework that integrates a sound acquisition unit, an attack behaviour detection module, a context classification module, a person detector, a data analytics and visualization engine, a profiling engine, a reactive intervention unit, a learning and memory module, user interface system.

Another aspect of the invention is to provide a sound acquisition unit comprising a microphone array and a digitization circuit to capture ambient verbal attacks and a voice detector to isolate distinct voice signatures to differentiate between aggressors and targets.

Another aspect of the invention is to utilize an attack category detection module to analyze the voice stream using multiple attack type detectors including but not limited to threats, terrorizing, sexual slurs, degradation, disinformation, manipulation/mind control, shaming, bullying, degradation, and any other user defined attack categories where signature objectionable phrases aka red flags for each specified attack types are detected. tone as detected through tone variation or modulation analyzers, pitch as detected through pitch variation or modulation detectors and volume modulation monitors to detect attacks of various kinds as specified and customized by the user.

Yet another aspect of the invention is to implement a context classification module that evaluates metadata, including location, time, activity, environmental noise, and life or situational context, including personal, professional, or social, thereby improving classification accuracy and situational awareness.

Yet another aspect of the invention is to implement a voice signature detector that uniquely and consistently identifies speakers, distinguishes aggressors from targets, and correlates identities with context to enhance behavioral analysis accuracy.

Another aspect of the invention is to employ a data analytics and visualization engine to process captured voice and contextual data using statistical and machine learning techniques to identify attack occurrence and recurrence patterns, alternating patterns, aggregate trends, variations in attack types and corresponding phrases uttered by location, time and activity, by being alone or being with someone, corresponding tone, volume, pitch, trends, adversarial copying of phrases used by targeted person and corresponding pitch, tone, volume, any other evolutions and variations in both attacks and attackers over time.

Another aspect of the invention is to generate and update individual behavior profiles using a profiling engine that tracks voice attack patterns including time since first involved in attack behaviour, attack types and influence and variation of corresponding triggers including time, location, activity and target being alone/with someone, for each attacking voice, the corresponding rendering of such attack types including through voice tone shifts, volume and pitch changes and emerging social behavioral group or cohort formation among attackers, including but not limited to lone actor or pack leader and corresponding followers, drift or shift over time in this voice's attack types or use of phrases, correlation of such drift or shift with target's activities, spread/contraction in attack variety for each attacking voice and correlation with target's activities, attack signatures by the attacking voice comprising of trigger points, duration of attack, changes in correlation with location, activity, time and words uttered by target, sequence followed if any, moments inviting participation from others or joining such attacks by others.

Yet another aspect of the invention is to provide a reactive intervention unit that issues real-time responses including alerting, reporting, muting/zapping, wherein tightening or relaxing zapping criteria for one or more attack category is based on voice specific policy customization based on user feedback, upon detection of one or more types of attack types,

Another aspect of the invention is to recognize and record portions of offending phrases with corresponding attack labels, simultaneously with the reactive intervention aspect.

Another aspect of the invention is to arrange attack recordings by attack category, intensity, location, time, activity respectively, and present and execute curated queries, and present insights including attack theme, which is type and sequence and association or correlation with other attack types, or with user's location, activity, and other situational context, and corresponding rendering of attacks, as characterized by modulations in pitch, volume and tone respectively, and corresponding modus operandi including repetitions/enchanting, alternations, jockeying, echoing, mocking, and issuance of command/instructions and association, or correlation if any, that such rendering and modus operandi of attacks respectively may have with user's location, activity, and other situational context.

Another aspect of the invention is to present reasoning behind these insights including use and dominance in occurrence of phrases, corresponding recurrence based on location, time, activity, and situational context of targeted person including being in company or alone.

Another aspect of the invention is to integrate the profiling and behavior tracking logic into a wearable-compatible interface, enabling users to receive alerts and view predictive and prescriptive insights via but not limited to earplugs, headphones, smart glasses, smartwatches, or mobile devices.

Another aspect of the invention is to provide a continuous learning/updating module that stores and continuously updates, Attack category types, phrases/keywords used per attack type, pitches, tones, volume based associations with given phrases/keywords, newly discovered voices for profiling, associations of given voice/s with attack category types, duration of attacks by category type, shift and drift of attacks over time into other attack categories, newly discovered attack types by voice, intensity fluctuations in attacks (volume, frequency, pitch, tone, harshness, vulgarity, obnoxiousness), association of attack types with location, time and activity, curated queries for profiled voice for each recognized attack type.

Another aspect of the invention is to support predictive modeling and rendering of results to anticipate verbal attacks of various types, and adapt responses based on evolving attack patterns based on time, location, activity and other situational contexts including whether in company or alone

Another aspect of the invention is to provide a process for detecting, analyzing, and responding to harmful verbal attacks, comprising the steps of: capturing real-time verbal attacks through a microphone array and digitizing them into audio streams; isolating and identifying distinct voice signatures using a voice detector; comparing each voice against stored profiles to assign unique user identities to newly detected voices or update existing ones; analyzing the audio through an attack behavior detection module to identify verbal attack patterns by analyzing the phrases used, and their rendition thereof through modulation of tone, pitch, and volume respectively, classifying the context of the interaction using semantic and metadata cues; processing the data through a statistical and computational engine to detect behavioral trends, occurrences, recurrences, associations, correlations and outliers/unusual occurrences if any; updating the attack behavior profile of each voice with new behavioral and contextual data; determining the modus operandi by analyzing attack patterns including tone or pitch or volume jockeying, mockery, alternation, echoing or mind control behavior; activating a real-time intervention response that is adaptive to user feedback to become more or less tolerant; and storing the complete interaction in a continuously learning module for future reference and predictive and prescriptive analysis and continuously delivering the insights and corresponding options to respond, to user over wearable device of choice

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

In the following description, for the purposes of explanation, numerous specific details are set forth to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form to avoid unnecessarily obscuring the embodiments of the invention.

FIG. 1 illustrates the components of a multifaceted and comprehensive module-based architecture for detecting, analyzing, and responding to harmful verbal attacks.

FIG. 2 illustrates a method of a multifaceted and comprehensive system for detecting, analyzing, and responding to harmful verbal attacks.

FIG. 2A illustrates a flow-based process for constructing predictive models of verbal attack behavior using contextual and behavioral voice data.

FIG. 2B illustrates predictive analysis and forecasting of verbal attacks based on real-time contextual and behavioral factors.

FIG. 3 illustrates the voice detector initiating the detection and classification process by capturing live audio input via the audio processing unit.

FIG. 4 illustrates examples from the Phrase Repositories, showcasing categorized trigger words and expressions commonly associated with various types of harmful verbal attacks.

FIG. 5 illustrates the pitch detector configured to assess reactive pitch swing behaviors between an aggressor and a target.

FIG. 6 illustrates the phrase and tone detectors analyzing how phrase types vary with tone during verbal attack rendering.

FIG. 7 illustrates the attack behavior detection module performing initial detection and categorization of harmful verbal attacks based on audio features.

FIG. 8 illustrates the context classification module enabling real-time situational awareness by capturing environmental metadata, including location, time, and activity.

FIG. 9 illustrates a visualization presenting a detailed breakdown of harmful verbal attacks across disinformation, degradation, sexual slurs, and threats/intimidation categories.

FIG. 10 illustrates a data analytics and visualization technique for assessing the evolution of harmful language through fuzzy clustering and probability-based classification.

FIG. 11 illustrates a classification model deployed for human activity recognition.

FIG. 12 illustrates identifying triggers that can adapt to user feedback, for potential attacks through an interactive interface, analyzing significant phrases.

FIG. 13 illustrates performing contextual behavioral analysis computing odds of likelihood using conjoint analysis or regression techniques on multimodal data within the analytics engine.

FIG. 14 (A-C) illustrates visualizing harmful verbal attacks via pie charts showing modus operandi, social behavior, and rendering.

FIG. 14A illustrates a pie chart visualization depicting distribution of modus operandi of attacks suffered by the target.

FIG. 14B illustrates a pie chart visualization depicting distribution of social behavioral patterns of such attacks.

FIG. 14C illustrates a pie chart visualization depicting distribution of rendering mechanisms of such attacks.

FIG. 15 (A-B) illustrates analyzing pattern likelihoods by examining statistical associations in harmful verbal attacks.

FIG. 15A illustrates a heatmap outlining likelihoods of listed modus operandi being utilized per attack type.

FIG. 15B illustrates a bar chart depiction outlining preference towards using one specific attack method versus others as discovered among attacking voice/s.

FIG. 16 illustrates temporal analysis of threat behaviors across speakers using the data analytics, profiling, and modus operandi engines.

FIG. 17(A-B) illustrates analyzing whether utterances by Voice #N are triggered by the Target's Location.

FIG. 17A illustrates a tabular representation of concurrent factors namely target's location in this instance, to explore whether an association between where target happens to be and attacks exists for a given target.

FIG. 17B illustrates estimation of such association using widely known statistical methods such as Chi.square test as one possible method followed by possible next steps.

FIG. 18(A-B) illustrates analyzing time-of-day correlation with utterance or non-utterance frequency.

FIG. 18A illustrates a tabular representation of concurrent factors namely a time bracket in this instance, to explore whether an association between time and attacks exists for a given target.

FIG. 18B illustrates estimation of such association using widely known statistical methods such as Chi.square test as one possible method followed by possible next steps.

FIG. 19(A-B) illustrates analyzing if voice #nl's attack timing correlates with the target's detected activity patterns.

FIG. 19A illustrates a tabular representation of concurrent factors namely time, location and one possible activity of target and corresponding recording of attack utterance instances.

FIG. 19B illustrates a tabular representation of concurrent factors namely time, location and other possible activities excluding that laid out earlier in FIG. 19A, of target and corresponding recording of attack utterance instances, to facilitate application of appropriate statistical or machine learning methods towards drawing an inference in terms of likelihoods or odds.

FIG. 20 illustrates the analysis of sonic attack types by Voice #N1 based on the target's activity for a given location or time context.

FIG. 21(A-B) further illustrates analyzing utterance or attack types by Voice #N1 based on target activities and contextual triggers including location and time.

FIG. 21A illustrates an attack record (focussing on one attack type at a time) wherein, attacks on target are grouped by target's situational context such as location in this instance, and activity.

FIG. 21B illustrates an analytical model of computing likelihoods or odds of given attack type, given that target happens to be at given situational context such as location in this example, versus other possible locations, and similarly, doing a particular activity at the time, versus any other activity.

FIGS. 22 and 23 illustrate conjoint analysis to assess audio features including pitch, tone and method or modus operandi influence on “Sexual Slurs” and “Threats Intimidation.”

FIG. 24(A-F) illustrates analyzing contextual factors' influence on utterance types like “Disinformation” and “Threats/Intimidation” for Voice #N1.

FIG. 24A illustrates relative odds of the target suffering from disinformation attacks when the target is at a given location versus others.

FIG. 24B illustrates relative odds of the target suffering from disinformation attacks when the target is speaking to someone versus doing other activities.

FIG. 24C illustrates relative odds of the target suffering from threats or intimidation attacks when the target is at a given location versus others.

FIG. 24D illustrates relative odds of the target suffering from threats or intimidation attacks when the target is speaking to someone versus doing other activities.

FIG. 24E illustrates relative odds of the target suffering from alternating trash attacks when the target is speaking to someone versus doing other activities.

FIG. 24-F illustrates the need to collect above mentioned insights for each Targeting Voice #at each location, for each activity type visited by Target of Interest.

FIG. 25 illustrates using logistic regression to analyze the social context's impact on inviting various types of verbal attack from Voice #N1.

FIG. 26(A-CD) illustrates predictive analysis based insights to assess the likelihood of inviting utterances or no utterances based on target context including time, location and activity.

FIG. 26A illustrates predictive analysis on relative odds of Alternating_Trash attack type, given target's situational context (location, time, activity) and social context (being along or being with someone)

FIG. 26B illustrates predictive analysis on relative odds of Disinformation attack type, given target's situational context (location, time, activity) and social context (being along or being with someone)

FIG. 26A illustrates predictive analysis on relative odds of Alternating_Trash attack type, given target's situational context (location, time, activity) and social context (being along or being with someone).

FIG. 26B illustrates predictive analysis on relative odds of Disinformation attack type, given target's situational context (location, time, activity) and social context (being along or being with someone).

FIG. 26C illustrates predictive analysis on relative odds of Threats/Intimidation attack type, given target's situational context (location, time, activity) and social context (being along or being with someone).

FIG. 26D illustrates inference drawn about odds of being attacked verbally considering the aggregation of such attacks about given target in given situational and social context.

FIG. 27(A-D) illustrates the assessing how target s situational context including location, activity and being in company influence the likelihood of inviting various types of verbal attacks by Voice #N1.

FIG. 27A illustrates how certain attack types such as Disinformation may vary depending on the social context and depending on activity

FIG. 27B illustrates how certain attack types such as Sexual slurs may vary depending on the social context and depending on the activity.

FIG. 27C illustrates how certain attack types such as threats or intimidation may vary depending on the social context and depending on the activity.

FIG. 27D illustrates an aggregation step where attack types are aggregated per attack voice per social, situational, or activity context of target.

FIG. 28(A-C) illustrates analyzing associations and correlations between phrase types and voice gender.

FIG. 28A illustrates investigating association between phrases uttered and demographics such as Gender of voices.

FIG. 28B illustrates investigating odds of attack phrase utterances among demographics such as Gender of voices.

FIG. 28C illustrates a conclusion drawn predicting how more or less likely one demographic factor such as gender over another, in uttering attack phrases using a particular rendering tactic and utilizing a particular modus operandi.

FIG. 29 illustrates investigating phrase categories and subsequent attacks by specific voices, visualized through tables and graphs.

FIG. 30 illustrates clustering phrase data and visualizing classification reliability with silhouette plots.

FIG. 31 illustrates detecting phonetically resembling attacks, clustering utterances by phonetic similarity to distinguish coherent verbiage from incoherent or nonsensical and toxic realms.

FIG. 32 illustrates analyzing and contrasting phonetic and semantic clusters to uncover cognitive manipulation through word associations.

FIG. 33(A-B) illustrates clustering allocation likelihoods associated with spoken words for phonetic and semantic similarity respectively, to detect mimicry and manipulation patterns.

FIG. 33A illustrates assignment of phonemes to clusters based on phonetic similarity based clustering.

FIG. 33B illustrates assignment of phrases to clusters based on semantic similarity based clustering.

FIG. 34 illustrates a conceptual representation of collected voices and insights derived thereof over time, categorized and stored in the insights database.

FIG. 35 illustrates the framework of recognizing similarities in use of phrases and phonetics, through use of clustering algorithms where similarity or dis-similarity metrics are applied to distinguish coherent verbiage from nonsensical or incoherent and toxic realms.

FIG. 36 illustrates modus operandi detector, identifying stalking behavior through analysis of historical verbal patterns satisfying assessment criteria corresponding to each attack type.

FIG. 37 illustrates a modus operandi detector analyzing speech over time to detect mind control tactics.

FIG. 38(A-B) illustrates the system detecting timely recurrent patterns in verbiage as one example and injecting instructions or command words to attempt subconscious control as another example, as a marker of mind control.

FIG. 38A illustrates use of time series analysis techniques such as auto-correlation and partial auto-correlation plots in uncovering mind control instruction repetition pattern.

FIG. 38B illustrates detecting mind control keyphrases intermixed in apparently normal conversation in an attack pattern.

FIG. 39(A-B) illustrates a system detecting mind control behavior through timely recurrent name-calling.

FIG. 40 illustrates detection of stalking as one example of the modus operandi of a specific form of mind control attack through voice behavior suggesting pursuit across locations using the modus operandi detector.

FIG. 41 illustrates statistical likelihood analysis of a voice chasing the target across locations or some location/s in particular

FIG. 42 illustrates detection and visualization of verbal attack patterns and alternations over time using clustering and alternation analysis.

FIG. 43 illustrates the logic of the alternation detector analyzing tonal shifts in claims to identify manipulation and mockery patterns.

FIG. 44 (A-C) illustrates detecting alternating uplifting and derogatory language as modus operandi for a kind of mind control attack.

FIG. 44A illustrates assembling a bag of descriptors using a linear weighted combination where weight assigned to the extracted frequency component depends on the nature of the tone. This is a simplified aggregate representing the net tonal impression of the attack.

FIG. 44B illustrates how net tonal impressions of a set of phrase expressions are represented as a vector using the weighted sum depicted in FIG. 44A.

FIG. 44C, a time domain and frequency domain visualization of net tonal impression as attack patterns are witnessed. Alternating attack pattern is illustrated.

FIG. 45 (A-D) illustrates profiling a suspect stalker's verbal attack behavior over time.

FIG. 45A illustrates aggregate distribution of a suspect stalker's historical attacks (“What is uttered?”) among various attack categories with additional insights on tendencies expressed in terms of statistical likelihoods or in terms of % distribution.

FIG. 45B illustrates situational (location, time, activity) triggers for such attacks. (“What triggers attacks?”).

FIG. 45C illustrates what an attacker does while carrying out such attacks. (“What is done while uttering so?”)

FIG. 45D illustrates the social behavioural uplifting or suppressing effects on such attacks. (“With Whom/Upon Whose Guidance such is done?”.

FIG. 46 (A-E) illustrates generating a behavioral profile of Voice #1, mapped to an attack signature framework listing attack categories and phrases, corresponding rendering using tone, pitch, phonetics and volume, the quality of life objective of such attacks, the method or modus operandi of such attacks, and the emerging sociological, behavioural formations among attacker/s.

FIG. 46A illustrates the aggregate view of attacks, attack categories and distribution thereof and corresponding variation by situational context such as location, time and activity respectively, as suffered by a given target due to a given attacker.

FIG. 46B illustrates the method of rendering attacks expressed in terms of tone, pitch, volume and phonetics modulation.

FIG. 46C illustrates the objective of attacks on target expressed in terms of life categories.

FIG. 46D illustrates the modus operandi of attacks on target expressed in terms of techniques such as Repetitions, Jockeying, Mocking, Alternation, and Echoing.

FIG. 46E illustrates the social/behavioural patterns such as leader/follower, cohort formations and lone actors, emerging from attacks on target.

FIG. 47 illustrates the sound jockeying detector identifying adversarial synchronization or locking patterns in vocal delivery, particularly in volume, pitch, and tone.

FIG. 48 illustrates analyzing volume synchronization patterns between an aggressor and target speaker.

FIG. 49 illustrates the jockeying detector identifying and clustering individuals based on their sound jockeying behavior.

FIG. 50 illustrates the jockeying detector identifying and clustering pitch jockeying behaviors based on correlation metrics.

FIG. 51 illustrates analyzing reactive tone patterns to identify unexpressed antagonism through opposite sentiment analysis.

FIG. 52 illustrates integrating analytics and modus operandi detectors to classify toxic or incoherent speech via clustering.

FIG. 53 illustrates identifying deceptive acoustic manipulation based on phonetic resemblance.

FIG. 54 illustrates the system detecting location-based stalking patterns including the discovery of social behavioural patterns among attackers by mapping voice activities across locations.

FIG. 55 illustrates analyzing location-based stalking and mutually encouraging or curbing influence among attacker voices and whether such tendencies vary by locations.

FIG. 56 illustrates identifying time-based stalking behaviors and analyzing social encouragement or curbing influence between voices and whether such tendencies vary by locations.

FIG. 57 illustrates identifying complicity and conspiring acts in stalking based on time-contextual behavior.

FIG. 58 illustrates detecting coordinated attack patterns and leader/follower roles via voice social network profiling.

FIG. 59 illustrates a real-time interrupter with a cognitive firewall managing verbal attacks through real-time decision-making processes.

FIG. 60 (A-C) illustrates the user defined policy based configuration and control of cognitive firewall for real-time management of audio streams.

FIG. 60A illustrates a cognitive firewall layer governed by user defined policy based configuration and control to detect and counter attack voices.

FIG. 60B illustrates a declarative policy artifact depicting placeholders for specifying countermeasures such as zapping and reporting attack voices upon detection and further customizing tolerances for issuing such measures per attack voice per attack category.

FIG. 60C illustrates countermeasure rulesets specifying which attack phrases, with which rendering mechanisms, with which modus operandi to zap and report and further customize tolerances for doing so depending on the attack voice.

FIG. 61 illustrates detecting and analyzing behavioral shifts in use of attack types, over time, in a given voice of an attacker, harmful language based on historical fuzzy cluster data.

FIG. 62 illustrates detecting attack types, demarcating them on audio recordings, aggregating occurrences by attack types, storing generated insights in database and presenting curated queries for users to look up and respond to harmful behaviors.

FIG. 63 illustrates a system for detecting disinformation attacks through fact checks against such attacks, by generating curated queries for verification.

FIG. 64 illustrates the system doing preparatory work to detect disinformation attacks including by learning facts about a target's life from online, verifiable sources.

FIG. 65 illustrates the system generating curated queries to retrieve document/resource locators referenced in an instruction document.

FIG. 66 illustrates the system detecting disinformation attacks by learning facts about target through alternative data sources when social media is restricted.

FIG. 67 illustrates the disinformation detection that includes a query generator, which creates curated queries for retrieving document locators.

FIG. 68 illustrates a method for detecting disinformation attacks through the generation and execution of curated queries to verify claims about a target's life

FIG. 69 illustrates a three-stage process for real-time monitoring, intervention, and evaluation of harmful verbal attacks using audio processing and attack behavior analysis.

FIG. 70 illustrates a method for profiling verbal attackers based on previously identified categories of harmful behavior and their associated context including time, location and activity.

FIG. 71 illustrates a method for grand summarization of detected attacks, identifying targeting attempts through various tactics over specified time frames and contextual attack insights made available to user through curated queries

FIG. 72 illustrates the systematically discovering occurrences of verbal attack patterns using a full factorial layout of behavioral features for analysis.

FIG. 73 illustrates the synthesized insights accumulated in the database, and corresponding rendering of such synthesized behavioral summaries on demand, based on historical voice activity linked to verbal attacks.

FIG. 74 (A-B) illustrates the cognitive firewall, which integrates selective audio profiling and real time intervention to enhance the handling of verbal attacks in real time.

FIG. 74 illustrates how a cognitive firewall software layered on top of audio processing consumer electronics hardware/firmware can be used to issue countermeasures upon detecting attacking voices and corresponding patterns of attacks, and further to aid in synesthically visualizing such attack patterns.

FIG. 74A further illustrates the visualization of voice attack patterns in terms of distribution by attack types, attacking voices engaging in one or more forms of attacks, and corresponding social behavioural patterns of such attackers.

FIG. 74B further illustrates one such depiction in the form of a pie chart showing distribution of attacks by the attack category for a given attack voice.

FIGS. 75 and 76 illustrate the system that provides detection, categorization, and derivation of advanced insights and visualizations, and make it available on wearable devices, including smartwatches and smart glasses.

FIG. 77 illustrates the system that utilizes a TinyML-based firmware interface to process voice inputs on edge devices.

FIG. 78 illustrates a visual rendering of verbal attack detection, displayed in the form of symbols on smart glasses

FIG. 79 illustrates an interface for managing “zapped” phrases and adjusting tolerance levels, allowing users to provide feedback for continuing adaptation and further customize the detection and zapping of verbal attacks.

FIG. 80 illustrates the user interface for smart glasses, enabling users to visualize and interact with in real time as well as playback recent and historical snippets or portions containing verbal attacks in real time.

FIG. 81 illustrates the user interface for smartwatches, enabling users to visualize, interact with, and playback verbal attack alerts directly on their devices.

FIG. 82 illustrates the user interface for smartwatches, for “verbal attack visualization and playback,” allowing users to view, replay and report detected verbal attacks.

FIG. 83 illustrates the system that delivers synthesized, context aware insights to the user through a series of notifications or summaries.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

The embodiments herein and the various features and advantageous details thereof are explained more fully with reference to the non-limiting embodiments that are illustrated in the accompanying drawings and/or detailed in the following description. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

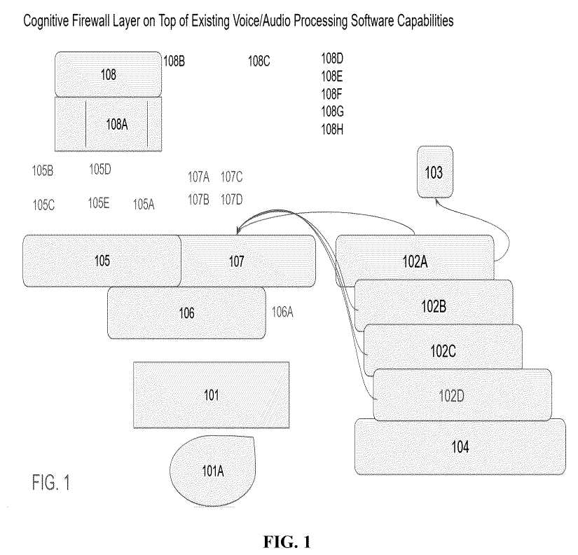

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon the present disclosure. The invention provides a multifaceted and comprehensive system for detecting, analyzing, and responding to harmful verbal attacks, comprising a wearable device intended/adapted to be worn by a user, and a computing device having a controller and a memory for storing one or more instructions and a plurality of modules executable by the controller, wherein the wearable device and the computing device are in communication with a server via a network, the controller is configured to execute the one or more instructions to perform operations using the plurality of modules, wherein the plurality of modules and detectors include a sound acquisition unit, a verbal attack behaviour detection module (107), a context classification module, a voice identifier, a data analytics and visualization engine, a profiling engine, a reactive intervention and reporting unit, a machine learning and memory module, a user interface system as illustrated in the FIG. 1

In one embodiment, the sound acquisition unit comprises an audio processing unit (101) and a voice detector. The audio processing unit includes at least one microphone (101A—Voice Sensors) and a signal digitization circuit, which are configured to capture verbal attacks in real time and convert them into digital audio streams. The audio processing unit (101) further comprises a directional microphone array configured to isolate voices in multi-speaker environments and reduce background noise. The voice detector is communicatively coupled to the audio processing unit, and is configured to isolate and identify distinct voice signatures in order to distinguish between aggressors and targets within the captured audio stream. The unit (107—Attack Type Detector) is capable of recognizing incoming voices as belonging to one or more of the following categories, including mind control tactic practitioners, work/professional career stalkers, relationship stalkers, economic, finances or wealth stalkers, other specific transaction stalkers, including those involved in legal proceedings or any other business/personal transactions.

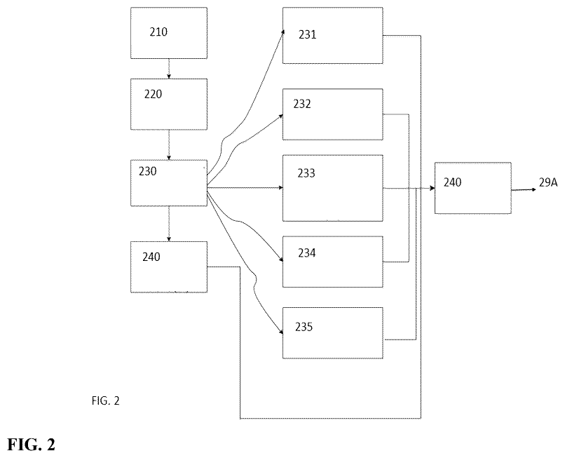

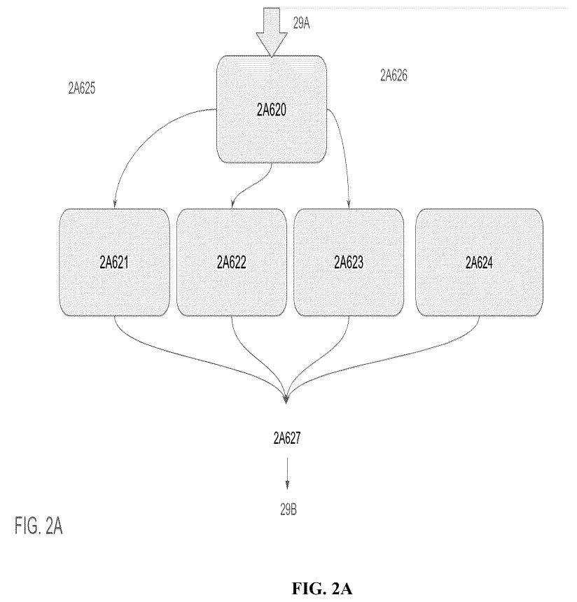

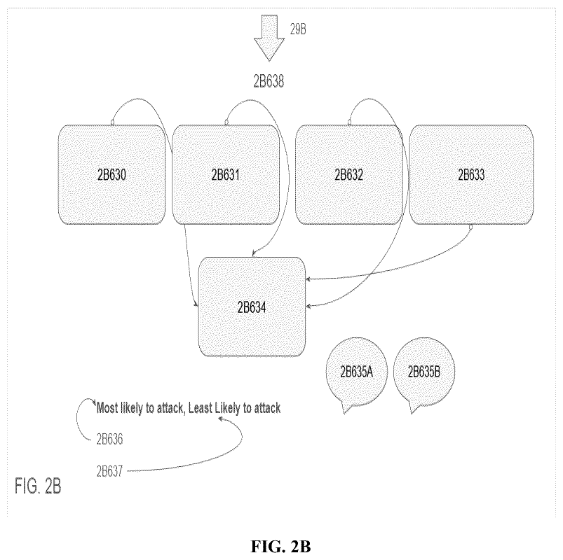

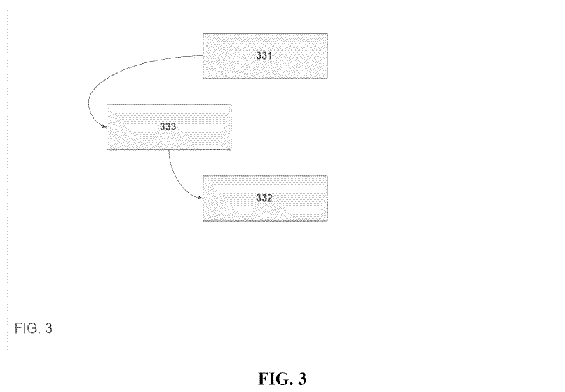

In one example embodiment, the voice detector (104—“Person/Attacker Detection Component”) initiating the detection and classification process by capturing live audio input via the Audio Processing Unit (101), which digitizes ambient speech into analyzable streams, is disclosed, as illustrated in FIGS. 2 and 3. The voice detector (210—“Detect Voices”) deconstructs each stream (331
Step 1→“Deconstruct voice into:

```
one,pitch,volume,phrases/words,facts/numerics if any).
Here is an example code snippet (333) as to how this can be implemented.
voiceComps[ ]=this.getDeconstructedComponets( )
for each deconstructed component
for comp in voiceComps:
{
    //predict likelihood of attack type from attack repository
    result[comp]=this.predictLikelihoodsForAttackTypes(comp)
}
def predictLikelihoodsForAttackTypes(comp):
{
    releventAttackTypes= comp.getReleventAttackTypes( )
    likelihoodList[ ];
    for type in releventAttackTypes:
      likelihoodList.append(type.computeLikelihood(this))
    return likelihoodList
}
likelihoodList
{
  attackType1:0.8
    ......
  attackTypetN: 0.1
}-->result[voiceComponent1]
  ....
likelihoodList
{
  attackTypetN1:0.85
    ......
  attackTypetN: 0.13
}-->result[voiceComponentN]
  ....
result[voiceComponentN]=
{
  attackTyype1:0.7
  attackTypeN: 0.15
}
}
```

Step 2→For each deconstructed component, discover which attack types can exist and their respective likelihoods for a given target, based on historical patterns.)
Step 3→Discover variations by target's location, activity, time and whether in company/alone (Analysis of Variation). See Table (332) below.

| | | | | Attacking | |
|---|---|---|---|---|---|
| | | | | Voice→ | |
| | | | | {Most | AttackType→{Most |
| | | | | Likely . . . Least | Likely . . . Least |
| Location | Activity | Time | Company | Likely} Rank | Likely} Rank |
| A | Wake | 6 am | Alone | {Voice#15: 70%, | Sexual Slurs: 50% |
| | up/Morning | | | Voice#1: 15%, | Disinformation: 10% |
| | Alarm | | | Voice#2: 15%} | |
| B | Meeting/Call | 4 pm | In | {Voice#11: 70%, | Sexual Slurs: 40% |
| | | | company | Voice#10: 10%, | Disinformation: 10% |
| | | | | Voice#9: 15%, | Degradation: 10% |
| | | | | Voice#21: 5%} | Threats: 40% |

into acoustic and linguistic components, including tone (102B—“Tone Detection Component”), pitch (102C—“Pitch Detection Component”), phonetics, volume (102D—“Volume Detection Component”), phrases (102A—“Phrase Detection Component”) or keywords (108G—“Phrases or Keywords”), and factual or numeric content. Each detected voice is assigned a unique identifier (230—Assign unique ID to each voice, and group matching voices) and compared against existing profiles (220—“Match against known voices in repository”) stored in the Insights Database to determine whether it belongs to a previously encountered speaker. If matched, it is grouped under that speaker's behavioral history. These deconstructed voice elements are then analyzed by the modus operandi detection module (105), which cross-references (240—“Match against Existing Repositories for each covered theme”) them with known (231 Check against known Attack Categories) patterns (240—“Match against Existing Repositories for each covered theme”) of aggression-including repeated (105C—“Repetitions Detector”) threats (107A), slurs (107B), insults, lies, shaming, disinformation (107D) dehumanizing or Degradation (107C), terrorizing, alternating (105E—“Alternation Detection”), echoing (105B—“Echoing Detection”), enchanting phrases, distraction inducing unrelated or incoherent phrase injections, dominance-seeking or distracting or locking tone modulation, or emotionally incongruent, sentimentally opposite conditioning, speech, mockery of target (105D—“Mockery Detector”)—to determine likely attack types. In parallel, the Context Classification Module gathers metadata including location, time, activity (108B—“Given that Target is @ location, @time, @ Activity”), and whether the target is alone or accompanied, which helps refine conditional likelihood estimations of specific verbal attack types. For instance, if a target is detected alone at home during early morning hours, and Voice #15 is active, the system might compute a 15.7% chance of aggression from that voice, with sexual slurs being the most likely attack form at 50%. In contrast, if the context changes to a group meeting in the afternoon, Voice #21 might show a 21.5% aggression likelihood, with both sexual slurs and threats equally probable at 40% each. Further, there might also be a social or cohort formation (235—“Check against Social Behavioural patterns of attackers”) where leader/follower formations in such attacks may be exhibited. These probability assessments are derived using statistical models executed within the data analytics and visualization engine, including clustering and correlation analysis. The results update (250—“Update Profile for this voice sample”) the behavior profile (108A—“Build comprehensive profile for each attack voice”) of each speaker through the Profiling Engine, allowing the system to detect changes including adoption of new attack styles or shifts in behavioral tactics including over time. The shift can be described and measured in terms of upward/downward in magnitude/intensity or expansion/contraction into more/less attack categories, and similarly expansion/contraction at more/less locations during more/less activities of the targeted person. This updated data loops back into both the voice-matching process and thematic attack repositories to ensure continuous learning. The system deconstructs attacking voice into constituent components including rendering (232—“Check against Rendering such as volume/tone/pitch jockeying”): pitch, tone, volume (106A—“Pitch, Tone, Volume”) respectively, detect attack phrases (107—“Attack Type Detector”) used and recognize their life objectives (233—“Check against Intention of Attack as to whether it is intended to attack Work/Business, Relationships, Transactions, Finances respectively”), infers modus operandi of attacks (234—“Check against Modus Operandi of attacks”), and invokes historical insights to predict (108—“Predictive Simulator”) attack likelihoods (108C—“Which voices are likely to attack and how?”) given the situational context of target. By combining real-time voice analysis with context-aware behavior modeling, the invention provides an intelligent, adaptive framework for early detection and intervention (108D—“How should the system react?”—108E—“Zap Voices”, 108F—“Record snippets containing attack phrases/keywords”) in harmful verbal attacks. The framework is specifically about knowing attack phrases and their life objective, corresponding rendering (106—“Rendering/Modulation Detection”) using pitch, tone, volume and phonetics modulation respectively, further the modus operandi of attacks and the social/behavioural cohort and hierarchy formation if any.

In another example embodiment, as illustrated in FIG. 2A, a flow-based process is disclosed for constructing predictive models of verbal attack behavior using contextual and behavioral data associated with a voice. The system first collects a set of target parameters-including location, time, current activity, and whether the target is alone-which serve as dynamic inputs to the Predictive Simulator. For each voice previously flagged by the Attack Type Detection Unit, the simulator builds individualized predictors based on situational context (2A620). The modeling process incorporates multiple dimensions (2A625), including location, activity, and time (2A621); whether the target is accompanied or alone (2A622); the linguistic and acoustic focus of the attack (e.g., phrases, pitch, volume, tone) (2A623); and observed patterns of social behavior (2A624), including acting alone or as part of a group, and whether the voice leads or follows within group dynamics. These factors are synthesized to produce likelihood estimates for future aggression (2A627), identifying which voices (2A26—build predictors for each attacking voice in the target's given situational context) are most or least likely to re-engage in harmful behavior under similar conditions. For instance, a voice May be determined to be two times more likely to attack during the evening when the target is alone and speaking about sensitive topics, three times more likely to emphasize tonal aggression, four times more likely to use repetition, and five times more likely to follow the target's voice across changing locations. This embodiment demonstrates how the Predictive Simulator, informed by the outputs of the Attack Type Detection Unit and enhanced with contextual predictors, enables proactive identification of high-risk individuals and supports anticipatory threat mitigation strategies.

In another example embodiment, as illustrated in FIG. 2B, the predictive simulator for assessing and forecasting impending verbal attacks based on real-time contextual and behavioral factors is disclosed. The system integrates various input parameters, including the target's location, activity, time (2B630), social environment (e.g., whether they are alone or in company) (2B631), verbal behavior (what and how target is speaking e.g., phrases, pitch, volume, tone) (2B632), and the social dynamics of potential aggressors (e.g., lone actor vs. herd, leader vs. member) (2B633). These factors are fed into the core processing module, represented by the “Predictors on impending attacks in the moment” (2B634), which generates a probabilistic assessment of the likelihood of an attack occurring. The system outputs predictions about which voices (2B635) are most and least likely to attack under the given circumstances. For example, the simulator May predict that “Voice #5” (2B635A) is more likely (for instance x times more likely to attack when the target is alone and discussing sensitive topics like work, relationships, or finances, with such attacks focussing on target's tone and pitch (2B636), y times more likely to suffer from alternation attacks and z times more likely to suffer from repetitions attack. “Voice #13” (2B635B) may attack using sexual slurs or insults to dignity, irrespective of, or without following the target's location (2B637). The system also captures the immediate social dynamics, including whether the aggressor is acting alone or as part of a group, providing insights into the most likely perpetrators and their behavioral patterns. This real-time predictive capability of the system allows for dynamic risk assessments, offering actionable insights on potential threats based on the unfolding situation. The “Flip to predict nature of attack and most likely perpetrators at the moment” (2B638) emphasizes the simulator's adaptability to shifting conditions, ensuring timely identification of high-risk scenarios and the individuals most likely to engage in harmful behavior.

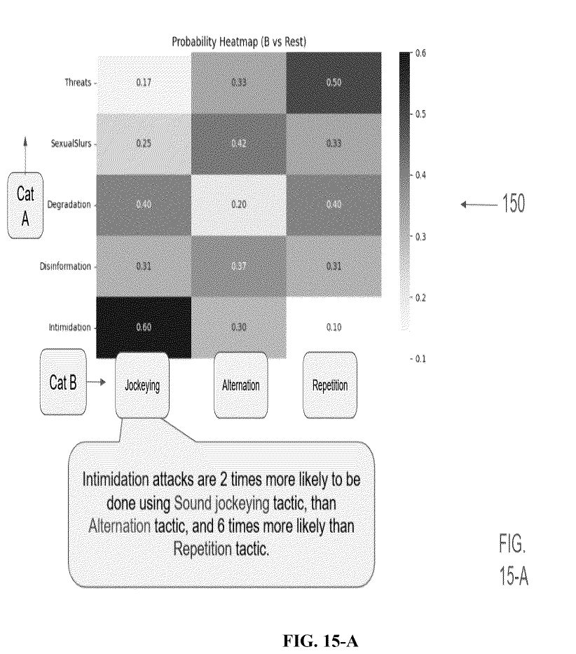

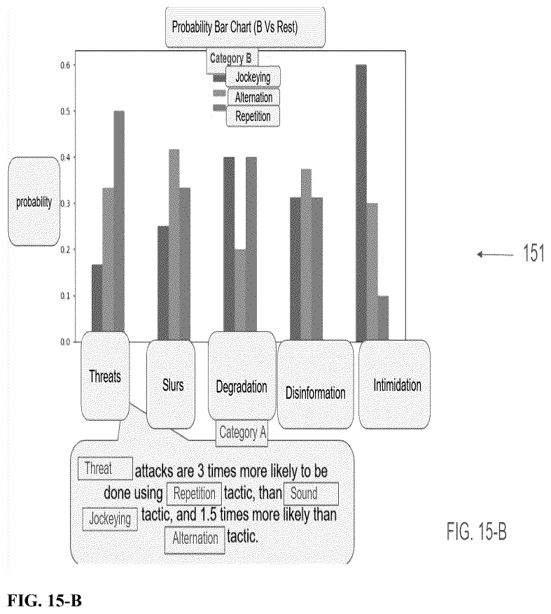

In an example embodiment, as illustrated in FIG. 15A and FIG. 15B, statistical engine within the data analytics and visualization engine is disclosed. for analyzing the association between categories of concern (e.g., Threats, Intimidation, Degradation) and specific verbal tactics (e.g., Jockeying, Alternation, Repetition). The engine computes conditional probabilities that are visualized, as depicted in FIG. 15A, through a probability heatmap (FIG. 15A-150) and as depicted in FIG. 15B, a bar chart (FIG. 15B-151), allowing for intuitive comparison across categories. For instance, Threats are associated with Repetition tactics at a probability of 0.50 (or 50% of the time), while Intimidation is most strongly linked to Jockeying tactics at 0.60. (or 60% of the time) These values are further contextualized through odds ratio-style interpretations provided below the visualizations, highlighting tactical preferences—for example, intimidation-related speech is shown to be two times more likely to involve Jockeying than Alternation tactic, and six times more likely than the tactic of Repetition. This embodiment illustrates how statistical modeling can uncover nuanced relationships between harmful interaction types and their delivery methods, enabling more targeted detection, profiling, and intervention strategies.

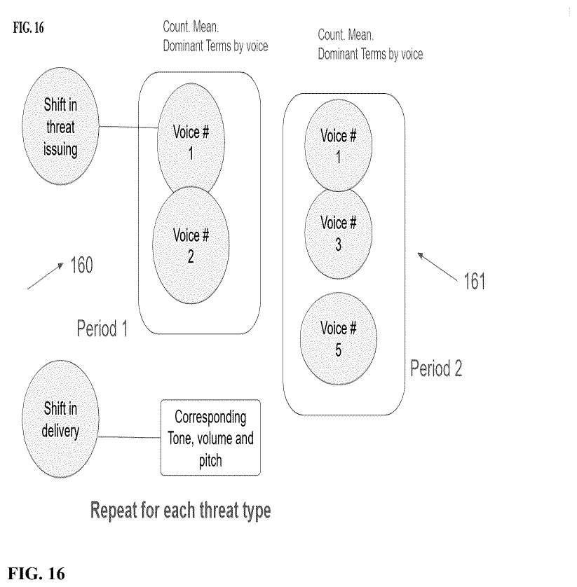

In an example embodiment, as illustrated in FIG. 16, the data analytics and visualization engine, in coordination with the profiling engine and the modus operandi detector, is configured to perform temporal analysis of threat-issuing behaviors and delivery characteristics across multiple speakers. During the analysis, the system compares behaviors across distinct time segments—e.g., Voice #1 and Voice #2 (161) in Period 1, versus Voice #1, Voice #3, and Voice #5 (162) in Period 2—identifying temporal shifts in aggression dynamics and speech delivery. The system also surfaces dominant threat-related terms through semantic analysis, allowing for contextual interpretation of how the nature of threats evolves over time. This temporal mapping supports the identification of escalating aggression trends or shifts in targeting strategies.

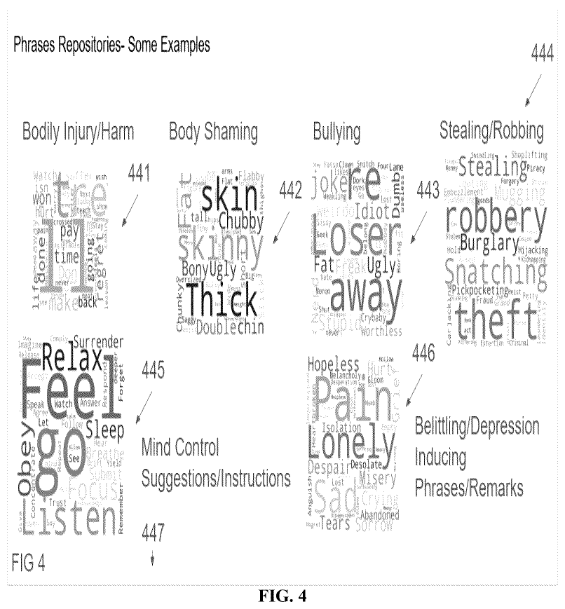

In another embodiment, the attack behavior detection module is operatively connected to the sound acquisition unit, and is configured to analyze the audio input for indicators of harmful or abusive interactions. The module comprises a red flag recognizer, a phrase detector, a tone detector, a pitch detector, and volume detector. The red flag recognizer scans the incoming audio data for predefined verbal abuse indicators, including but not limited to threats, slurs, disinformation, and harassment patterns. The phrase detector detects specific trigger words or phrases that are commonly associated with psychological abuse or expressions of harmful intent. The tone detector extracts and classifies emotional tone characteristics—including joy, elation, anger, sarcasm, sombreness, or fear—from the audio data, contributing to the contextual understanding of verbal attacks. The pitch detector analyzes frequency modulation in voice signals to identify manipulative speech patterns or escalating vocal behavior indicative of unusual or contradictory emotional excitement or distress or aggressive intent. The volume detector monitors amplitude fluctuations and tracks loudness trends over time to detect yelling, shouting, screaming or other forms of aggressive vocal modulation. In an example embodiment, the phrase detector within the attack behaviour detection module configured to scan incoming audio for harmful or concerning phrases by comparing spoken content against curated repositories of predefined and extensible thematic phrase sets is disclosed, as illustrated in the FIG. 4. The repository provides phrase clouds representing various categories of verbally abusive or psychologically harmful language. Each word cloud in FIG. 4. illustrates a distinct category of concern, that are outlined below:
(a) the Bodily Injury/Harm category (441) includes phrases including “suffer,” “die,” “cull,” “burn,”, “hang”, “shoot”, “behead,”, “dismember”, “kill,” “going to die,” “break legs/hands”, “deface”, “char” and “make you pay,” indicating potential physical or distress inducing threat.
(b) the body shaming category (442) comprises terms like “fat,” “flabby,” “skinny,”, “moobs”, “fatass” “chubby,” “ugly,” “thick,” and “double chin,” typically used to demean physical appearance.
(c) the bullying category (443) includes insults and degrading remarks including “jerk,” “loser,” “idiot,” δfreak,” “stupid,”, “retard”, “worthless”, “shaggy”, “asshole”, “bitch”
(d) the stealing/robbing category (444) encompasses words related to theft and unlawful actions, including “steal,” “rob,” “snatch,” and “theft”, “ransack”
(e) mind control suggestions/instructions (445), features words like “feel,” “relax,” “sleep,”, “love me”, “like me”, “go away”, “right now”, “give up”, “go back”, “die somewhere”, “leave”, “obey,” “listen,” “look at me,” “trust,” and “remember”, “sign it”, “accept”, “say sorry” which may be used to exert psychological influence or manipulation.
(f) the belittling/depression-inducing remarks category (446) includes emotionally charged language including “hopeless”, “loser”, “lowlife”, “worthless,” “lonely,” “despair,” “sad,” “misery,” “crybaby,” and “sorrow”, “sombre”, “illicit”, “jailed or in jail”, “tootsy” which could contribute to psychological distress or emotional harm.

The phrase detector increases the likelihood score for specific “Attack Categories” or “Intent of Attack” classifications when matching phrases from these repositories are detected in the audio stream, enhancing the system's ability to assess potentially abusive or harmful verbal attacks in real time.

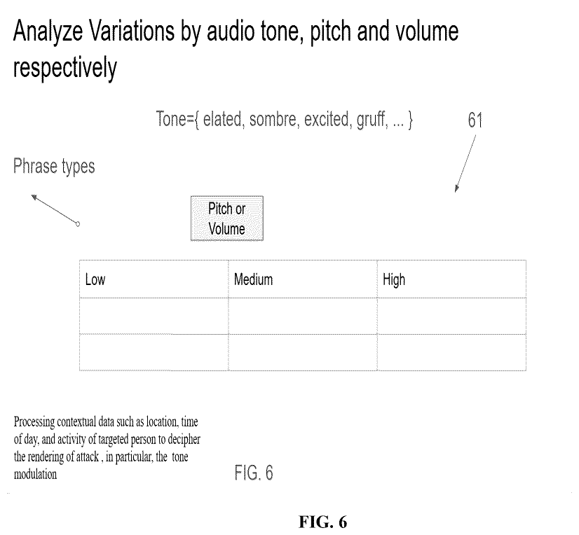

In an example embodiment, the phrase detector in conjunction with the Tone Detector, within the attack behaviour detection module is configured to analyze variations in the “rendering of attack” by examining how different “Phrase types” vary based on the audio tone, is disclosed, as illustrated in FIG. 6. The system categorizes detected phrases (e.g., Threats, Insults, Disinformation) and maps their occurrences to different tone, pitch, phonetic, and volume levels, including Low, Medium, and High, as provided in Table 2 (61). For example, if the tone detector analyzes the audio signal to classify the tone, the phrase detector identifies the specific phrase types, data collected is processed by the data analytics and visualization engine, which populates a table and generates insights including frequency counts or statistical measures that describe the relationship including association or correlation between tone and phrase types. this analysis contributes to understanding how tone, pitch, phonetic and volume modulation has been chosen by the attacker/sin delivery of verbal attacks, factoring in (that is whether and how such modulation varies) contextual data including location, time of day, and target activity.

In yet another embodiment, the context classification module is operatively connected to the attack behavior detection module and is configured to enhance the interpretability of detected verbal attacks by assigning situational meaning to the captured audio. The module comprises a life category detector and a contextual information aggregator. The life category detector is configured to determine whether the conversation pertains to personal, professional, or social contexts based on semantic and behavioral cues extracted from the audio stream. The contextual information aggregator is configured to retrieve and correlate relevant metadata from internal or external sensors, including but not limited to external device installations including audio sensors or microphones installed in personal properties and/or privately owned automobiles, collecting audio along with situational context including timestamp geolocation data, and user's activity at the time. The context classification module includes the geolocation input that dynamically adjusts behavioral thresholds based on location-specific risk factors. By identifying the contextual domain of a conversation and integrating auxiliary data, the context classification module enables more accurate classification and prioritization of potentially harmful interactions, which improves the system's ability to assess risk and generate appropriate responses. What this means in simple terms is learning about what is acceptable or not acceptable to users based on historical attack patterns encountered at time, location and activity respectively and adapting responses including intervention and reporting accordingly. For instance, “Let's go out for dinner” by a stranger at night heard near a deserted public transit station while walking alone should be alarming while the same suggestion may not be that alarming when it comes from a friend or colleague while leaving the workplace or when within an apartment.

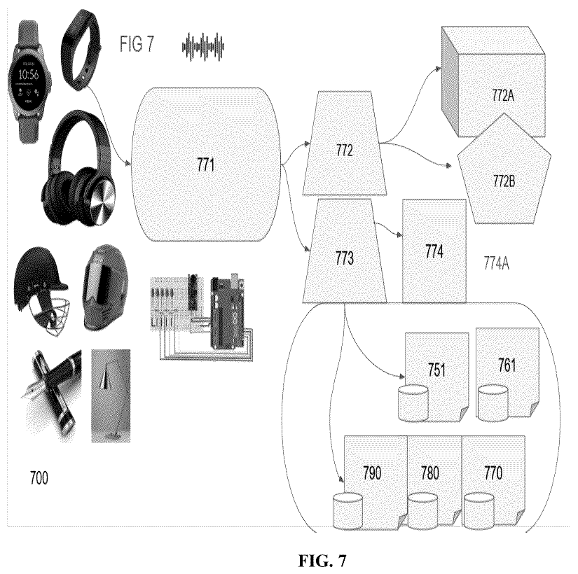

In one example embodiment, as illustrated in FIG. 7, the system for the initial detection and categorization of harmful verbal attacks is disclosed, primarily focusing on the attack behavior detection module. The system first utilizes a sound acquisition unit, potentially comprising microphones in wearable devices or sensors (700—“Wearable devices, Interiors and Outdoors”) including microphones installed in ambient environments, coupled with an audio processing unit to capture and digitize verbal attacks. A voice detector (771—“Detect voices”) then isolates individual voice signatures. Subsequently, the attack behavior detection module deploys a red flag recognizer (including specialized components like the Threat Recognition Component (774), (774A—“Similarly, a recognition component for each attack category”)) and a phrase detector (773—“Phrase/Term Recognition”) to scan the audio data. This involves matching recognized phrases and terms against predefined databases of harmful language, including terms related to bodily harm, property damage, terror (780—“Match against Terror related terms”), and insults to dignity (770—“Match against Insult to Dignity related terms”, as well as any custom user-defined terms (760—“Match against custom user defined terms”. The context classification module, through entity (772B)/object (772A) recognition (772), may provide additional context. This initial detection phase identifies potential instances of harmful verbal attacks based on linguistic content.

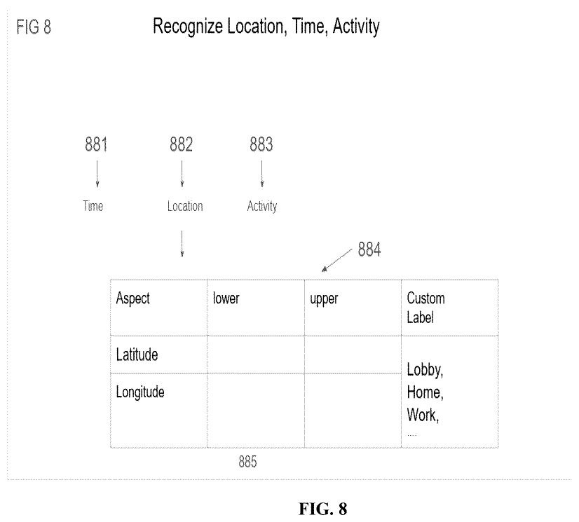

In another example embodiment, as illustrated in FIG. 8, the Context Classification Module for enabling real-time situational awareness is disclosed. The module captures various environmental metadata-including location (via GPS coordinates), time (via timestamps), and activity (e.g., “InCall” inferred from microphone energy)—to assess and correlate the target's context. The FIG. includes pseudo-code and tabular format illustrating how these conditions are detected, classified and represented.
881—Sample Pseudo Code to Collect Timestamp—

```
void loop( ) {
    DateTime now = rtc.now( );
    Serial.print(now.timestamp( ));
}
if (gps.time.isUpdated( )) {
  Serial.print(“Time: ”);
  Serial.print(gps.time.hour( )); Serial.print(“:”);
  Serial.print(gps.time.minute( )); Serial.print(“:”);
  Serial.printIn(gps.time.second( ));
}
```

882—Raw Location→Example code snippet—

```
void loop( ) {
  while (ss.available( ) > 0) {
    gps.encode(ss.read( ));
    if (gps.location.isUpdated( )) {
      Serial.print(“Lat: ”);
      Serial.print(gps.location.lat( ), 6);
      Serial.print(“, Lng: ”);
      Serial.printIn(gps.location.lng( ), 6);
    }
  }
```

883—Activity→“Incall”→Example code snippet

// Pseudo-code on Arduino
if (acc_variance < 0.05 || mic_energy > threshold) {
label = “in_call”;
}

884—Map {lat, long} to custom location for supervised learning, associative analysis and user friendly notifications
885—Map (lat, long) to custom location for supervised learning, associative analysis and user friendly notifications
By linking (884 and 885) environmental inputs to rule-based triggers, the system provides a foundation for dynamic, context-driven responses to verbal threats.

In another embodiment, the person detector, operatively connected to the sound acquisition unit and the attack behavior detection module, is configured to identify and differentiate individuals involved in verbal attacks. The person detector includes a speaker identification module configured to analyze unique vocal characteristics and voiceprints in order to distinguish between different speakers in real time. It further comprises an aggressor-target differentiation module adapted to classify individuals as aggressors or targets based on detected behavioral patterns, tone, and historical context. A voice signature matcher is provided to compare incoming voice signatures with stored profiles to support identification of recurring individuals. A speaker role tracker monitors role shifts over time within an interaction, capturing transitions in aggressor or target status. The component also includes an identity correlation engine configured to associate speaker identities with external or internal metadata including device identifiers, timestamps, and geolocation data, thereby supporting contextual and behavioral analysis across multiple interactions.

In yet another embodiment, the data analytics and visualization engine are operatively connected to the attack behavior detection module and the context classification module, and is configured to analyze and categorize the data to detect trends, patterns, and variations in behavior, and visualize these insights to support interpretation and decision-making. The data analytics and visualization engine comprise a computational unit and a statistical engine. The computational unit is configured to execute clustering algorithms, trend analysis, and outlier detection based on temporal and behavioral patterns identified across multiple interactions. The statistical engine is configured to perform variety of associative and correlation techniques including chi-square testing, logistic regression, odds ratio calculation, and correlation analysis in order to identify statistically significant relationships between contextual variables and aggressive behaviors. By combining pattern recognition with statistical inference, the data analytics and visualization engine enables the system to detect recurring behavioral trends, recognize anomalies, and support predictive modeling for early identification and mitigation of potentially harmful interactions.

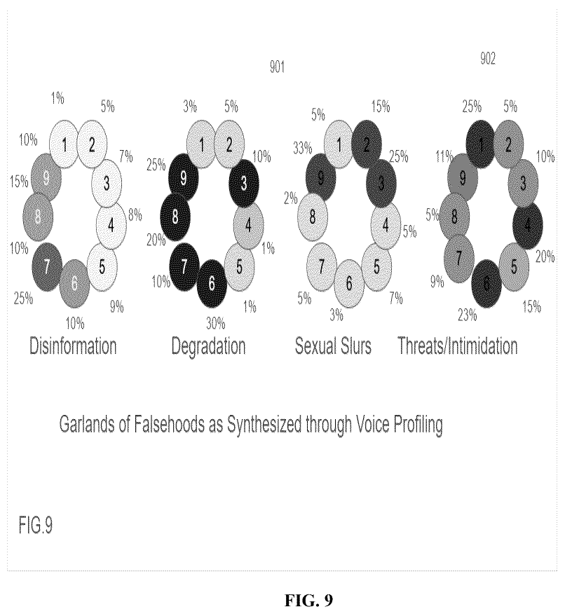

In an example embodiment, as illustrated in FIG. 9, a visualization presents a detailed breakdown of harmful verbal attacks across four main categories: Disinformation, Degradation, Sexual Slurs, and Threats/Intimidation. Each category appears as a garland segmented by sub-category, with the size and color intensity (901—Color grade proportional to % share) of each segment reflecting its relative prevalence. Each of the four circular visualizations (902—a synthesized visual rendering on wearable device of choice) illustrates a distinct category of concern, as outlined below:
a) the disinformation category includes elements including “sexuality” (1%), “relations” (5%), “education” (7%), “finances” (8%), “assets” (9%), “status” (10%), “career” (25%), “age” (10%), and “health” (15%), suggesting the
spread of false or misleading information across various life domains. b) The degradation category comprises terms like body shaming (3%), iq shaming (5%), status/identity related shaming (25%), appearance/looks related (10%), sexuality related (1%), relationships related (30%), interactions related (10%), business transactions related (8%), and legal rights/issues related (20%), indicating the distribution of various forms of demeaning language.
c) the sexual slurs category features phrases including sexually colored remarks (5%), sexually explicit vulgarity (15%), and sexual degradation of relationships (25%), along with three unlabeled elements at 5%, 3%, and 7% respectively, and another unlabeled element at 2% and a significantly higher unlabeled element at 33%, illustrating the relative frequency of different types of sexual slurs. 2
d) The threats/intimidation category encompasses phrases related to potential harm and coercion, including bodily injury (25%), threats to family members (5%), threats to colleagues (10%), threats to witnesses/acquaintances (20%), belittling (15%), and “use of nazi/supremacist phrases including exterminating, entombing, mass grave-ing and more so” (23%), alongside unlabeled elements at 9%, 5%, and 11%, suggesting the varying degrees to which different threatening behaviors are observed.

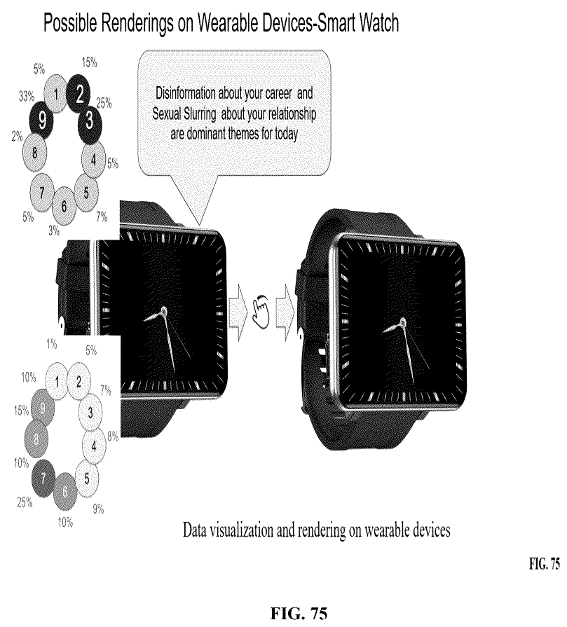

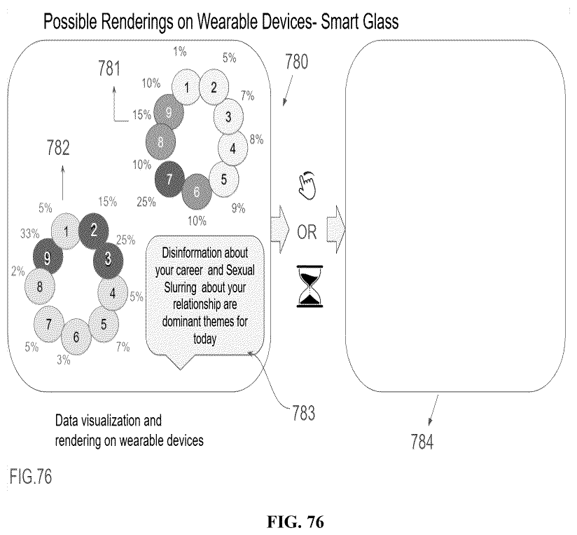

In an example embodiment, as illustrated in the FIGS. 75 and 76, the system provides advanced insights and visualizations on wearable devices including smartwatches (770) and smart glasses (780). The smartwatch interface (770) offers two views: a detailed one showing visual elements like circles or nodes (771) that represent voices or topics, with sizes and colors encoding data on intensity or frequency. A text box (772) displays a summary of the dominant themes detected, including “Disinformation about your finances/Spread hatred about your relationship.” The display also includes a clock face to show that insights are time-sensitive and can be further programmed to disappear after a predefined period to declutter the display. View reverts to the default clock interface (773) when no critical insights are present. For smart glasses (780), the system overlays visualizations onto the user's field of vision. Two circular graphs (781, 782) display nodes with percentages indicating the prevalence of different voices or themes. The highlighted nodes suggest key insights, including “Sexual Slurs during late evening hours.” (783). The user can interact with the visualization using hand gestures to dismiss or alter the display, which can automatically fade over time. This provides timely, contextual information without obstructing the user's view, offering a hands-free, proactive way to stay informed and minimizing disruption.

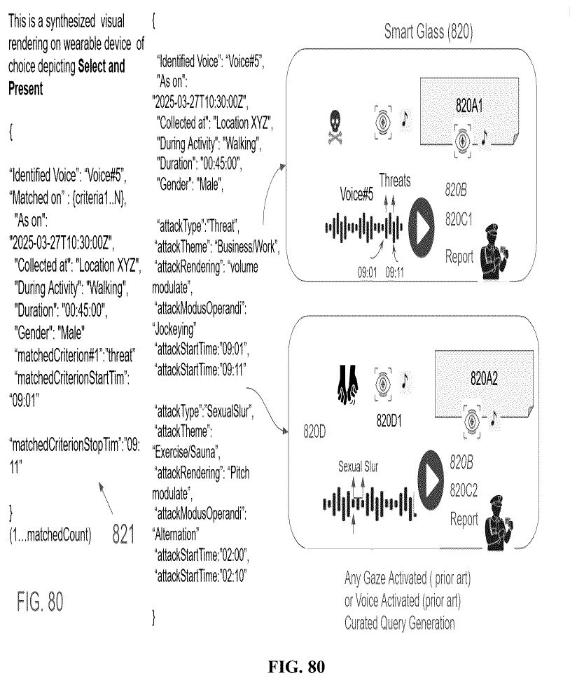

In another example embodiment, as illustrated in FIG. 80, the user interface for smart glasses for visualizing and interacting with detected verbal attacks is disclosed. The system visualizes and enables interaction with detected verbal attacks on a smart glass (820) interface. When a voice, including “Voice #5,” is identified and matches the criteria for a specific threat, the system presents an option to play back all recent threats. It also displays a visual representation of the detected threat, allowing the user to play that specific portion, and provides a “Report” function. Underlying data structures (821) contain details about the identified voice, the criteria it matched (e.g., “threat”), the time and location of the event, and the activity during which it occurred. Similarly, when a “Sexual Slur” is detected, the system offers a way to “Play back all the sexual slurs I have received in the last hour or so while I was speaking to someone on phone.” (820a), A representation of the “Sexual Slur” is displayed with playback (820c) and a “Report” (820e) option. The data associated with this event includes the specific attack type (“SexualSlur”) and its characteristics, including the theme, rendering, modus operandi, and the start and stop times. The smart glass interface includes an “Interactive Menu Bar” (820d) and indicates the possibility of user interaction through gaze or voice activation for curated query generation. Essentially, the system provides a wearable interface for users to review, contextualize, and report detected verbal attacks through visual and interactive elements.

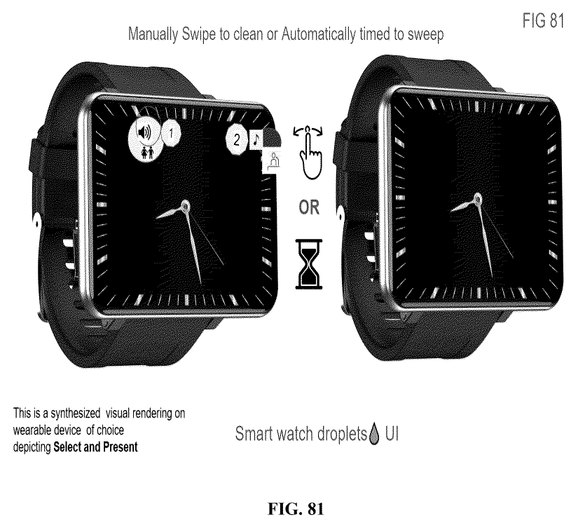

In another example embodiment, as illustrated in FIG. 81, the User Interface (830) for smartwatches for visualizing and managing verbal attack alerts is disclosed. This system enables users to receive real-time notifications about harmful verbal attacks directly on their smartwatch. The interface is presented on a stylized analog clock face and showcases two primary views. In the left view (830a), which represents active alerts, the smartwatch displays two circular icons: one showing a person icon with sound waves, indicating a detected verbal interaction, and another displaying a musical note with a prohibition symbol, potentially representing a muted or managed audio event related to a verbal attack. A speaker icon is also visible, likely indicating the option to play back the detected audio. In the right view (830b), the alert icons are removed, signifying that the user has interacted with or cleared these alerts, either by swiping them away manually or through an automatic timed mechanism. This user interface offers an efficient and discreet way for users to receive and manage verbal attack alerts, ensuring they can take timely action and maintain a seamless experience.

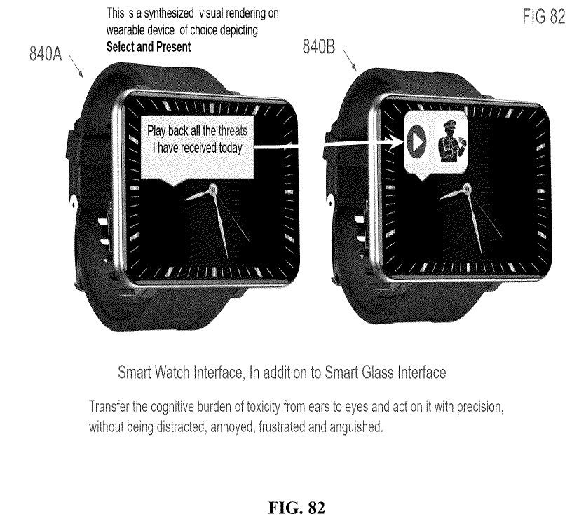

In another example embodiment, as illustrated in FIG. 82, the User Interface of smart watches (840) for “Verbal attack visualization and playback” is disclosed. This system serves as an alternative or complementary option to a Smart Glass interface, allowing users to manage and review detected verbal attacks directly from their wrist. The interface displays two main views on the smartwatch face. In the left view (840a), labeled “Reviewing Threats,” the user can select the option to review all threats received throughout the day, with a text box overlay stating “Play back all the threats I have received today.” In the right view (840b), labeled “Playing Back a Threat,” a prominent play button appears, enabling the user to listen to the audio recording of a specific threat. An icon representing the identified attacker or a generic alert symbol is displayed next to the play button. This UI aims to reduce the emotional burden associated with harmful verbal attacks by providing users with a controlled, visual approach to processing the content, allowing them to act with precision without feeling distracted or frustrated.

In another example embodiment, as illustrated in the Table 1 below, a multi-dimensional classification approach is disclosed for analyzing incoming voice data across linguistic, behavioral, and contextual dimensions. The attack type detection unit classifies utterances into categories including threats, sexual slurs, disinformation, and degradation. The attack rendering detection unit detects delivery styles including tone, pitch, volume, and phonetic modulation. Behavioral patterns like repetition, alternation, jockeying, echoing, and mocking are recognized by the modus operandi detection module, and the social behavior mapper analyzes interaction dynamics, identifying lone actor behavior, cohort aggression, and leader-follower structures. life themes—including relationships, work, finances, and health—are inferred through semantic evaluation.

TABLE 1
Multidimensional classification of incoming voice data

| Analysed Incoming Voice data | | | | | | Attack type |
|---|---|---|---|---|---|---|
| Threats | Sexual Slurs | Dis- | Shaming | Other | | Utterance |
| | | information | Degradation | Custom | | |
| | | | | Categories | | |
| Tone | Pitch | Volume | Phonetic | | | Rendering |
| Modulation | Modulation | Modulation | Modulation | | | |
| Work/ | Relationship | Transaction | Finances | Health/Body | Other | Life Theme |
| Business | | | | | Custom | |
| | | | | | Categories | |
| Repetitions | Alternation | Jockeying | Echoing | Mocking | | Modus |
| | | | | | | Operandi |
| Lone Actor | Cohort | Leader/ | | | | Social |
| | Formation | Follower | | | | Behavioural |
| | | | | | | Patterns |

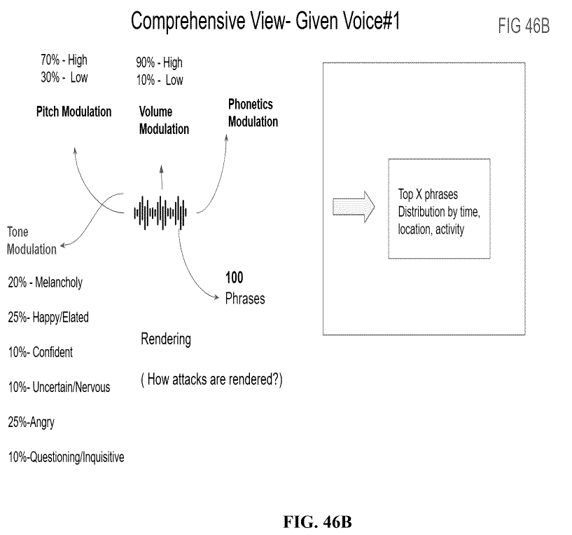

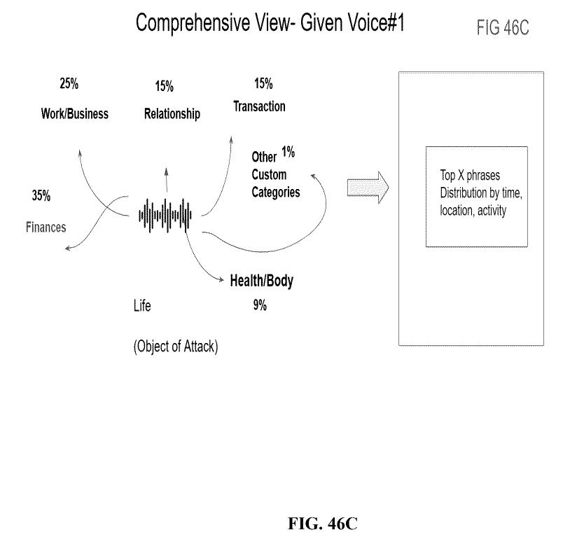

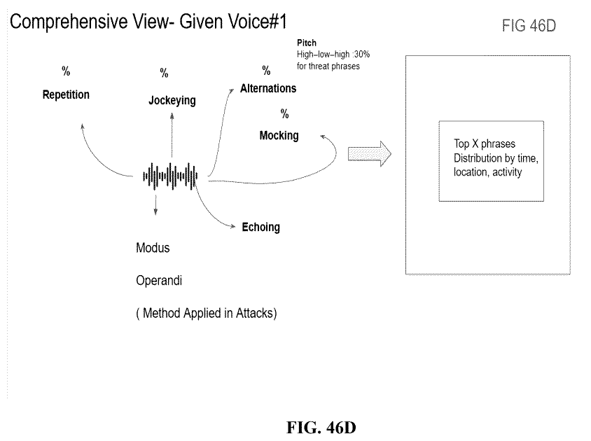

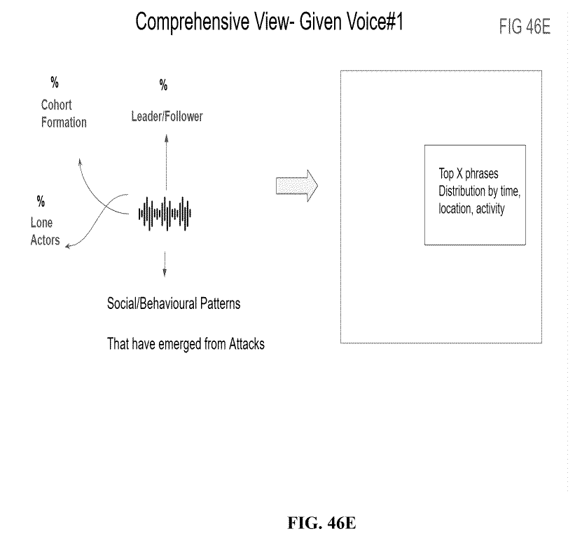

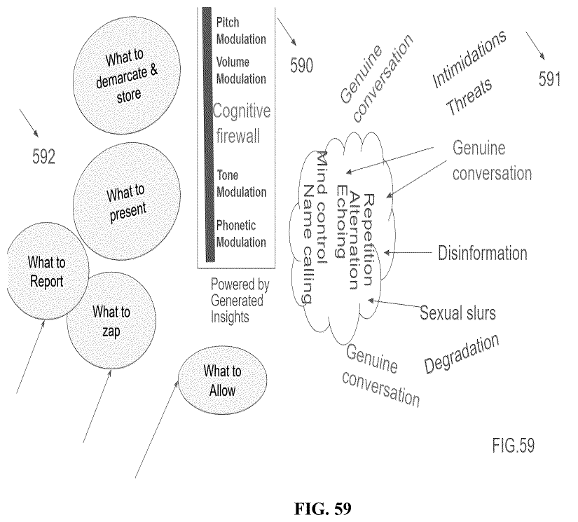

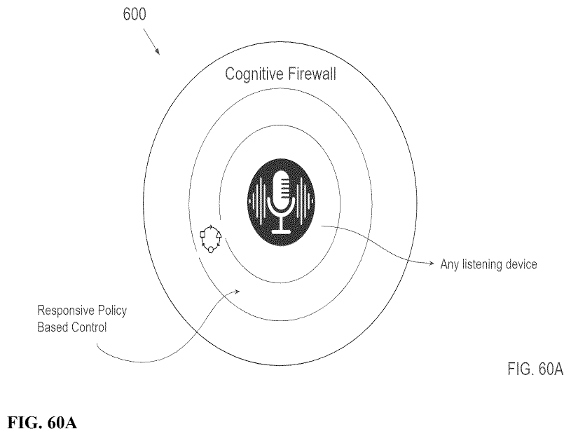

In another example embodiment, as illustrated in FIG. 46A, a system for generating a comprehensive behavioral profile of a given voice, including a given Voice #1, is disclosed. Similarly, each attacker's voice can be recognized and documented. The profile management module within the profiling engine compiles utterance categories including 18950 Personal Threat Phrases, 900 Sexual Slur Phrases, 150 Disinformation Phrases, 150 Insult to Dignity Phrases, 100 Shaming Degradation (insult to dignity) Phrases, and 100 Other Custom Categories, all contextually triggered by time, location, activity, or system-level cues. As illustrated in FIG. 46B, The Tone Detector identifies emotional delivery, showing 20% hateful, 285% elated, 2610% confident, 25% angry, and 10% uncertain or and 10% questioning or inquisitive tones. The Pitch Detector captures high-low-high modulation, wherein high-low distribution is 70% and 30% respectively, in 30% of threat phrases, and the Volume Detector detects 90% of utterances delivered at high volume and remaining 10% delivered at low volume. As depicted in FIG. 46D, The Repetition Detector confirms 100% recurrence of sexual slur phrases across spatiotemporal contexts. The Alternation Detector recognizes 30% alternation in threat phrases, based on pitch shifts; the Sound Jockeying Detector and Mockery Detector jointly flag patterns of jockeying and mocking. The Context Classification Module as depicted in FIG. 46C, identifies rendering topics including 25% Work/Business, 15% Relationship, 15% Transaction, 35% Finances, 9% Health/Body, and 1% Custom Categories. The actual percentage or number values may vary from attacker to attacker and depending on the targeted person, and his/her situational context. The Social Behavior Mapper, as depicted in FIG. 46E, maps social dynamics including Lone Actor behavior, Cohort Formation, and Leader/Follower influence. The Data Analytics and Visualization Engine aggregates these insights to present a structured summary of Voice #1's communication style and behavioral strategies for risk analysis and intervention. In one example embodiment, as illustrated in FIG. 59, the real-time interrupter focusing on the cognitive firewall and its decision-making process for managing verbal attacks is disclosed. The firewall analyzes acoustic features—pitch, volume, tone, and phonetic modulation (590)—extracted by the attack behavior detection module. Incoming utterances, visualized as a speech cloud, are classified by their characteristics (e.g., “Mind control,” “Echoing,” “Threats,” “Disinformation”) (591) and matched against known harmful patterns. Based on this analysis, the firewall determines whether to allow, zap, report, present, or store the content (592). For instance, harmful phrases may be muted (zap), logged (report), shown to users (present), or time stamped and archived (store), and genuine conversation is allowed through. These decisions are powered by the user defined policy guidelines as well as insights database, part of the learning and memory module, enabling context-aware filtering.

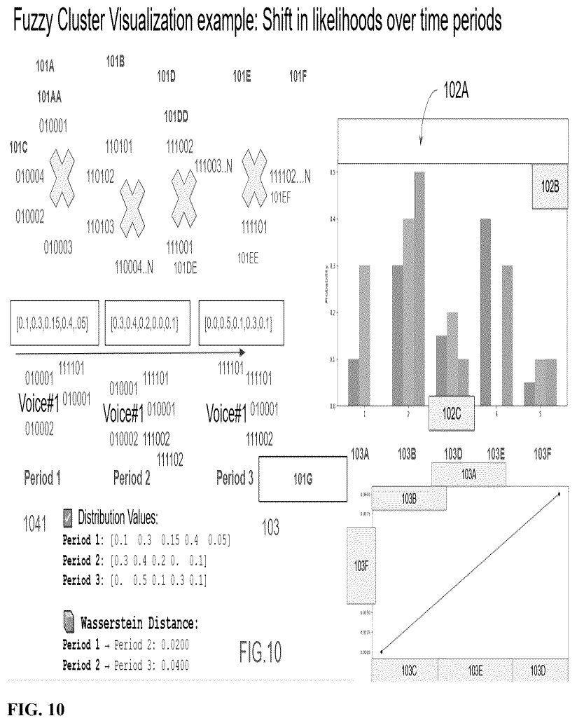

In another example embodiment, as illustrated in FIG. 10, the data analytics and visualization engine assessing the evolution of harmful language through fuzzy clustering and probability-based classification is disclosed. The system analyzes verbal utterances from a voice at different time periods, generating probability vectors that estimate each phrase's affiliation with predefined harmful language categories, including Threats, Sexual Slurs, Disinformation, Shaming/Degradation, and Others. Using fuzzy clustering methods, the engine groups utterances within a multidimensional space, where boundaries between categories might be fuzzy and corresponding likelihoods are estimated, for phrase encodings as to which category or categories they might belong solely or simultaneously, allowing for nuanced interpretation of ambiguous or overlapping language. Each utterance's cluster membership is visualized via spatial plots (101), and stacked bar charts (102) and line graphs (103) depict the temporal dynamics of category probabilities across time slices (e.g., Segment A, B, C). For example, in Voice #1, early time segments (period 1) show a stronger association with Shaming/Degradation, which gradually shifts toward sexual slurs in later segments (period 3), as evidenced by increasing vector magnitudes in the corresponding dimensions. These visualizations enable human operators or targeted users to detect emerging behavioral patterns and linguistic shifts in attack patterns. A key component is the fuzzy cluster map, where utterances are plotted according to their fuzzy membership across multiple categories. Probabilistic distributions allow real-time assessment of language volatility, supporting use cases including moderation, threat escalation tracking, or psychological profiling. Shift in probability distribution over time can be measured by various metrics, one being Wasserstein distance. To put it simply, this may detect an attacker may start with threats/intimidation but switch to sexual slurring or increase threats over time etc.

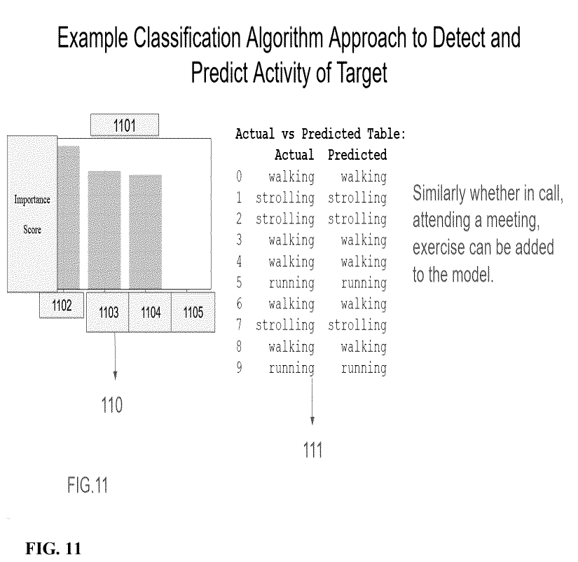

In another example embodiment, as illustrated in FIG. 11, the data analytics and visualization engine facilitate interpretability and performance evaluation of a classification model deployed for human activity recognition. The figure comprises two primary visual components: a bar chart illustrating the relative importance of selected features (1101—“Feature Importance”) used in the classification algorithm, and a table (111) depicting actual versus predicted activities for a sample set of data instances. In the bar chart (110), four features—“std” (1102—“standard deviation”), “peak_freq” (1103—“peak frequency”), (1104-“energy,”) and (1105—“mean”)—are ranked by their importance scores, with “std” being the most impactful in determining the activity classification outcome. The adjacent table (111) presents ten entries where the predicted activities correspond closely to the actual labels, highlighting the model's robust accuracy in recognizing activities including walking, running, and strolling. Furthermore, a contextual annotation within the visualization suggests potential future enhancements, including the incorporation of features that detect secondary conditions including whether the individual is on a phone call, in a meeting, or engaged in physical exercise.

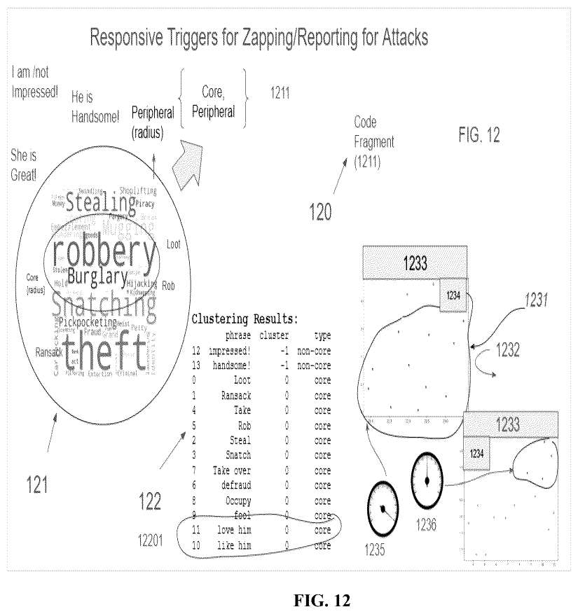

In another example embodiment, as illustrated in FIG. 12, the Data analytics and visualization engine identifies responsive triggers for detecting or reporting potential attacks by providing an interactive visual interface that analyzes and presents semantically significant phrases. The engine displays a stealing/robbing word cloud (121) that emphasizes key attack-related terms—including “robbery,” “theft,” and “burglary”—with word size and color indicating relevance and cluster grouping. A surrounding radar chart maps these terms along a “core” to “peripheral” axis to show their semantic proximity (1211—“Threshold of Semantic Similarity”) to central threat concepts. A clustering results table (122) lists each phrase with its assigned cluster and classification (e.g., core or non-core (1234—“Cluster 0, Non-core”)), supporting interpretation of the underlying model output. A misclassification example (12201—“Misclassification error but this can be reduced by tuning models”) where deceptively distracting expressions such as “love him!” or “like him!” are misclassified as part of the core group instead of non-core. This example is depicted in the clustering results table (122) wherein non-core terms may have been misclassified as core. This is included to show that not every clustering algorithm is perfect and tuning needs to be applied to optimize (by minimizing misclassification errors) clustering and associated classification. The scatter plots (123) visualize how phrases group under different tuning settings per incoming attack voice. (120—Specifying and applying customizations and corresponding code snippet to retrieve previously specified custom preferences for a set of attack types, wherein the preferences contain specified or prescribed tolerance limits (lower, upper) respectively per attack type. These tolerance limits are then applied successively per on phrase cloud entries to include/exclude. A more inclusive filter indicates a loosened focus while a more exclusive filter indicates a tightened focus.

```
  (12201-
while(incomingVoice=listen( ))
{
  customizations=getCustomizedPreferencesFor(incomingVoice)
  applyCustomizations(customizations)
}
def applyCustomizations(customizations):
For customization in customizations:
  attackCategory,lower,upper= extractToleranceLimits(customization)
  filteredCloud=filterPhraseCloud(getPhraseCloud(attackCategory),lower,
upper),
””)),
).
```

The settings are labeled (1231—“Loosened Focus”) and (1232—“Tightened Focus),” and adjacent gauge, which are part of interactive visual interface as stated above—(1235—“Zap most”) and (1236—“Zap only Core”)—indicate the system's current sensitivity and response strategy, guided by the user.

(1236—“Zap only the Core”) and (1232—“Tightened Focus)” work together. That is, user can choose to focus on eliminating the core intent (which gets shrouded in peripheral or non-core attacks), behind such attacks as those depicted in table (1232).

| | Phrase | Cluster | Type |
|---|---|---|---|
| 2 | Steal | 0 | core |
| 3 | Snatch | 0 | core |
| 5 | Rob | 0 | core |
| 1 | Ransack | 0 | core |

This embodiment demonstrates how the Data Visualization Engine enhances transparency, allows real-time tuning, and supports adaptive decision-making in threat detection systems.

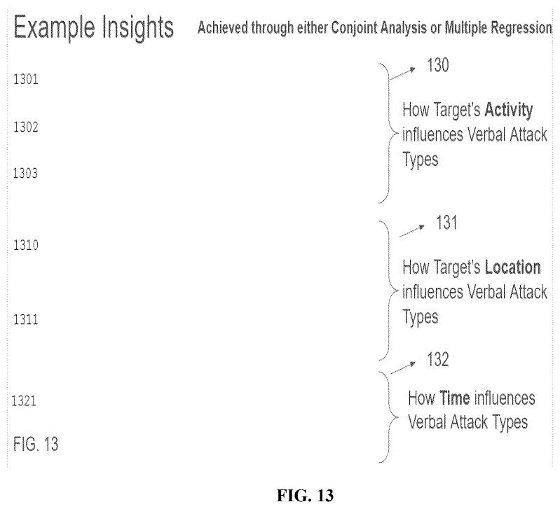

In an example embodiment, the statistical engine within the data analytics and visualization engine configured to perform contextual behavioral analysis by applying conjoint analysis of regression-based techniques on multimodal data streams is disclosed, as illustrated in FIG. 13. The analysis produces “Example Insights” which quantify the influence of contextual variables-including target activity, location, and time of day—on the likelihood of specific verbal attack types. The resulting insights (130—How Target's Activity influences Verbal Attack Types, 131—How Target's Location influences Verbal Attack Types, and 132—How Time influences Verbal Attack Types) are stored in the Insights Database and visualized for interpretation. As shown in FIG. 13, the engine determines that being in 1301—Activity 1—Gym increases the odds of Sexual Slurs by 25.98%, and 1302—(Activity 2—Work/Desk increases it by 35%). In contrast, 1303—(Activity 3—Sleep) shows no significant effect. Location-based insights reveal that 1310—(being at Home raises the likelihood of Sexual Slurs by approximately 22.17%, whereas being at the Gym reduces it by 27.73%). Time-related patterns indicate that 1311—(Evening increases Sexual Slurs by 10%, whereas Afternoon decreases the likelihood of SexualSlurs' by approximately 10.34%.) and 1321—(Evening increases Alternating Trash Talk by 24.19%, and Afternoon decreases Alternating Trash Talk by 25.82%). These insights, derived using Conjoint Analysis or Multiple Regression, inform the Modus Operandi Detection Module and support the Profiling Engine in dynamically understanding evolving aggression contexts, thereby enhancing predictive accuracy and real-time risk assessment.

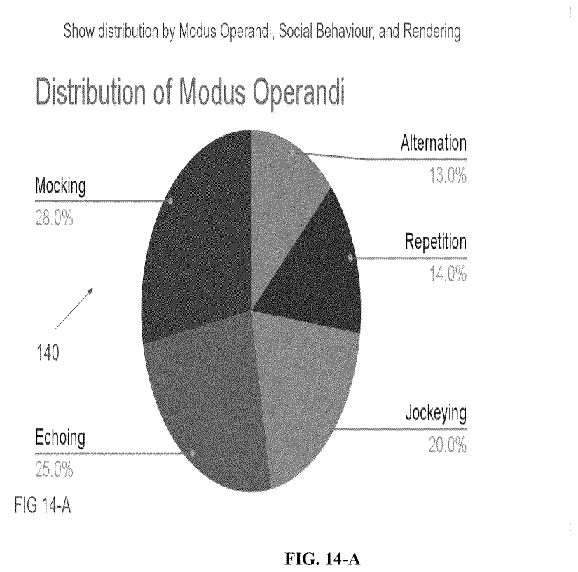

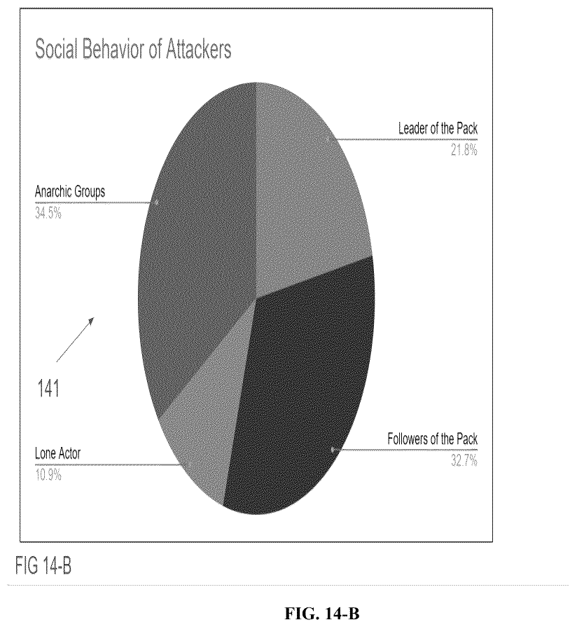

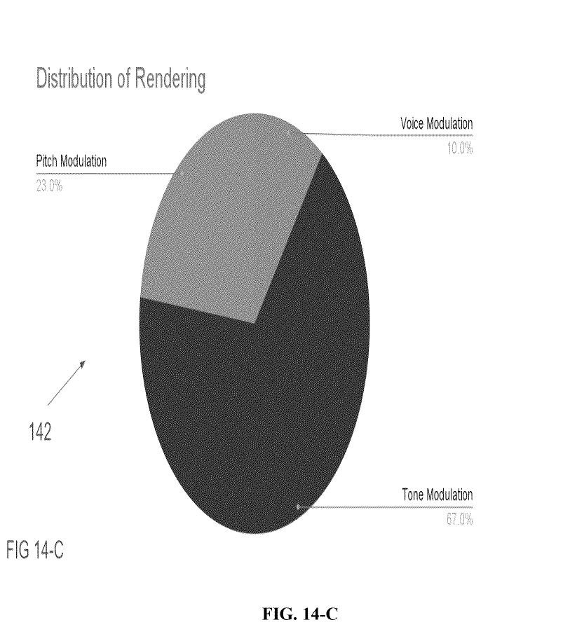

In another example embodiment, as illustrated in FIG. 14 (A-C), the data analytics and visualization engine are disclosed for analyzing and visualizing harmful verbal attacks through pie charts that depict the distribution of various characteristics, including as depicted in FIG. 14A, modus operandi, as depicted in FIG. 14B, social behavior of attackers, and as depicted in FIG. 14C, rendering. The system generates these visualizations via the profiling engine, which aggregates data from detected verbal attacks, providing key insights into their nature. As depicted in FIG. 14A, The distribution of modus operandi pie chart (FIG. 14A-140) highlights the frequency of attack tactics employed in harmful interactions, revealing mocking as the most prevalent at 28.0%, followed by echoing at 25.0%, jockeying at 20.0%, repetition at 14.0%, and alternation at 13.0% (gray). This classification aids in understanding the strategies most commonly used by attackers. As depicted in FIG. 14B, Tthe social behavior of attackers' chart (FIG. 14B-141) illustrates the social dynamics within these interactions, indicating that a significant portion (34.5%) involves anarchic groups—the largest category—and other categories include leader of the pack (21.8%), followers of the pack (32.7%), and lone actors (10.9%), highlighting the various group structures and individual motivations within harmful verbal attacks. As depicted in FIG. 14C, Tthe distribution of the rendering chart (FIG. 14C-142) focuses on the acoustic characteristics present in the attacks, with tone modulation representing the majority at 67.0%, followed by pitch modulation at 23.0% and voice modulation at 10.0%, underscoring the predominant acoustic features that accompany verbal assaults. The entire system effectively integrates various modules: the profiling engine aggregates and analyzes modus operandi, social behavior, and rendering features; the modus operandi detection module identifies and categorizes different attack tactics; the social behavior mapper assesses interactions among attackers; and the rendering/modulation detector evaluates the acoustic traits of speech.

In another example embodiment, as illustrated in the Table 2 and Table 3 below, a comprehensive analysis of verbal attack types is presented, outlining how use of different acoustic features (pitch, tone, volume) and deploying of modus operandi tactics (alternation, mocking, echoing, jockeying, repetition) vary depending on the specific type of verbal attack detected, including threat, sexual slurs, and disinformation. The data is likely processed by the Behavior Detection Module, which incorporates various detectors and is summarized by the Data Analytics and Visualization Engine. In Table 2 the acoustic feature variation by Attack Type reveals that during a “Threat,” the use of pitch modulation exceeds more than twice compared to other tactics being tone and volume respectively, the tone is over three times compared to other tactics being pitch and volume respectively, and the volume is more than 1.4 times the other tactics being pitch and tone respectively, and. In table 3, indicates the prevalence of specific tactics during a “Threat,” with Alternation being used more than twice as frequently, Mocking occurring more than three times as often, Echoing appearing over 1.4 times more frequently, Jockeying being executed three times as frequently, and Repetition occurring at 2.1 times than others; To clarify the relationship to the modules, the Behavior Detection Module, which encompasses the various detectors for acoustic features and Modus Operandi tactics, performs the analysis that identifies variations based on the detected attack type, and the Attack Type Detector categorizes verbal attacks into Threat, Sexual Slurs, or Disinformation, facilitating this comparative analysis. The Data Analytics and Visualization Engine compiles and presents the analysis in a structured table format, enhancing comprehension.

TABLE 2
Acoustic feature variation by Attack Type

| By Attack Type | Pitch | Tone | Volume |
|---|---|---|---|
| Threat | >2 times | >3 times | >1.4 times |
| | Vs Rest | Vs Rest | Vs Rest |
| Sexual Slurs | . . . | . . . | . . . |
| Disinformation | . . . | . . . | . . . |

TABLE 3
Modus Operandi variation by Attack Type

| By Attack Type | Alternation | Mockeying | Echoing | Jockeying | Repetition |
|---|---|---|---|---|---|
| Threat | >2 times | >3 times | >1.4 times | 3 times | 2.1 times |
| | Vs Rest | Vs Rest | Vs Rest | Vs Rest | Vs Rest |
| Sexual Slurs | . . . | . . . | . . . | . . . | |
| Disinformation | . . . | . . . | . . . | . . . | |

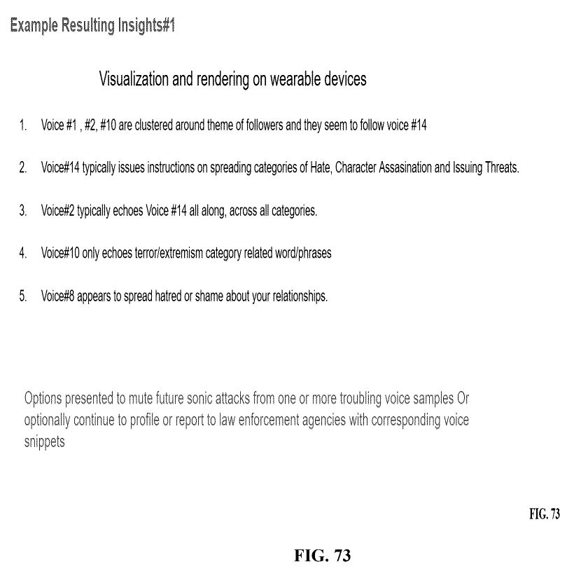

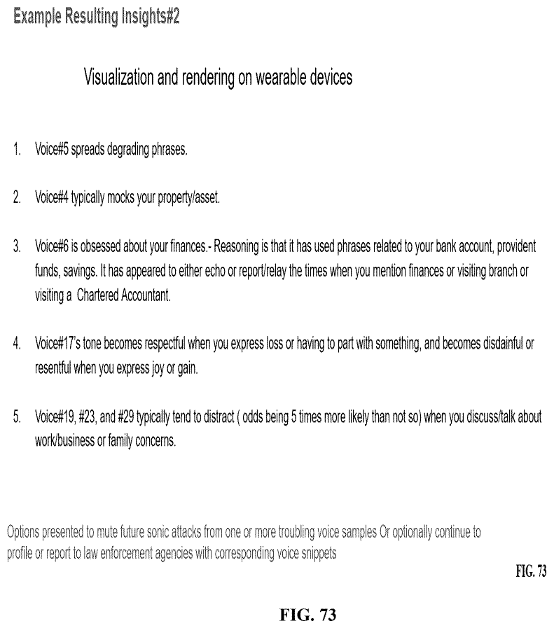

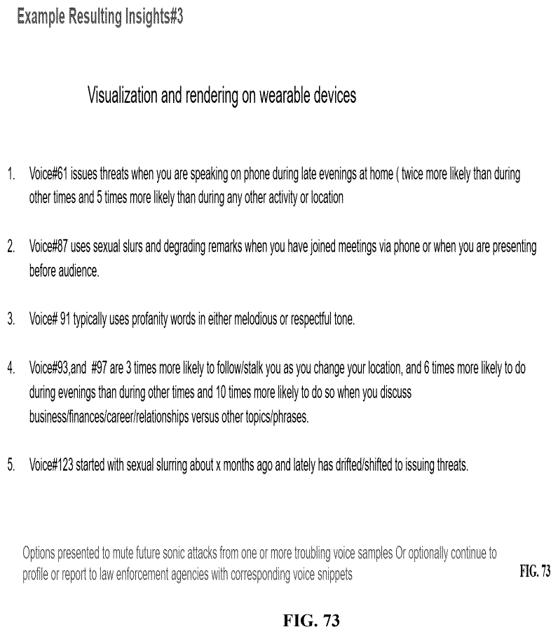

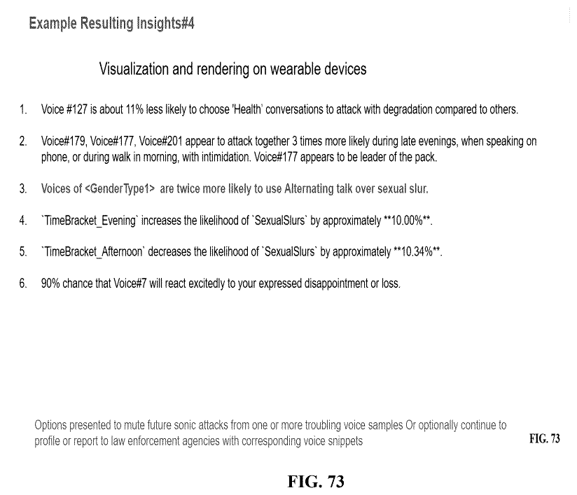

In one example embodiment, as illustrated in FIG. 73, the Insights Database captures and renders synthesized behavioral summaries based on accumulated voice activity linked to verbal aggression. It logs that Voice #1, #2, and #10 form a cluster centered on a dominant influence by Voice #14, who drives categories including hate, character assassination, and threats. Voice #2 mirrors the patterns of Voice #14 across all detected categories, and Voice #10 echoes content restricted to extremism. Voice #6 repeats finance-related terms connected to banking activity, reflecting a targeted interest in monetary details. Voice #87 delivers sexual slurs and degrading language during professional settings involving phone-based meetings or presentations. Context-driven shifts appear in Voice #123, which transitioned from sexual slurring to issuing threats over a defined time frame. Voice #93 and #97 increase stalking activity as the user changes location, with higher incidence during business-related conversations in the evening. Voice #61 shows increased threat behavior during late evening phone use at home. The system tracks coordinated actions where Voice #177, #179, and #201 launch intimidation attacks together under specific temporal and activity-based conditions. Emotional reactions are documented, where Voice #7 displays increased activity during moments of user-expressed loss. The database links time, topic, and location with voice behavior, offering actionable insight and probabilities tied to aggression dynamics.

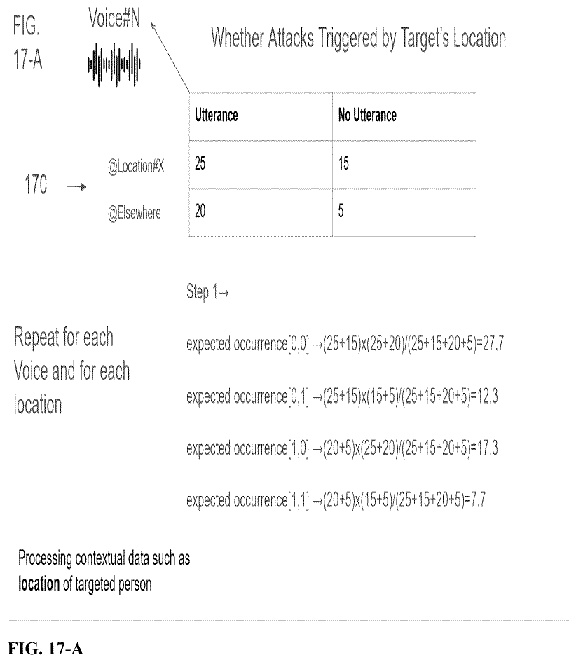

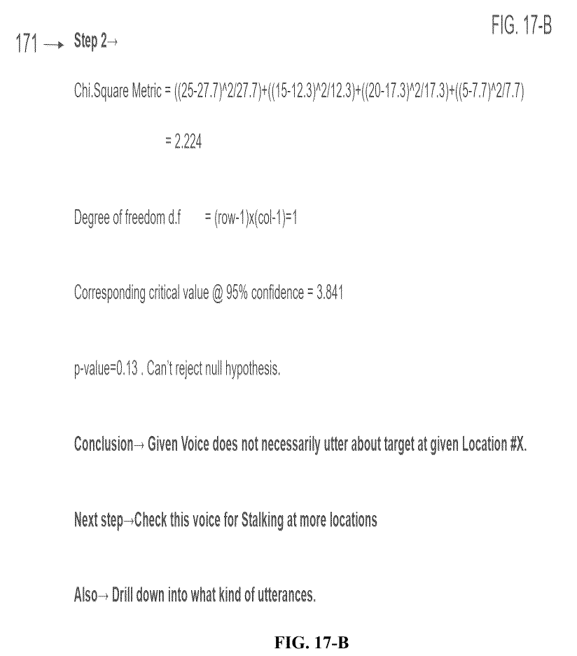

In an example embodiment, the context classification module, operatively connected to the data analytics and visualization engine, is disclosed for analyzing whether utterances by a given voice (e.g., “Voice #N”) are triggered by the Target's Location, as illustrated in FIG. 17A and FIG. 17B. As depicted in FIG. 17A, The system compares utterance frequency when the target is present at a specific location (e.g., Location #X) versus when they are elsewhere. A contingency table (170) captures observed occurrences, and expected frequencies are calculated under the null hypothesis of independence using standard probability formulas. As depicted in FIG. 17B, a Chi-square test (171) is then performed, yielding a test statistic (χ²=2.224) and p-value (0.13). Since the result falls below the critical threshold (3.841 @ 95% confidence), the analysis concludes that there is no statistically significant evidence that the target's presence at Location #X triggers utterances by Voice #N. However, the system flags the voice for continued monitoring across other locations, using the stalking detection function of the modus operandi detector, which seeks patterns of repeated behavior across contexts.

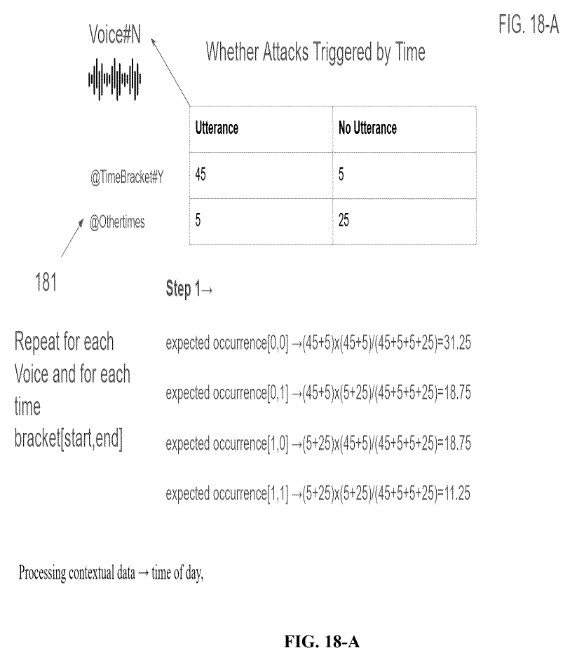

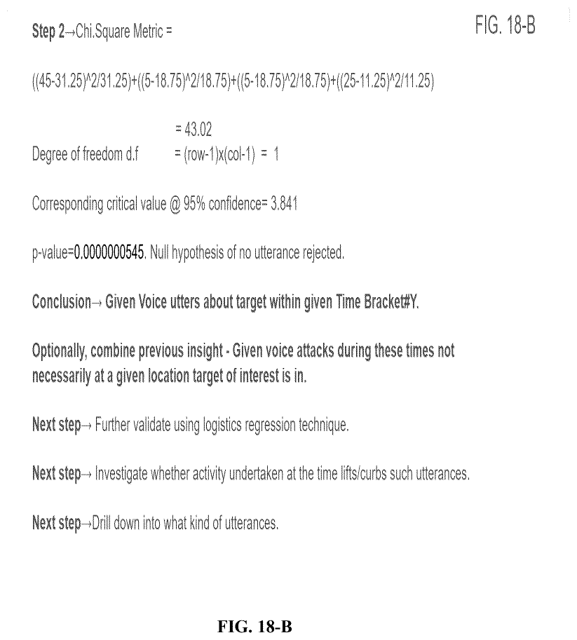

In an example embodiment, as depicted in FIG. 18A, statistical analysis of attacks (voice utterances) related to a target by “Voice #N” within a specific “Time Bracket #Y,” compared to other times (denoted as “@Othertimes”) is disclosed. This analysis utilizes the Context Classification Module (Time Detection) and the Data Analytics and Visualization Engine for statistical testing, with a focus on understanding the relationship between time of day and the frequency of utterances. The contingency table (FIG. 18A-181) displays the observed frequencies of Voice #N's utterances: during TimeBracket #Y and @Othertimes.
Step 1: To calculate the expected frequencies under the assumption that time bracket and utterance occurrence are independent.

$${E}_{[ 0 , 0 ]} = \frac{( 50 \times 50 )}{80} = 31.25 , {E}_{[ 0 , 1 ]} = \frac{( 50 \times 30 )}{80} = 18.75$$

$${E}_{[ 1 , 0 ]} = \frac{( 30 \times 50 )}{80} = 18.75 , {E}_{[ 1 , 1 ]} = \frac{( 30 \times 30 )}{80} = 11.25$$

Step 2: As depicted in FIG. 18B, To apply a Chi-Square test to evaluate the relationship between time brackets and utterances. (FIG. 18-B)

$${χ}^{2} = \frac{{( 45 - 31.25 )}^{2}}{31.25} + \frac{{( 5 - 18.75 )}^{2}}{18.75} + \frac{{( 5 - 18.75 )}^{2}}{18.75} + \frac{{( 25 - 11.25 )}^{2}}{11.25}$$

$${χ}^{2} = 43.02$$

So, Degrees of Freedom (d.f.): (2−1)(2−1)=1
Critical value @ 95% confidence: 3.841
p-value: 5.45×10⁻⁸
Step 3: To interpret the results
Since χ²=43.02>3.841 and p-value<<0.05, the result is highly significant.
The null hypothesis (“utterances are independent of time bracket”) is rejected.
Step 4: Conclusion
There is statistically significant evidence that voice utterances about the target occur disproportionately during Time Bracket #Y.
This implies a behavioral pattern—e.g., heightened verbal reference to the target during specific time windows.
To incorporate logistic regression, the analysis treats the presence of utterances as a binary dependent variable, using predictors including time, location, and activity type to model the likelihood of utterance occurrence based on contextual factors.
Activity influence is assessed to determine whether behaviors during specific time brackets increase or suppress utterance frequency, potentially using timestamped behavioral logs or sensor data. Additionally, content and sentiment analysis is performed to categorize utterances into types including threats, queries, commands, or emotional language, helping infer the speaker's intent, urgency, or psychological state.

The analysis highlights the significance of the time of day as a trigger for these attacks, and further steps are recommended to explore the attacker's or target's activities during this period and identify the nature of the utterance

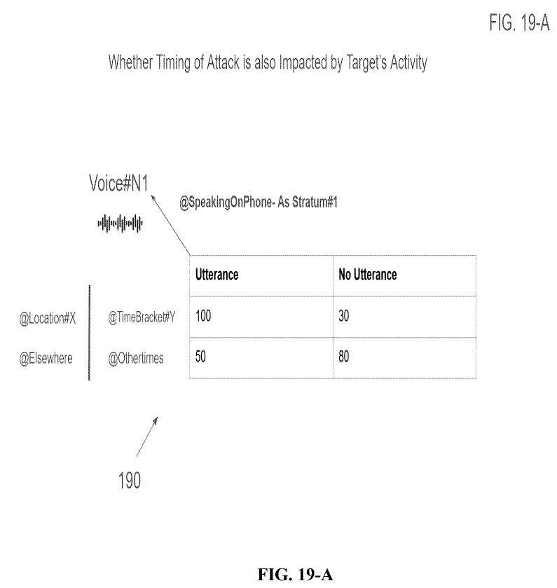

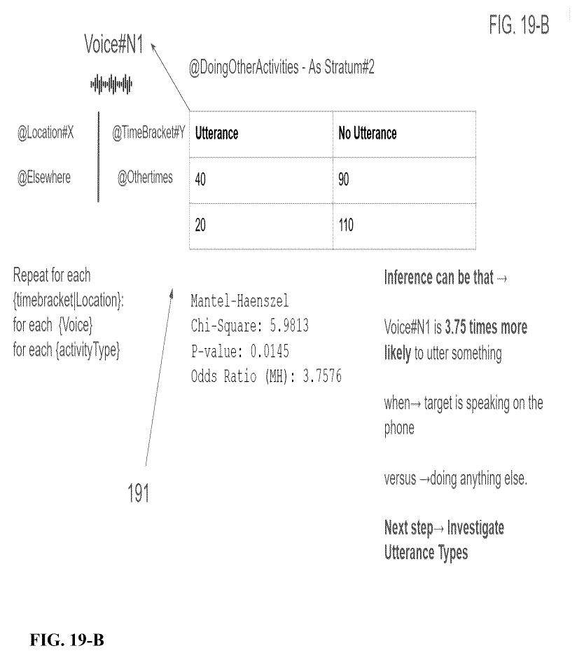

In an example embodiment, the Statistical Engine within the Data Analytics and Visualization Engine, configured to analyze whether the timing of attacks by “Voice #N1” is influenced by the target's activity, is disclosed, as illustrated in the FIG. 19A. This engine compares utterance behavior across different time brackets and locations, conditioned on two distinct activities of the target including Speaking on Phone (Stratum #1) as depicted in FIG. 19A and Doing Other Activities (Stratum #2) as depicted in FIG. 19B. The engine uses the Mantel-Haenszel Chi-Square test as one possible method to detect consistent effects of the target's activity across different contexts. The engine prepares contingency tables for each combination of target activity, location, and time bracket, showing frequencies of utterances by Voice #N1 under these conditions. For example, as depicted in FIG. 19A, when the target is speaking on the phone (stratum #1), the table (190) shows 100 utterances at @Location #X during @TimeBracket #Y, compared to 50 utterances at @Elsewhere during @Othertimes. As depicted in FIG. 19B, when the target is engaged in other activities (stratum #2), the table (191) indicates fewer utterances: 40 at @Location #X and 20 at @Elsewhere during the respective time periods. The Mantel-Haenszel Chi-Square test calculates an Odds Ratio of 3.7576, indicating that Voice #N1 is 3.75 times more likely to utter something when the target is speaking on the phone than when the target is doing other activities. This analysis is repeated across various combinations of time brackets, locations, voices, and activity types, allowing the Statistical Engine to comprehensively assess the impact of different contextual factors on utterance likelihood.

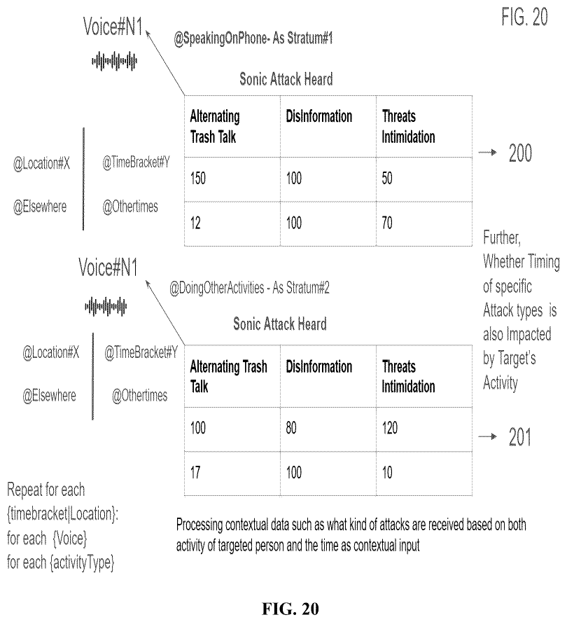

In an example embodiment, the Data Analytics and Visualization Engine, configured to analyze the types of sonic attacks by “Voice #N1” based on the target's activity, is disclosed, as illustrated in FIG. 20. This engine examines how attack types like Alternating Trash Talk, Disinformation, and Threats Intimidation vary with the target's activity, location, and time. For instance, when the target is speaking on the phone (Stratum #1), the frequency of different attacks varies between locations and time brackets. Table 200 indicates that at @Location #X during @TimeBracket #Y, 150 instances of Alternating Trash Talk, 100 of Disinformation, and 50 of Threats Intimidation are noted. In contrast, when the target is engaged in other activities (Stratum #2, Table 201), attack patterns change, with 100 instances of Alternating Trash Talk, 80 of Disinformation, and 120 of Threats Intimidation at @Location #X during @TimeBracket #Y. The next step involves using the Statistical Engine to assess these relationships in Table 200 and 201 through statistical analysis techniques like Chi-square tests or logistic regression.

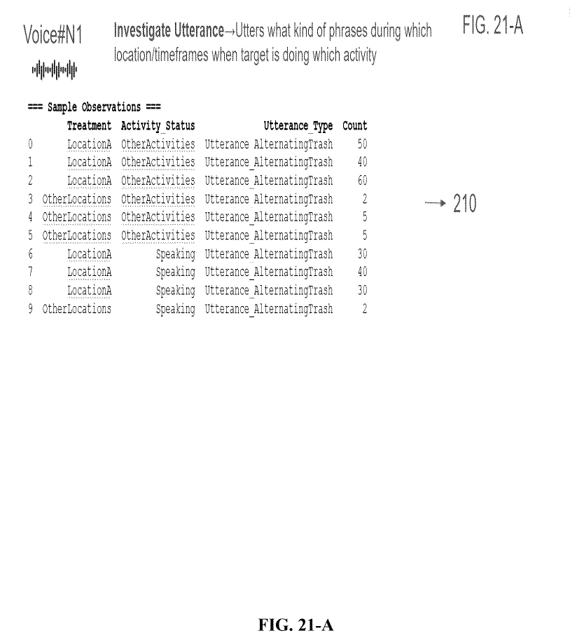

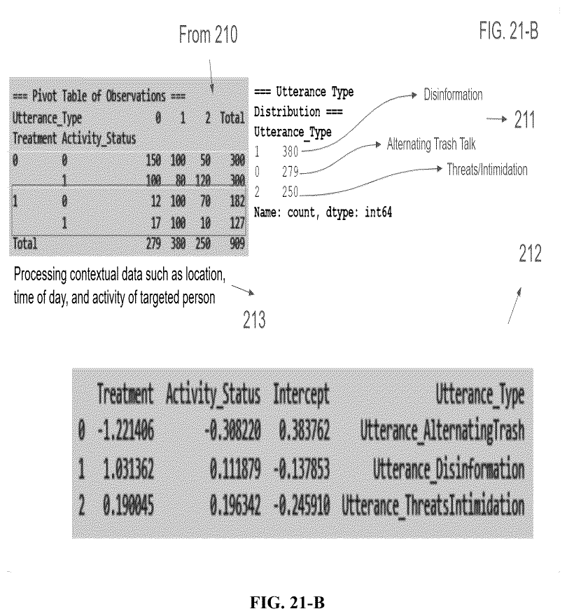

In an example embodiment, the Phrase Detector configured to analyze the types of utterances made by “Voice #N1” based on target activities and contextual triggers, is disclosed, as illustrated (210) in the FIG. 21A. The analysis examines specific phrases, categorized as “AlternatingTrash,” “Disinformation,” and “ThreatsIntimidation,” (FIG. 21B-211) that occur when the target is engaged in different activities, including speaking on the phone or performing other tasks. The context classification module provides essential data, including target activity status and timeframes, which is used to determine the relationships between these factors and the utterance types. As depicted in FIG. 21B, a pivot table (FIG. 21B-213) aggregates the data, showing the total count of each utterance type under different conditions. The Statistical Engine then uses this data to build a regression model such as a multinomial logistics regression (FIG. 21B-212), predicting the likelihood of each utterance type based on contextual factors.

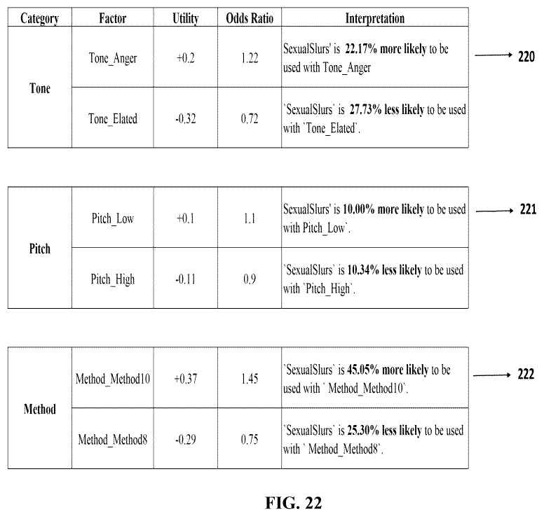

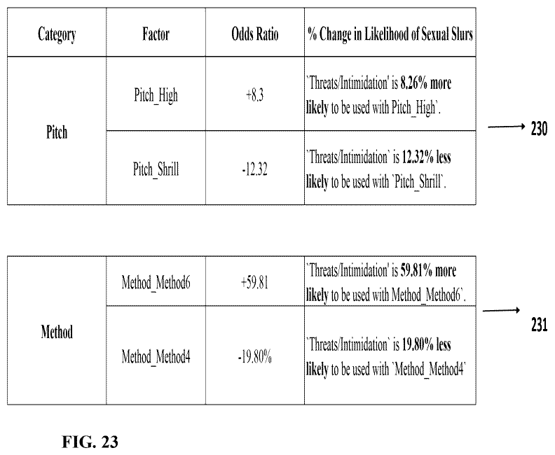

In an example embodiment, the statistical engine and computational unit within the data analytics and visualization engine performing a conjoint analysis to assess the influence of different audio features (Tone, Pitch) and “Method” (likely Modus Operandi) on the likelihood of “Sexual Slurs” and “threats intimation”, is disclosed, as illustrated in the FIGS. 22 and 23. Tone analysis (FIG. 22—Table 220) reveals that utterances containing “SexualSlurs” are 22.17% more likely to occur when the speaker's tone reflects anger. Conversely, an elated or positive emotional tone reduces the likelihood of such utterances by 27.73%. Pitch analysis (FIG. 22—Table 221) reveals a lower vocal pitch is associated with an increase of 10% in the likelihood of slur usage, suggesting more controlled, possibly intense speech whereas a higher pitch may reflect emotional regulation or non-threatening intent, reducing slur usage. Method analysis (FIG. 22—Table 222) reveals that communication style or rendering or modus operandi labeled “Method10” (possibly aggressive, confrontational, or emotionally charged) significantly increases the use of slurs whereas “Method8” (possibly formal, restrained, or passive) shows a strong dampening effect on such utterances.

In a behavioral signal analysis for predicting threats/intimidation in speech (FIG. 23), Method analysis (FIG. 23—Table 230) reveals communication labeled as Method6 is 59.81% more likely to be used with threatening or intimidating speech-possibly indicating direct or indirect confrontation, coercive language, or verbal escalation tactics whereas Method4 likely represents restrained, formal, or deflective dialogue, may be 19.80% less likely to be used when delivering threats. Pitch analysis (FIG. 23—Table 231) reveals a high pitch can correspond to intense or emotionally charged communication 8.26% more likely to be used in delivering threats/intimidation, whereas a shrill pitch appears to be 12.32% less likely to be used to deliver threat or intimidation. Thus, the Data Analytics and Visualization Engine calculates the utilities and odds ratios, providing valuable insights into the factors that influence harmful verbal behaviors, whether through tone, pitch, or method.

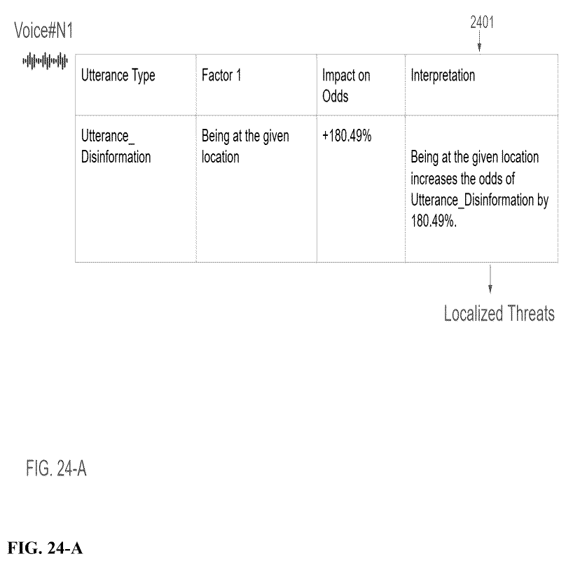

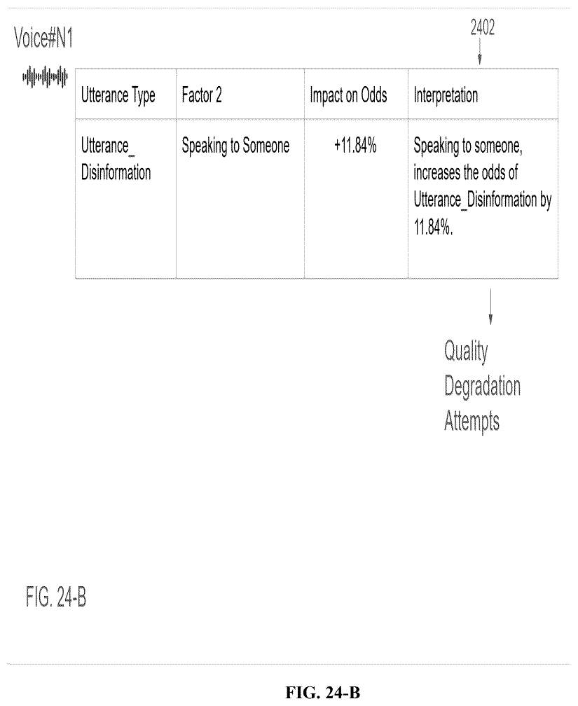

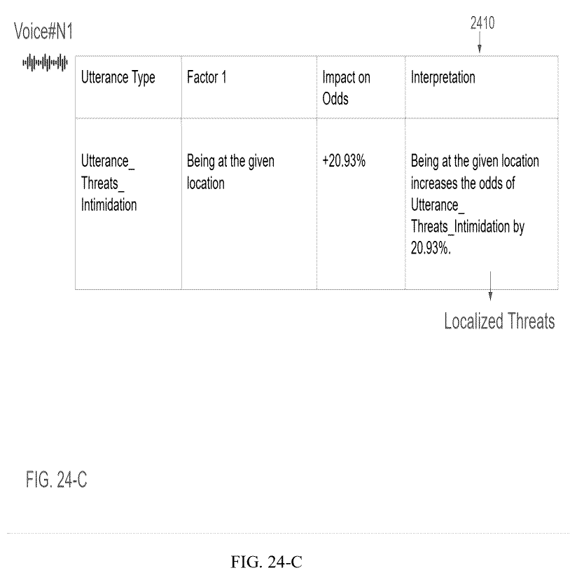

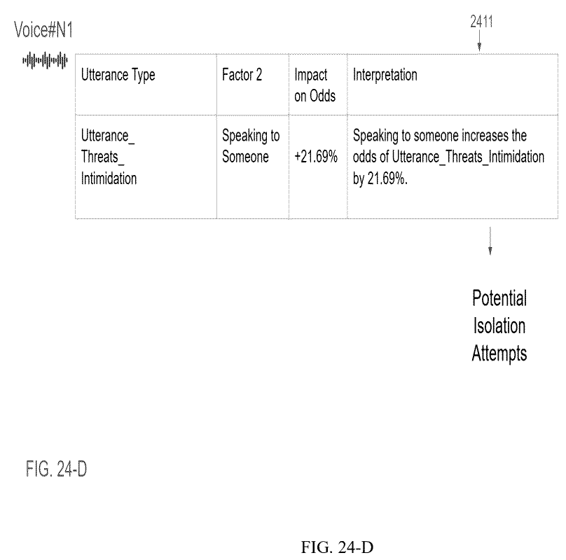

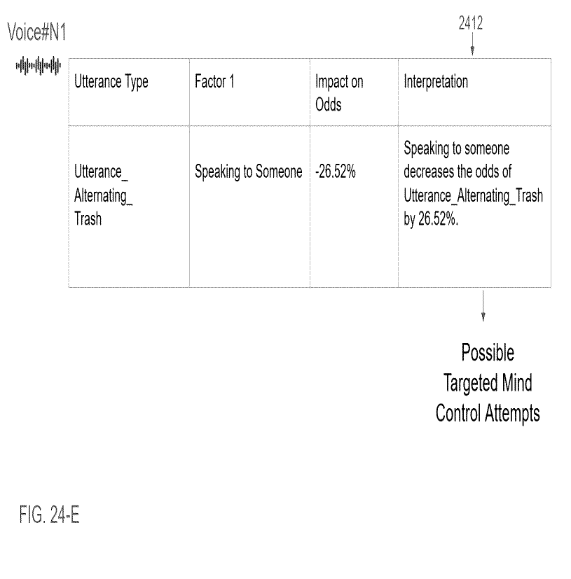

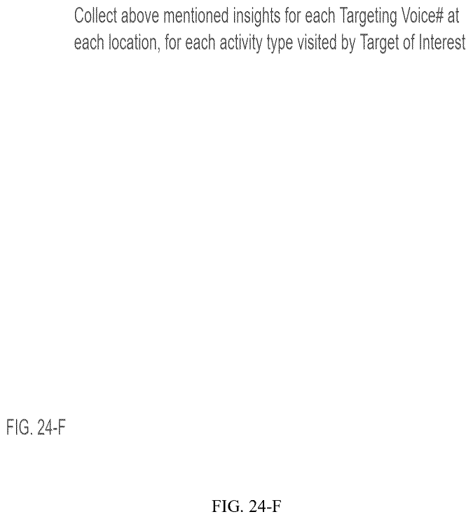

In an example embodiment, the statistical engine within the data analytics and visualization engine configured to analyze the influence of contextual factors including “Treatment” (being at a given location) and “Speaking to someone” on the odds of specific utterance types (“Disinformation,” “Threats/Intimidation,” “Alternating Trash Talk”) for “Voice #N1,” is disclosed, as illustrated in the FIG. 24(A-F). The analysis involves calculating odds ratios and utility scores to measure the impact of these factors on verbal aggression. The results (interpretations namely as depicted in FIG. 24A—2401, FIG. 24B—2402, FIG. 24C—2410, and FIG. 24D—2411) show that “Disinformation (as depicted in FIG. 24A—2401) is 180.4% more likely when the targeted person is at a specific location, and as FIG. 24B-2402 illustrates when the targeted person is speaking to someone, it slightly increases the odds of being subjected to disinformation attacks by 11.84%. In the case of “Threats/Intimidation attacks (as depicted in FIG. 24BC—240210),” the odds increases by 20.93% when the targeted person is at the given location and by 21.69% (as depicted in FIG. 24D—2411) when s/he is speaking to someone. For “Alternating Trash Talk (FIG. 24C—2410),” however, speaking to someone decreases (as depicted in FIG. 24E—2412) the odds by 26.52%. Again, all these derived insights (as depicted in FIG. 24-F—“Collect above mentioned insights for each Targeting Voice #at each location, for each activity type visited by Target of Interest”) are subjective and listed to serve as an illustration only and will vary from person to person as per the situational context applicable to them. These insights are processed by the Statistical Engine to help assess the intent or behavior of the attacker, highlighting potential territorial aggression, psychological manipulation, or isolation tactics.

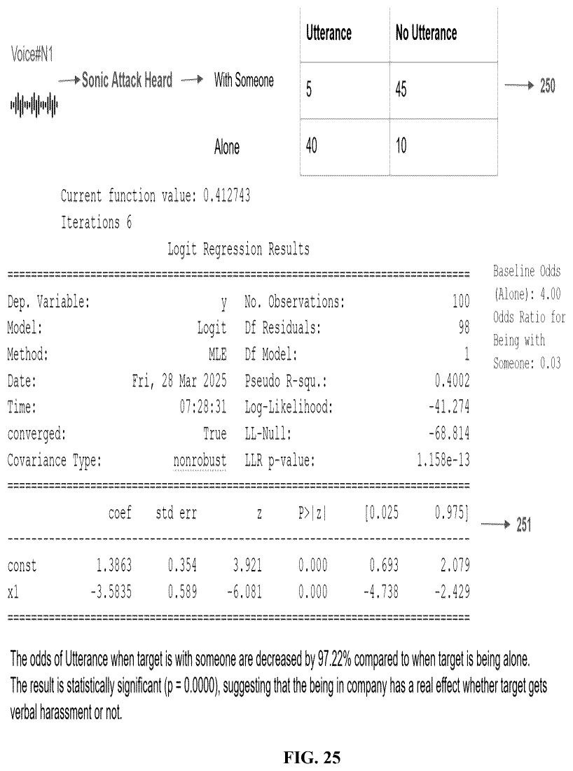

In an example embodiment, the statistical engine within the data analytics and visualization engine performing a Logistic Regression (251) to analyze the influence of the target's social context (“Alone” vs. “With Someone”) on the likelihood of verbal attacks from “Voice #N1.”, is disclosed, as illustrated in the FIG. 25. The presented logistic regression analysis investigates the relationship between an utterance from Voice #N1 during a “Sonic Attack Heard” event and the social context of the target (alone versus with someone). The initial contingency tables (250) reveal a higher frequency of utterances when the target is alone (40 out of 50 instances) compared to when the target is with someone (5 out of 50 instances). The logit regression results, with a significant likelihood ratio p-value (1.158e−13), confirm that the model is statistically significant. The negative coefficient for the predictor variable (x1=−3.5835) indicates an inverse relationship between being with someone and the likelihood of an utterance. The crucial finding is the odds ratio for “Being with Someone,” which is 0.03. This translates to a 97.22% decrease in the odds of an utterance from Voice #N1 when the target is in company compared to when alone. This substantial reduction, coupled with a highly significant p-value (p=0.0000) for the predictor, strongly suggests that the target's social context has a real and statistically significant effect on the probability of Voice #N1 making an utterance during a sonic attack. The interpretation concludes that being in company significantly reduces the likelihood of an utterance from Voice #N1, implying that the social environment plays a role in whether or not Voice #N1 engages in vocal behavior during such events, potentially related to verbal harassment. This quantitative analysis provides strong evidence for the influence of social context on the vocal behavior of Voice #N1 in the scenario of a perceived sonic attack.

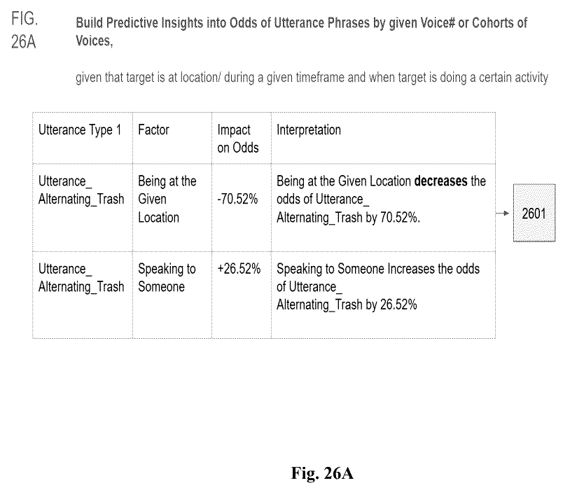

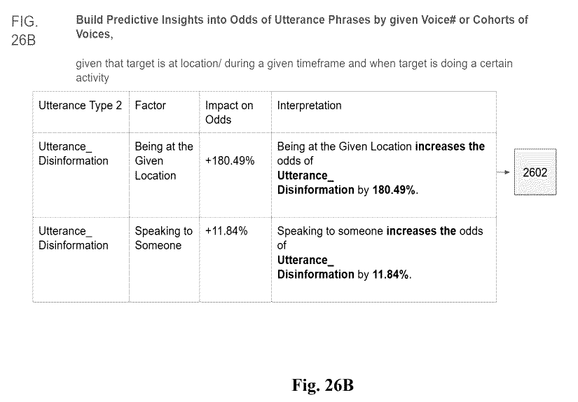

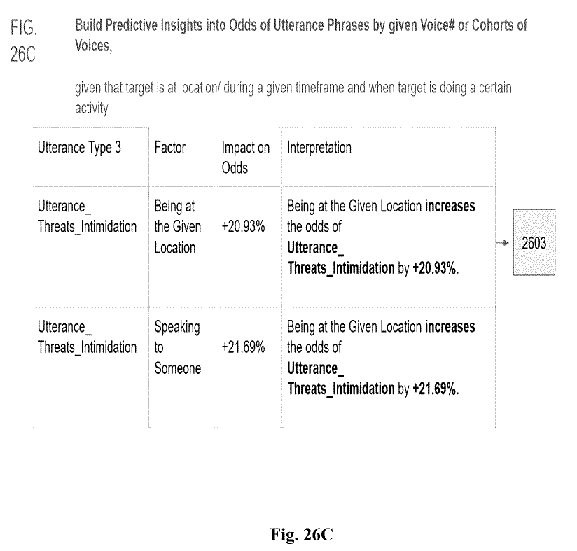

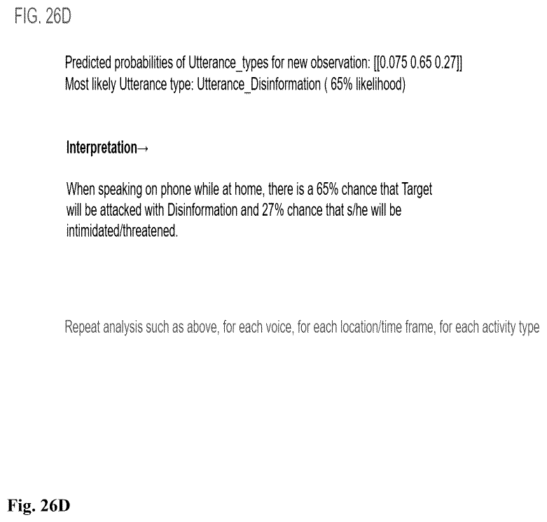

In an example embodiment, the data analytics and visualization engine, utilizing data from the Insights DB, and conducting predictive analysis to assess the likelihood of different utterance phrases by a given “Voice #” based on the target's location, timeframe, and activity, is disclosed, as illustrated in FIG. 26(A-D). The results (FIG. 26A—2601, FIG. 26B—2602, FIG. 26C—2603) show how contextual factors influence various utterances: for instance, as depicted in FIG. 26B, being at a specific location increases the odds of “Utterance_Disinformation” by 180.49% (FIG. 26AB—26012), while speaking to someone increases the odds of “Utterance_Disinformation” by 11.84%, (FIG. 26B—2602) and as depicted in FIG. 26A, speaking to someone increases the odds of “Utterance_AlternatingTrash” by 26.52%, while being at a given location (going to a bar versus going to classroom), subjects target to decreased odds of Alternating_trash kind of attacks. (FIG. 26A—2601). Moreover, as depicted in FIG. 26B, speaking to someone increases the odds of “Utterance_Disinformation” by 11.84% (FIG. 26B—2602). Further, as depicted in FIG. 26C, being at the given location increases the odds of “Utterance_Threats_Intimidation” by 21.69% (FIG. 26C—2603), while speaking to someone increases the odds of “Utterance_Threats_Intimidation” by 20.93%. As depicted in FIG. 26D, The system generates predicted probabilities, with an example revealing a 65% chance of “Utterance_Disinformation” when the target is speaking on the phone at home and 27% chance that s/he will be intimidated and threatened. These predictive insights allow the system to forecast verbal attacks, including threats or disinformation, based on contextual factors. This analysis provides actionable insights for risk assessment and intervention strategies. The predictive models rely on historical data, allowing the system to evaluate potential threats and proactively manage harmful verbal behavior.

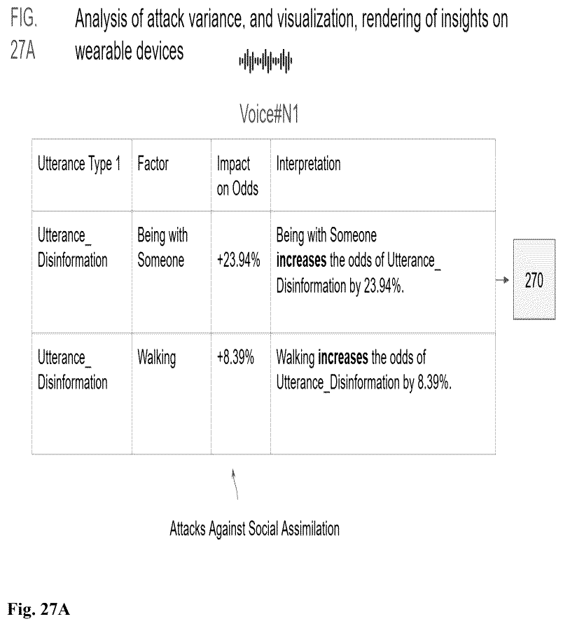

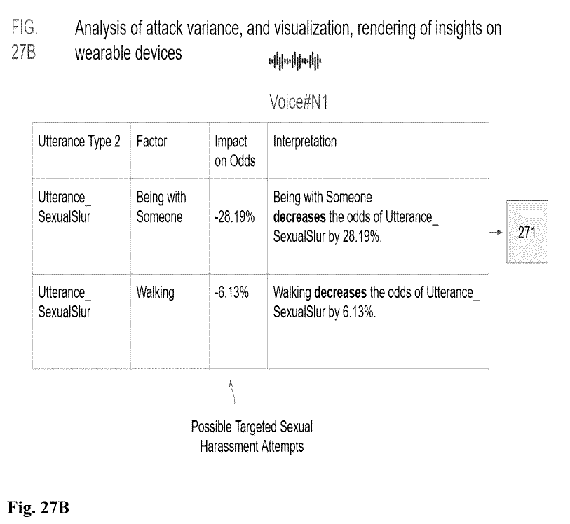

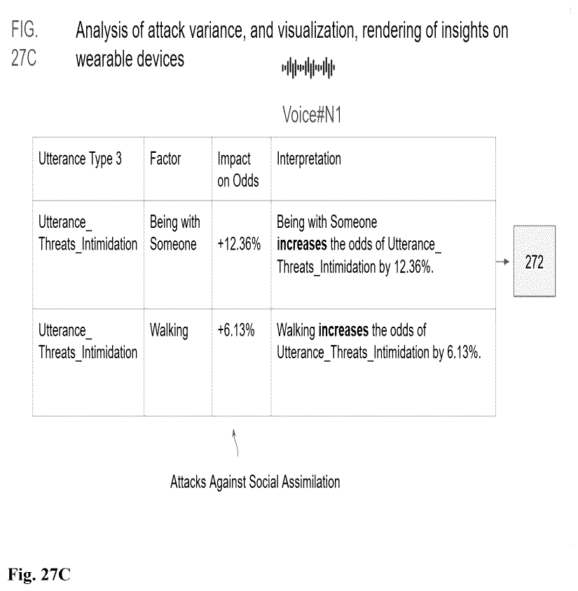

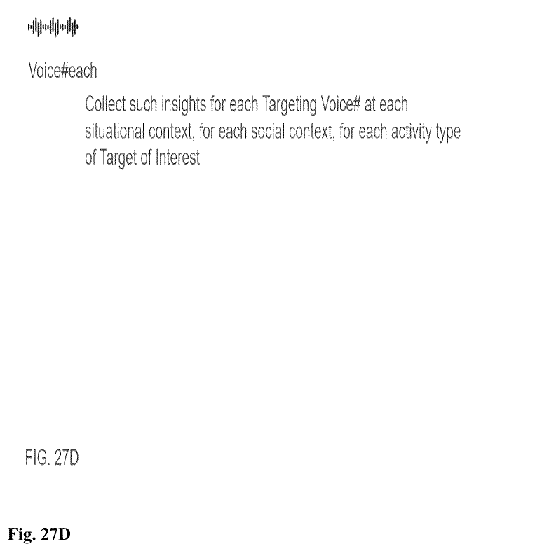

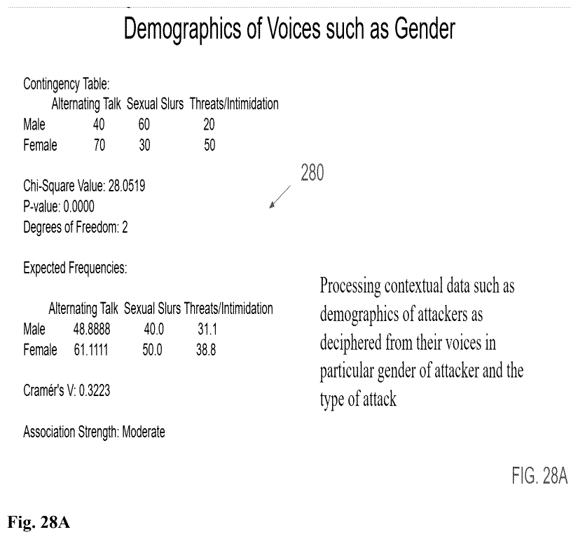

In an example embodiment as depicted in FIG. 27(A-D), the predictive simulator and data analytics and visualization engine, configured to assess how a target's behavior, including “Being with someone” or “Walking,” influences the likelihood of various utterance types (as depicted in FIG. 27A, a “Disinformation” attack type, as depicted in FIG. 27B, a “Sexual Slur” attack type and as depicted in FIG. 27C, a “Threats/Intimidation”) from “Voice #N1,” is disclosed. as illustrated in FIG. 27. The predictive model analyzes the target's actions and provides insights into how these behaviors impact verbal attacks. For example, as depicted in FIG. 27A, “Being with someone” increases the odds of “Disinformation” attacks by 23.94% (270) and as depicted in FIG. 27C, increases “Threats/Intimidation” attacks by 12.36% (272), and as depicted in FIG. 27B, decreases the odds of “Sexual Slurs” by 28.19% (271)”. The model further reveals as depicted in FIG. 27A, that “Walking” raises the odds of “Disinformation” by 8.39% (270), but reduces the odds of “Sexual Slurs” by 6.13% (271) and as depicted in FIG. 27C, further increases the odds of “Threats/Intimidation.” by 6.713% (272). As depicted in FIG. 27D, such insights are expected to be aggregated over each attack type for each attacking voice for a given target, and over each situational, social and activity context of target. These insights provide predictive insights into the verbal attack risks target is subjected to, aiding in proactive risk assessment and intervention strategies. The system allows for real-time insights, potentially viewable on wearable devices, to assess verbal threats and their context.

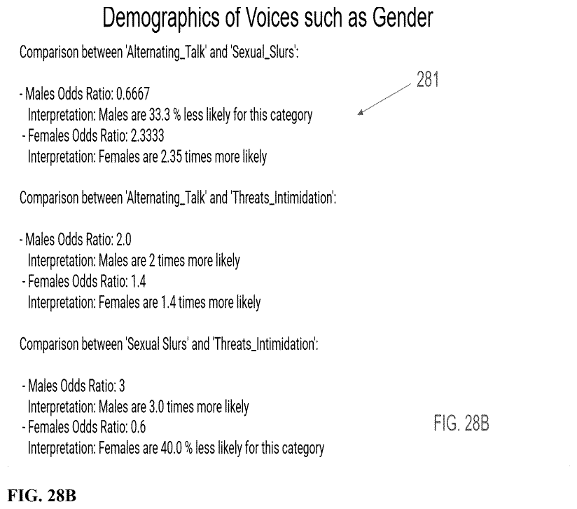

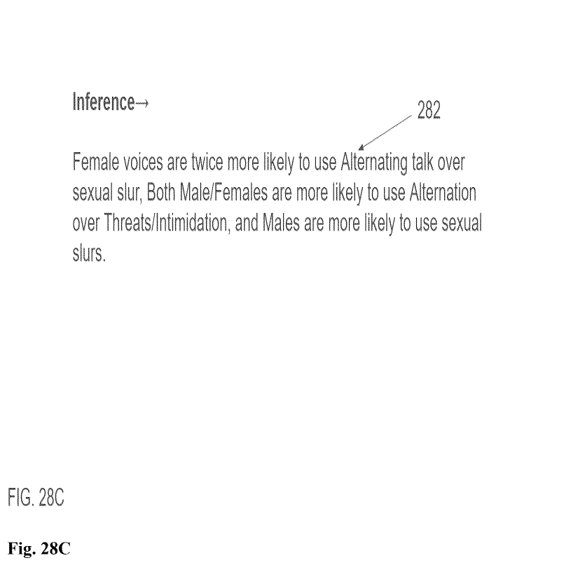

In another example embodiment, as illustrated in FIG. 28(A-B), the data analytics and visualization engine is disclosed for analyzing associations between phrase types and gender of voices. As depicted in FIG. 28A, a contingency table (280) records frequencies of Alternating Talk, Sexual Slurs, and Threats/Intimidation by male and female voices. A chi-square test yields a value of 28.0519 with p-value 0.0000, confirming a statistically significant association. Cramer's V of 0.3223 indicates moderate strength. FIG. 28B depicts the odds such as Males certain gender type are more likely to use sexual slurs; FIG. 28C depicts another potential conclusion that certain gender type females favor alternating talk. Odds ratios quantify these distinctions. This analysis aids in identifying linguistic behavior patterns tied to demographic profiles for voice-attributed content.

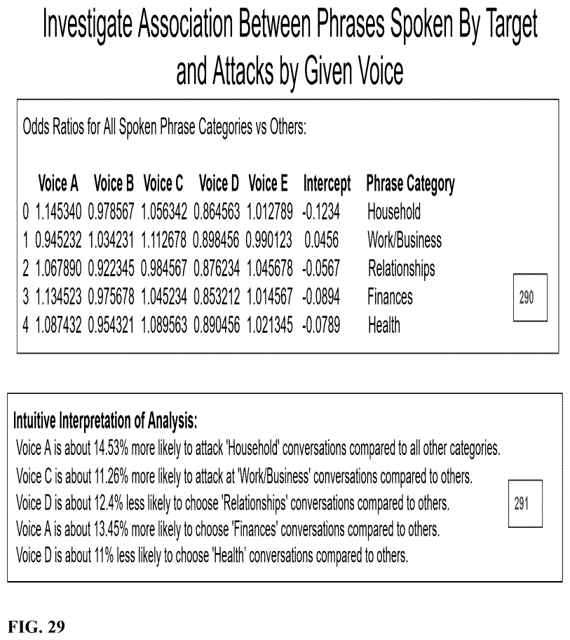

In another example embodiment, as illustrated in FIG. 29, a system using the data analytics and visualization engine is disclosed to investigate the association between phrase categories spoken by a target and subsequent attacks attributed to specific voices. In simple terms, the objective is to discover whether there is any effort to “silence” or “crowd out”. Spoken utterances are categorized into domains including household, work/business, relationships, finances, and health, and odds ratios are computed to quantify the likelihood of attack initiation by Voice A to Voice E across these categories. For instance, Voice A shows a 14.53% higher likelihood of choosing to attack “Household” phrases/topics and a 13.45% more likely to choose “Finances” related phrases/topics. Voice C shows an 11.26% increase after “Work/Business” speech. In contrast, Voice D is 12.4% less likely to go after or attack “Relationships” and 11% less likely to attack “Health” categories (290) and (291). These computed patterns are visualized through tables and graphs rendered on wearable or mobile/desktop interfaces, supporting the identification of targeted behavioral tactics based on phrase content and attack timing.

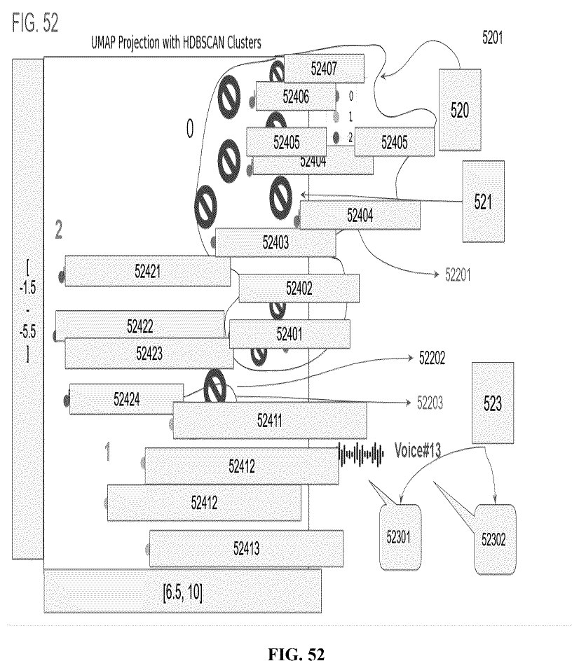

In another example embodiment, as illustrated in FIG. 52, a system that integrates the data analytics and visualization engine with the modus operandi detector is disclosed to identify behavioral patterns and classify toxic or incoherent speech through textual clustering. The system applies the UMAP dimensionality reduction technique to visualize phrase clusters derived from HDBSCAN, projecting them into a 2D space (520) where each point corresponds to a text phrase. These phrases are color-coded based on their assigned clusters: red (Cluster 0) includes emotionally charged or incoherent utterances like “he is not looking at me!” and “52401: his shirt is expensive,” green (Cluster 1) represents tech-related discourse including “Artificial intelligence is transforming tech,” and blue (Cluster 2) contains finance-related expressions like “Interest rates are rising.” The system flags misclassified entries (52202), including the phrase “52411: those overseas pants Machine learning models predict trends,” incorrectly assigned to Cluster 1 but conceptually belonging to Cluster 0. Indicators (521) highlight potential outliers within clusters, particularly within the zone (522). Additional annotations (523) show that “Voice #13” is statistically more likely to produce incoherent or degrading remarks (52301: “5 times more likely than not to use random, incoherent remarks”), and 52302: “3 times more likely than not to use degrading remarks” and suggesting behavioral profiling at the speaker level. The overall objective is to isolate meaningful data and filter out irrelevant or harmful content, (52201: “Cutting the weed and crap to focus on what matters.”) with potential applications in real-time monitoring systems or wearable technologies.

Here is a complete list of encodings used in FIG. 52

| Encodings | Description |
|---|---|
| 5201 | Data Visualization rendering on |
| | wearable devices |
| 52201 | Cutting the weed and crap to focus on |
| | what matters |
| 52202 | Erroneous instance of cluster allocation. |
| | But in principle this should belong to |
| | cluster 0. |
| 52301 | 5 times more likely than not to use |
| | random, incoherent remarks |
| 52302 | 3 times more likely than not to use |
| | degrading remarks |
| 52203 | At the same time, record for evidence |
| | collection |
| | and attribute back to perpetrators. |
| 52421 | Interest Rates. Federal Reserve |
| | Announces New Policy |
| 52422 | Investors are worried about inflation |
| 52423 | Stock Market is Volatile Today |
| 52424 | Economic Forecasts Look Grim |
| 52411 | Those Overseas pants. Machine |
| | Learning Models predict trends. |
| 52401 | His shirt is expensive. His Pants. |
| 52402 | Gosh! His shirt is creased. |
| 52403 | He is international! |
| 52404 | He is Awesome! He is not! |
| 52405 | I don't like him! He is trying too |
| | much! |
| 52406 | Look! He wants to talk . . . |
| 52407 | Look! He wants to read/type/work . . . |

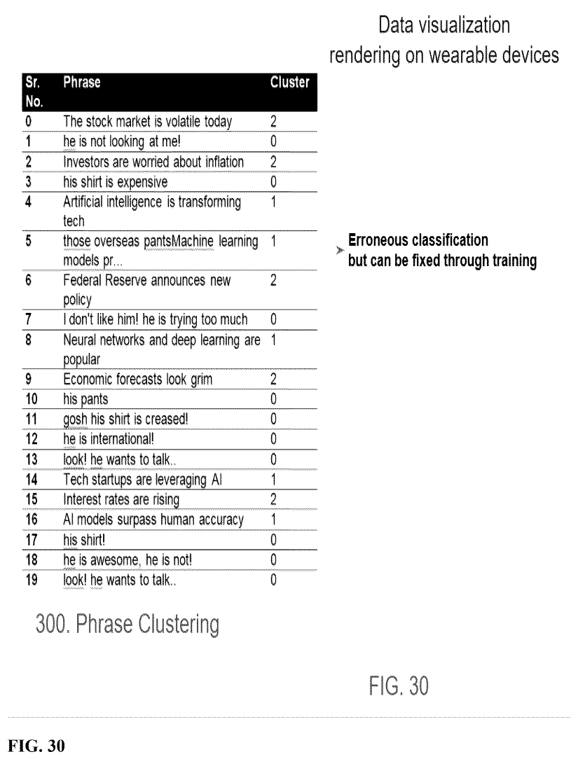

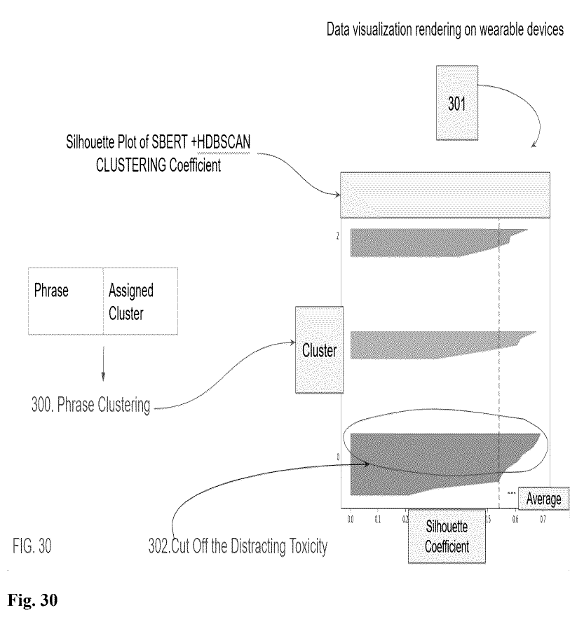

In another example embodiment, as illustrated in FIG. 30, a Data Analytics and Visualization Engine for clustering phrase-level text data and assessing classification reliability is disclosed. The system uses semantic embeddings (BERT) and density-based clustering (HDBSCAN) to categorize phrases into clusters (300), bringing together coherent topics that one is expected to pay attention to, including “52423: The stock market is volatile today” and “Investors are worried about inflation” in Cluster 0, and “52412: Artificial intelligence is transforming tech” and “52412: AI models surpass human accuracy” in Cluster 1. However, deceptively injected and uncalled for personal or emotionally charged phrases like “he is not looking at me!” and “his shirt is expensive” are grouped in Cluster 2, showing poor cohesion. Misclassified phrases, including “those overseas pants machine learning models pr . . . ,” are flagged as erroneous. However, this is a temporary limitation of un-optimized tuning of machine learning models. Provided, a model is tuned optimally, the “those overseas pants” would be assigned to Cluster 2 and “machine learning models . . . ” would be assigned to Cluster 1. A silhouette plot (301) visually assesses the quality of clustering by displaying silhouette coefficients for each phrase. Cluster 0, with many phrases showing negative silhouette scores, is identified as containing distracting or “toxic” content (302), and a red vertical line marks the average silhouette score. Stability of cluster allocation can be determined. The system enables filtering out such low-coherence or uncalled—for phrases in real-time, ensuring that only relevant content remains, to aid targeted person is focussing on what is essential and cutting out the deceptive distracting attacks, enabled through applications deployed on wearable devices including ear pods, headphones, smart glasses etc.

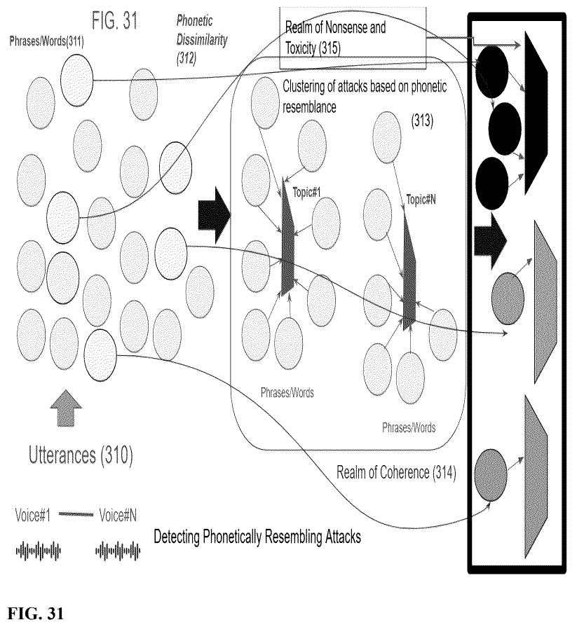

In another example embodiment, as illustrated in FIG. 31, the Data Analytics and Visualization Engine for detecting phonetically resembling attacks is disclosed. The system begins by analyzing utterances (310) from multiple voices, identifying individual phrases or words (311). It calculates phonetic dissimilarity (312) among these utterances (310) and feeds them into a clustering stage (313) where phrases are grouped based on phonetic resemblance. Since phonetically similar phrases can be misleading or rather injected deceptively, clusters form around phonetic topical anchors (Topic #1 through Topic #N) are relegated to a separate region marked as the “Realm of Nonsense and Toxicity (315). Those phrases that do not align phonetically or semantically are moved to “Realm of Coherence (314).”” For instance, “right” and “bright” will tend to be allocated to phonetic Cluster 3. Though it is nonsensical from a cognitive interpretation. From the coherent clusters, data flows into a neural classification structure where layered analysis enables further categorization and interpretation. Visual indicators, including audio signal representations, topic-centered clustering maps, and progression through analytical layers, guide users through how certain attacks mimic others phonetically to create confusion or reinforce disinformation. This configuration reveals how seemingly unrelated utterances can act in concert, allowing detailed exploration of audio-based toxicity and its patterning across speakers.

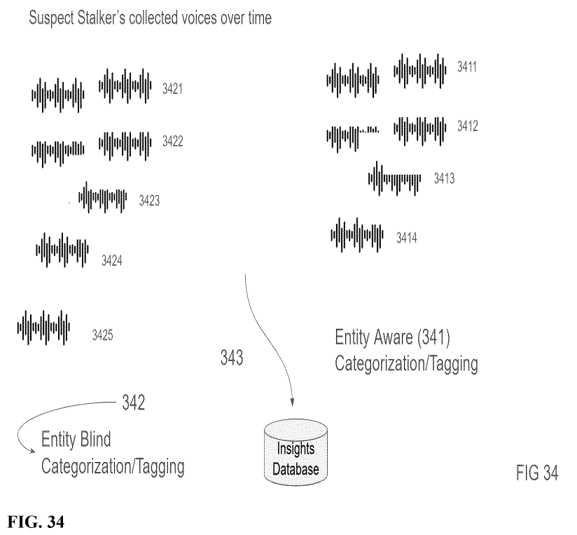

In another embodiment, as illustrated in FIG. 34, a conceptual representation of the Suspect Stalker's collected voices over time (340) is provided. This figure demonstrates how voice data collected from a suspected stalker is categorized and tagged, both with entity awareness—i.e. who is engaging in attacks (341) and without entity awareness (342, referred as blind, that is without any bias to entity, what are the various attack patterns irrespective of who is engaging in so.), and stored in the Insights Database (343). Entity Blind Categorization/Tagging (342) focuses on classifying voice data based on the type of harmful language used, including “Personal Threat Phrase (3421—“Personal Threat Phrase, Match prob-85%, and corresponding Reasoning “)” or “Insult to Dignity phrase (3422—Insult to Dignity Phrase match prob 80% and corresponding reasoning)”, or Damage to Property Phrase (3423—Damage to Property Phrase, match prob 95% and corresponding reasoning) or “Mind Control Instruction (3424—Mind control instruction phrases, match prob 95% and corresponding reasoning)”, or Sloganing/Propaganda phrases (3425—Sloganing/Propaganda phrases, match prob 95% and corresponding reasoning)” without any recognition of specific individuals. Entity Aware Categorization/Tagging (341) identifies the speaker (e.g., “Person #X”) with varying levels of match probability (3411—Person #X, match prob-95%, 3412—Person #X,matchprob—93%, 3413—Person #X,matchprob-91%, 3414—Person #X, match prob—91%), incorporating entity awareness into the categorization process. Both sets of categorized data are then directed to the Insights Database, which serves as a repository for storing speech history and behavior patterns. This data is crucial for the Profile Management System to track the stalker's harmful language use, update behavior profiles, and analyze trends for potential future actions.

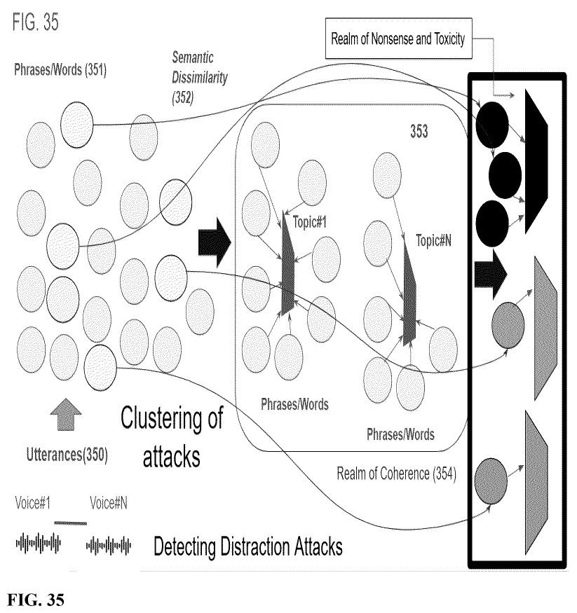

In another example embodiment, as illustrated in FIG. 35, a system integrating the Modus Operandi Detector is disclosed for detecting distraction attacks by isolating semantically incoherent utterances from coherent topic-driven speech. Incoming audio streams from multiple speakers (Voice #1 to Voice #N) are processed into discrete utterances (350), which are then mapped into a clustering mechanism (353) that evaluates semantic similarity. Semantically coherent utterances (350) are grouped into clusters labeled as Topic #1 through Topic #N within a “Realm of Coherence (354),” where phrases and words (351) are further analyzed for topic-based alignment. In contrast, utterances with high semantic dissimilarity (352) bypass the coherent clustering and are routed directly to the “Realm of Nonsense and Toxicity (355),” representing potential distraction attacks. These dissimilar utterances are flagged via red lines and are visualized as being isolated from meaningful content. The system uses this separation to process only the coherent clusters for downstream classification and filtering out noise. This layered approach enables the detection and exclusion of toxic or distracting speech based on contextual dissonance, thereby enhancing focus on relevant content and identifying behavioral tactics used to derail communication or inject confusion.

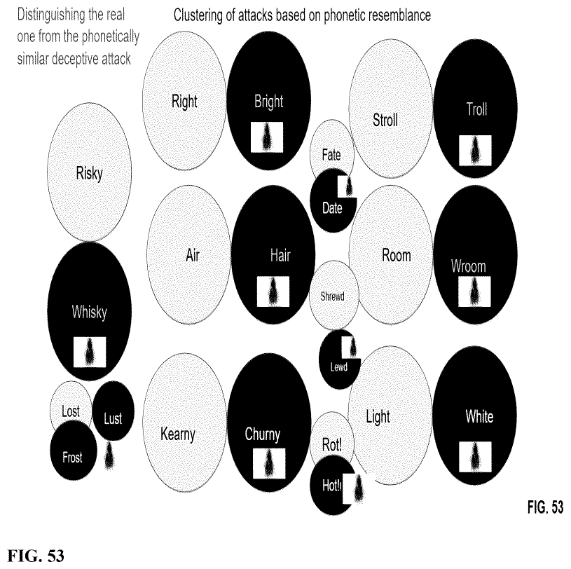

In one example embodiment, as illustrated in FIG. 53, the jockeying detector for identifying deceptive acoustic manipulation based on phonetic resemblance is disclosed. The system clusters spoken words into groups using phonetic similarity, where words that sound alike but carry different meanings are analyzed for potential misuse. Visualized through shaded circles, each cluster reflects levels of acoustic proximity, with darker shades indicating higher manipulation risk. Within these clusters, deceptive variants—including “Wroom” with “Room,” “Hair” with “Air,” “Frost” with “Lost” and “Lust,” or “White” with “Light”—are marked with embedded silhouettes, highlighting their likelihood of being intentionally misleading. The system distinguishes these deceptive utterances from legitimate ones by mapping them within a “Realm of Coherence” or flagging them into a “Realm of Nonsense and Toxicity” based on phonetic dissimilarity and user feedback. Connections between words like “Right” and “Bright,” or “Risky” and “Whisky,” are analyzed to surface patterns where acoustic jockeying is used to obscure intent or impersonate benign communication. These insights are visualized through clusters and neural classification stages, enabling detection of subtle vocal distortions and revealing orchestrated attempts to exploit phonetic likeness for cognitive interference or harassment.

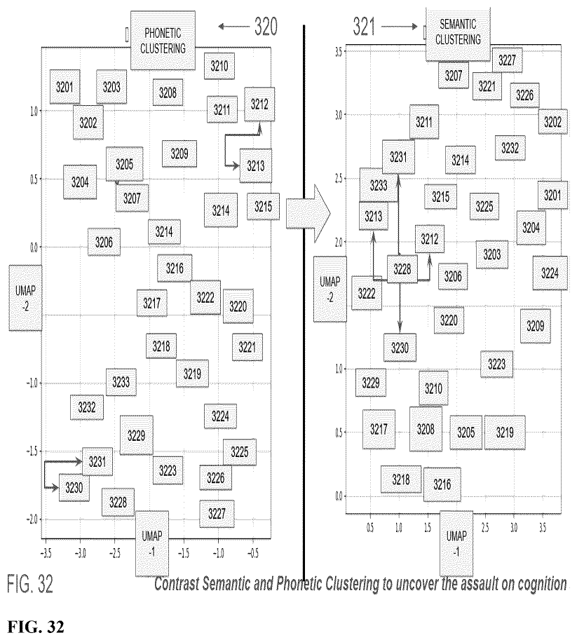

In another example embodiment, as illustrated in FIG. 32, a Data Analytics and Visualization Engine for analyzing phonetic and semantic clustering to uncover cognitive manipulation is disclosed. The system maps words to their phonetic clusters (320) and semantic groups (321), revealing how words with similar phonetic patterns, including—“flower”—(3201) and “flour”—(3202) interact with words having related phonetics (but not semantics), like “mourning”—(3218) and “morning.”—(3217) The system contrasts these clusters to identify overlaps where phonetic similarities reinforce or obscure semantic intent. For example, words like “whisky”—(3232) and “risky”—(3233) may confuse the listener, and “mourning”—(3218) and “morning”—(3217) may trigger specific cognitive states. The engine calculates associative likelihoods between words within each cluster, analyzing how they may affect cognition by amplifying or curbing psychological responses. Additionally, visual representations are provided to display the contrasting relationships between these clusters, offering insights into how linguistic patterns may be used to manipulate or harm targets through targeted word choice. For instance, “light”—(3214), “bright”—(3212) and “sight”—(3215) are clustered together semantically, while “right”—(3213) is taken out. Compared with phonetic clustering example earlier, “right”—(3213) and “bright”—(3212) were clustered together. Thus, the engine can apply additional logic to declare semantic separation as the winning distinguisher to aid in the user's cognitive understanding.

Here is a complete mapping of word encodings as listed in accompanying FIG. 32

| Encoding | Word |
| 3201 | Flower |
| 3202 | Flour |
| 3203 | Brown |
| 3204 | Crown |
| 3205 | Lewd |
| 3206 | Lieu |
| 3207 | Room |
| 3208 | Troll |
| 3209 | Stroll |
| 3210 | Rot |
| 3211 | Shot |
| 3212 | Bright |
| 3213 | Right |
| 3214 | Light |
| 3215 | Sight |
| 3216 | Moaning |
| 3217 | Morning |
| 3218 | Mourning |
| 3219 | W/Vroom |
| 3220 | Sage |
| 3221 | Page |
| 3222 | barely |
| 3223 | bearly |
| 3224 | shed |
| 3225 | red |
| 3226 | hair |
| 3227 | air |
| 3228 | weak |
| 3229 | week |
| 3230 | busy |
| 3231 | easy |
| 3232 | whisky |
| 3233 | risky |

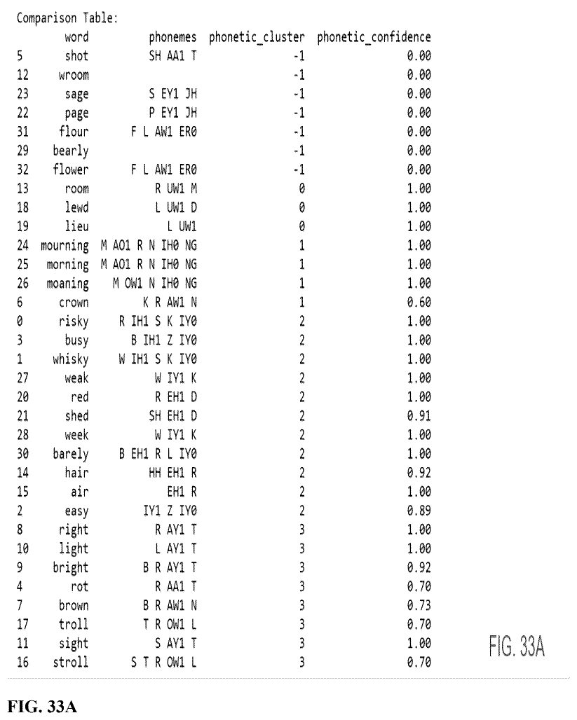

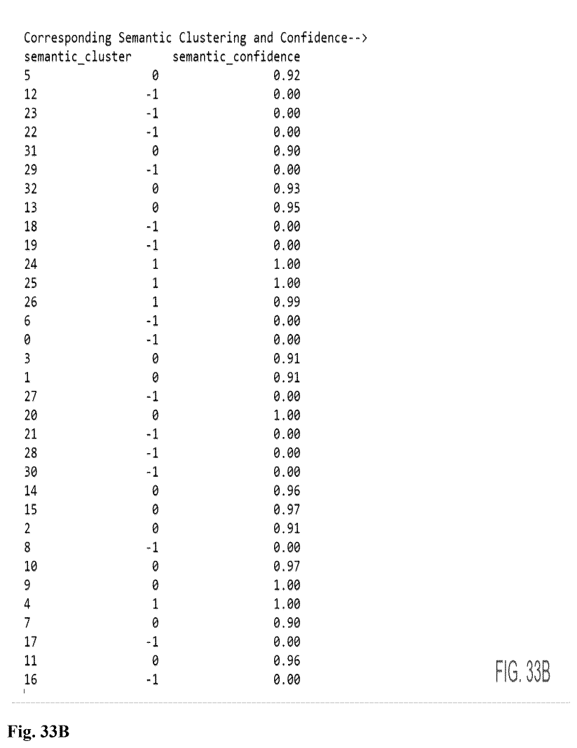

In another example embodiment, as illustrated in FIG. 33(A-B), the Data Analytics and Visualization Engine is disclosed for clustering and analyzing spoken words based on their phonetic (as depicted in FIG. 33A) and semantic (as depicted in FIG. 33B) similarity. This engine processes voice data to detect recurring sound structures that may reflect patterns of mimicry, theme-based stalking, or linguistic manipulation. As depicted in FIG. 33A, Each word is tagged with its phonemes, assigned to a phonetic cluster, and given a confidence score. For instance, “red,”—(3225) and “shed,”—(3224) belong to phonetics cluster 2, while they are separated into cluster −1 and 0 respectively, when clustered semantically. “Mourning,”—(3218), “morning”—(3217), and “moaning”—(3216) appear in cluster 1, revealing overlap in grief- and emotion-related terms and with time indication. Engine can however compare the separating distance between these phrases phonetically and semantically. For instance, mean separation distance phonetically is about 0.5 versus 1-1.5 when considered semantically. Words like “risky”—(3233), “whisky”—(3232) “easy,”—(3231) “shed,”—(3224) and “red”—(3225) are grouped under cluster 2, linked by shared vowel-consonant phonetic structures. Again, “risky”—(3233) and “whisky”—(3232) are separated 0.5 units apart phonetically while their corresponding semantic separation is 5 times as much. Words with no reliable clustering (e.g., “shot”—(3211), “wroom”—(3219), “page”—(3221)) are marked with −1 and low confidence, suggesting outliers or unpatterned entries. The engine visualizes these clusters, highlighting phonetic mimicry, semantic coordination, and speech manipulation tactics. This facilitates advanced detection of orchestrated voice behaviors or repeated phrases used in sonic stalking or psychological targeting.

In yet another embodiment, a profiling engine is operatively connected to the data analytics and visualization engine and is configured to generate, update, and maintain comprehensive behavioral profiles for individuals involved in detected interactions. The profiling engine comprises a profile management module that is configured to generate behavior profiles for identified aggressors and targets by capturing and storing recorded speech history, behavioral markers, and interaction metadata over time, and modus operandi detection module that is configured to identify repeated aggression tactics exhibited by an individual including phrase repetition, pitch alternation, jockeying for vocal dominance, echoing, and mocking. The modus operandi detection module further comprises a sound jockeying detector, a pitch/frequency and phonetic modulation analyzer, a volume modulation detector, a tone modulation analyzer, a repetition detector, a mockery detector, a mind control behavior analyzer, an alternation detector, a social behavior mapper, a modus operandi synthesizer, an attack rendering detection unit, and an attack type detection unit. The sound jockeying detector is configured to identify overlapping, interruptive, or dominance-seeking vocal behavior by analyzing timing overlaps, escalation in voice volume, and speaker transition patterns. a pitch/frequency and phonetic modulation analyzer configured to detect aggressive or erratic shifts in pitch, frequency, and phonetic articulation, including alternations in pronunciation, enunciation, or speech clarity indicative of sarcasm, mocking, disguise, or emotional destabilization. The volume modulation detector is configured to measure volume variations and abrupt fluctuations, detect volume surges used to overpower the target, and analyze speaker-target volume interactions to infer vocal dominance attempts. The tone modulation analyzer is configured to assess the emotional tone of speech through sentiment analysis, tone gradient shifts, and detection of emotionally incongruent expressions including sarcasm or mockery. The repetition detector is configured to detect repeated phrases, commands/instructions, insults, or name-calling patterns, utilizing lexical frequency models and historical utterance matching to identify harassment intent or cognitive conditioning strategies. The mockery detector analyzes patterns of belittlement or sarcasm by evaluating vocal tone, pitch shifts, sentiment polarity reversals, and emotionally mismatched responses. The mind control behavior analyzer detects the use of subconscious control language, including repeated directive statements, imperative phrasing, commanding and reinforcement strategies aimed at influencing or dominating the target's behavior. The alternation detector identifies high-frequency shifts in pitch and tone associated with destabilizing or emotionally manipulative communication patterns, including forced empathy reversal. The social behavior mapper detects group-based harassment dynamics by identifying leader-follower aggression patterns, mutual reinforcement among harassers, and lone-actor behavioral profiles. The modus operandi synthesizer aggregates detected behavioral features across multiple interactions to generate a predictive signature of each aggressor's verbal attack strategies and forecasts future behavior patterns or escalation risk using distributional behavior modeling. The attack rendering detection unit, is configured to identify the structure, sequencing, and delivery mechanisms of verbal attacks by analyzing linguistic, tonal, and behavioral signals, and the attack type detection unit, configured to classify the specific nature of each verbal attack using integrated linguistic, acoustic, and behavioral feature sets.

In one example embodiment, a system for analyzing the evolution, devolution, and shifts in tactics of harmful verbal attacks over time is disclosed, as illustrated in the Table 1 illustrates the corresponding evolution or devolution and shifts in tactics practiced by a voice over time. It involves aggregating phrases into categories and tracking shifts from one type of behavior to another, including Utterance, Rendering (tone, pitch, volume, phonetic modulation), Life Theme (work/business, relationships, etc.), Modus Operandi (repetitions, alternation, jockeying, etc.), or Social Behavioural Patterns (lone actor, cohort formation, leader/follower). The analysis considers expansion or contraction in participation possibilities and visualizes these changes through fuzzy clusters and silhouette plots. The system categorizes and analyzes attacks, contributing to the component of contextual awareness. By tracking these shifts and evolutions across different categories and behavioral patterns, the system aims to understand how a voice's tactics change over time, providing insights into potential escalation or de-escalation of harmful behaviors.

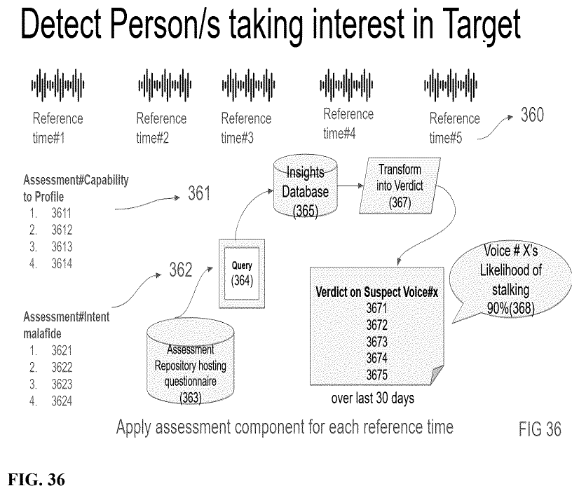

In another example embodiment, as illustrated in FIG. 36, the modus operandi detector for identifying stalking behavior through repeated verbal patterns is disclosed. The system detects individuals exhibiting potential stalking behavior towards a target by analyzing their vocal interactions across multiple temporal snapshots. Initially, audio data is captured at various “Reference times,” (360) each undergoing a detailed assessment. This assessment encompasses two key dimensions: “Capability to Profile,” (361) which identifies mentions of the target's name (3611—“Target Name mentioned”), associated entities (3612—Entities/Objects associated with target mentioned?), locations (residence, workplace (3613—Location/whereabouts related details mentioned?—residence, workplace location), transit times (3614—“Times of transit mentioned?”), and indications of the suspect's voice being present near the target's whereabouts. (3615—“Does the voice seem to accompany target along whereabouts?”) The second assessment, “Intent malafide,” (362) scrutinizes the audio for terms associating the suspect with the target (including nicknames or code names, 3621—“Terms used to associate or identity target with such as real name/nick name/code name”), profanities (3622—“Profanities if any”), controlling instructions (3623—“Controlling Instructions if any”), and repetitive use of specific terms (3624—“Repetitions of certain terms over other terms”). The data gleaned from these assessments at each reference time is then aggregated (363) and stored within an “Insights Database.” (365) Subsequently, a “Query” (364) is executed on this database, likely searching for patterns and frequencies of the identified elements associated with a specific “Suspect Voice #X” over a defined period, exemplified here as the “over last 30 days.” The “Verdict on Suspect Voice #X” (366) compiles the results of this query, quantifying the occurrences of target name mentions (120)—(3671), associated entity mentions (60)—(3672), whereabouts mentions (10)—(3673), transit time mentions (15)—(3674), and instances of the suspect being heard near the target's locations (10 occasions)—(3675). Finally, these quantitative findings are processed through a stage labeled “Transform into Verdict,” (367) culminating in a probabilistic assessment of stalking likelihood. In this specific instance, the system concludes with a high probability: “Voice #X's Likelihood of stalking 90%” (388). This indicates that the repeated mentions, proximity indicators, and potentially the linguistic cues related to intent, when analyzed collectively, strongly suggest stalking behavior by the individual identified as Voice #X.

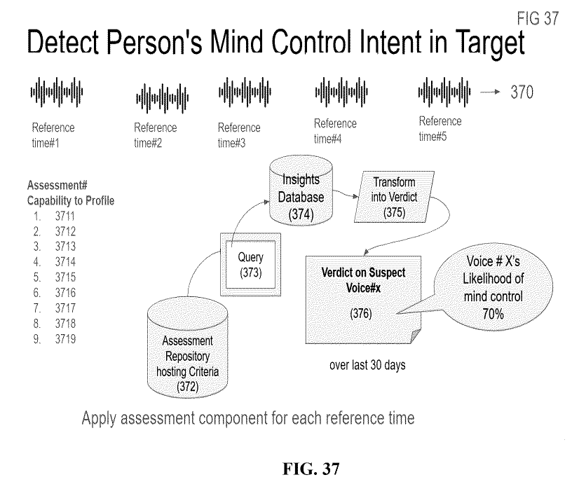

In another example embodiment, as illustrated in FIG. 37, the modus operandi detector for identifying mind control intent through repeated verbal patterns is disclosed. The system detects potential mind control behavior by analyzing a suspect's voice interactions across multiple temporal reference points. Audio data is captured at different “Reference times” (#1 to #5), each undergoing evaluation through an “assessment component” (371). This assessment consists of two primary dimensions: the “Capability to Profile” which determines whether the voice is audibly present as the target enters or exits specific zones or premises (3711—“Is the voice heard as target enters a zone/premise?”), whether it consistently mentions (3712—“During this time, is the voice almost always mentioning Target or what target is doing?”, (3713—“Target Name mentioned?”). the target or their actions, whether the target's name is repeated (3714), and whether the voice appears to accompany the target across changing locations (3715), and whether the voice appears to issue any mind control instructions or suggestions (do this, or do not do that?)—(3716), and whether the voice is trying to reinforce through repetition (3717). Further, whether there are any alterations of tonal/sentimental alternations with repetitions?—hope/despair, threats/pacifying, love/hate, praise/slander and so on. (3718).

; and the “Assessment Repository Hosting Criteria” (372), which further evaluates the presence of directive language (e.g., instructions to act or refrain—3716), use of reinforcement through repetition, patterns of emotional alternation—(3718) (e.g., hope/despair, love/hate), and threats issued when the target does not comply. The outputs of these assessments are stored in an Insights Database (374), which accumulates evidence over time. A Query (373) is then run against this database, targeting patterns associated with a specific suspect voice (e.g., Voice #X) over a defined analysis window including “the last 30 days.” The Verdict on Suspect Voice #X (376) aggregates findings including the frequency of name mentions (120), associated object or entity references (60), voice presence upon target's entry or exit (60%), issued instructions (7/10), general threats (9/10), and threats upon non-compliance to issued instructions (5/10). These data points are passed to a decision stage labeled Transform into Verdict (375), producing a probabilistic assessment of intent. In this instance, the system assigns a “Voice #X's Likelihood of Mind Control: 70%” (377), indicating a high probability that the voice exhibits manipulative or coercive behavior toward the target. This embodiment demonstrates how the system uses temporal audio snapshots, behavioral cues, and linguistic features to evaluate and quantify potential mind control dynamics in verbal attacks.

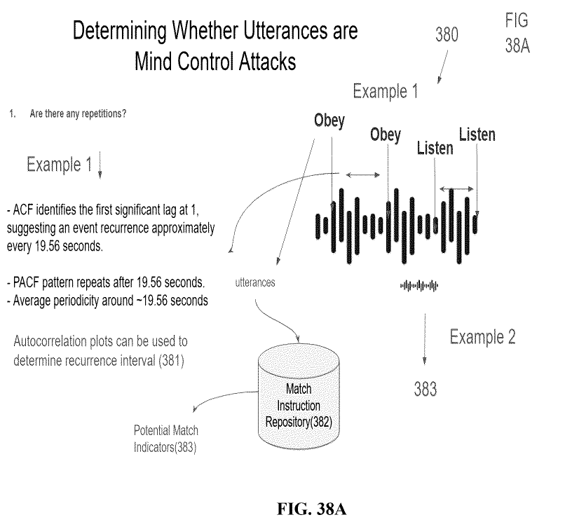

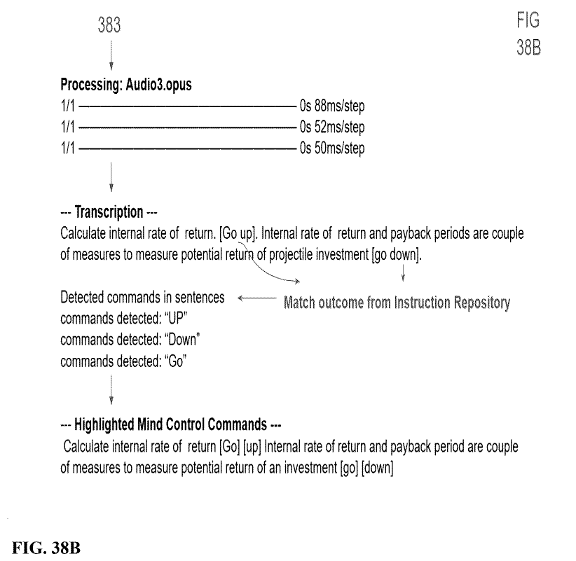

In another example embodiment, as illustrated in FIG. 38, a system for detecting verbal repetition as a marker of mind control behavior is disclosed. This embodiment integrates the Data Analytics and Visualization Engine, the Repetitions Detector, and the Modus Operandi Detector (specifically its Mind Control and Repetition Detection subcomponents). The image as depicted in FIG. 38A, depicts the analysis of audio input (380) over time using autocorrelation techniques (381) to identify repeated segments within a speaker's utterances. These segments are then compared against a predefined Match Instruction Repository (382) to determine alignment with known manipulative or directive phrases. The Repetitions Detector flags recurring patterns including repeated commands or name-calling, and the Mind Control Detection unit interprets these patterns as potential indicators (383) of coercive or manipulative intent. This layered approach enables the system to detect mind control tactics rooted in linguistic repetition. Example 2, as depicted in FIG. 38B, analyzes audio for mind control. It uses autocorrelation to find repeating patterns and transcribes the audio to detect command words like “Up,” “Down,” and “Go.” The presence of both repetition and these specific directives within the speech are considered potential indicators of a mind control attempt. The engine's analytical and visualization capabilities further support real-time interpretation of these patterns, contributing to both immediate intervention and long-term behavioral profiling.

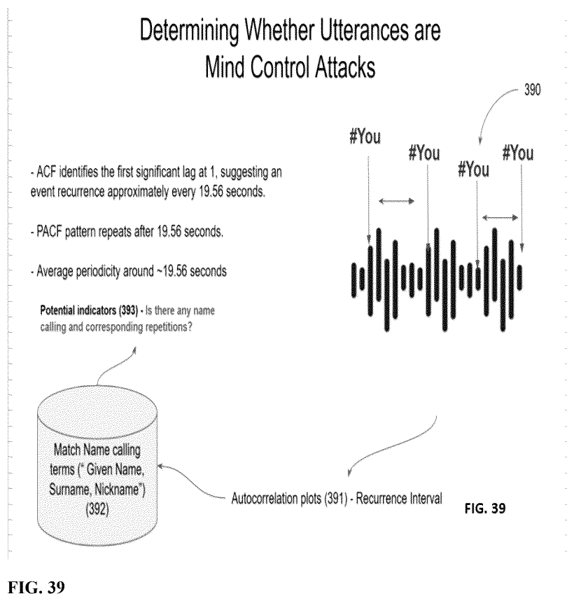

In another example embodiment, as illustrated in FIG. 39, a system for detecting mind control behavior through repeated name-calling is disclosed. This figure exemplifies the coordinated operation of several components, including the data analytics and visualization engine, the phrase detector, the repetitions detector, the mockery detector, and the mind control analyzer within the modus operandi detector. The image focuses on the analysis of audio input (390), particularly highlighting the recurrence of the pronoun “You,” which is often used as an attention grabbing psychological trigger in manipulative speech. Using autocorrelation analysis (391), the Data Analytics and Visualization Engine identifies repeating linguistic structures and flags suspicious patterns. The Phrase Detector identifies critical trigger terms including “You,” and the Repetitions Detector confirms their repeated usage across time. Simultaneously, the Mockery Detector evaluates the context and tone for signs of belittlement or dehumanization. Together, these insights (392) feed into the Mind Control detector/analyzer, which interprets (393) such repeated phrases as a strategic attempt to dominate or mentally condition a target.

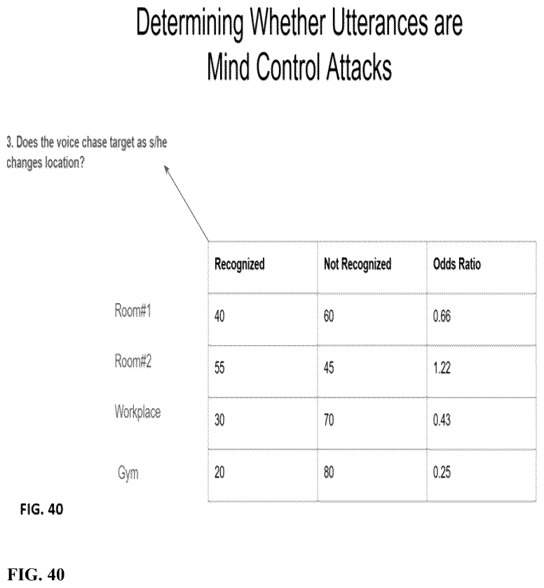

In another example embodiment, as illustrated in FIG. 40, the system continues its assessment of whether certain utterances constitute mind control attacks, focusing specifically on the behavioral tactic of the suspect voice appearing to “chase” the target across different locations. This scenario directly aligns with the capabilities of the Modus Operandi Detector, particularly the Mind Control Behavior Analyzer component. The image presents a table evaluating whether the suspect voice's mind control attack is “Recognized” or “Not Recognized” in a series of locations frequently visited by the target—Room #1, Room #2, Workplace, and Gym—along with corresponding Odds Ratios. These Odds Ratios quantitatively assess the strength of association between the suspect voice's presence and the target's location. For instance, in Room #2, where the Odds Ratio is 1.22, the suspect voice is more likely to be engaged in attack when the target is present, suggesting a non-random pattern of co-location. Conversely, lower ratios in other locations indicate weaker associations. This co-occurrence analysis illustrates the system's ability to detect patterns of spatial tracking or “chasing” behavior by correlating the suspect voice's appearance with the target's movement history. Such behavior is interpreted by the Mind Control Behavior Analyzer as a potential manipulation strategy intended to monitor, influence, or create psychological pressure through repeated, seemingly coincidental presence.

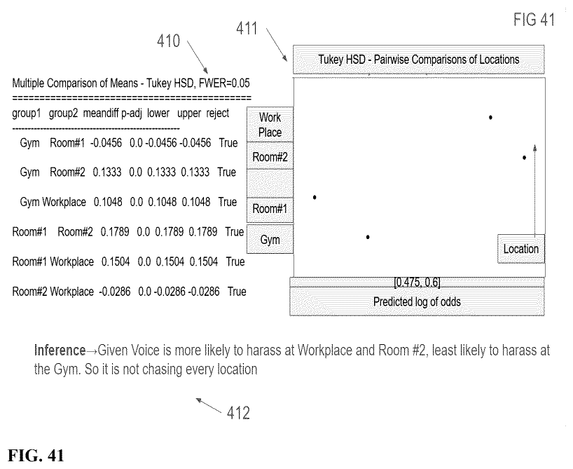

In the same embodiment, as illustrated in FIG. 41, the system employs a statistical framework—executed via the Data Analytics and Visualization Engine—to investigate whether a “Given Voice” exhibits a pattern of chasing the target across different physical locations, a potential tactic indicative of stalking or mind control, and thus analyzed by the Modus Operandi Detector. A Multiple Comparison of Means table (410, using the Tukey HSD test) evaluates pairwise differences in the predicted log-odds of harassment across locations including the Gym, Room #1, Room #2, and the Workplace. This test identifies which pairs of locations show statistically significant differences in harassment likelihood, adjusting for multiple comparisons with a Family-Wise Error Rate (FWER) of 0.03. A scatter plot (411) visually maps the predicted log-odds of harassment at each location, offering a comparative overview. The results (412) show that the “Given Voice” is significantly more likely to harass at the Workplace and Room #2, and being least likely to do so at the Gym (as is revealed by the meandiff column values in the Multiple Comparison of Means table, 410), thereby revealing a non-uniform distribution of harassment across spaces. This indicates that the suspect is not consistently “chasing” the target at every location, undermining the hypothesis of a generalized stalking pattern. The analysis exemplifies how the Data Analytics and Visualization Engine contributes to behavioral profiling by quantifying and visualizing the spatial aspects of harassment, and the Modus Operandi Detector interprets these findings in the context of recurring behavioral strategies.

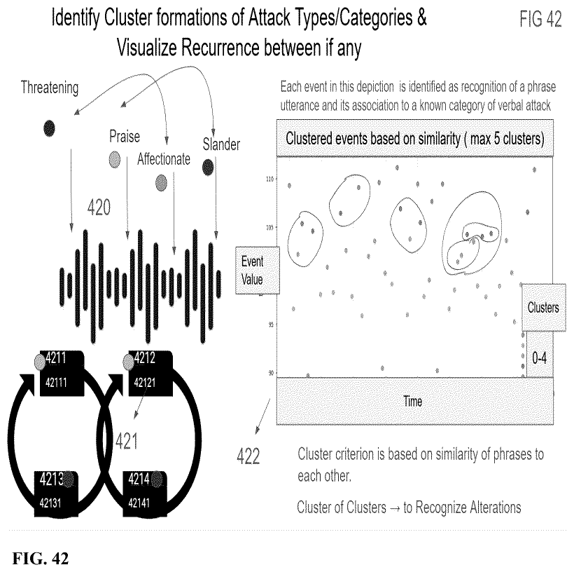

In another embodiment, as illustrated in FIG. 42, the system leverages the Data Analytics and Visualization Engine to detect and visualize clustered patterns and alternations among various verbal attack types over time—an approach that integrates outputs from the Attack Type Detector, the Alternation Detector, and potentially the Mockery Detector. A conceptual visualization maps (420) colored dots (e.g., red for threats, green for praise, blue for affection, and orange for slander) to represent classified utterances, with directional arrows indicating transitions between them over time. A specific recurrence pattern (421)—including praise (4211) and 42111—“awesome, he is the best”, curses/trash words—42121—“#@$,!@ #$”, 4213—“slander such as 42131—“Worst, Horrible, Minnow, Horrendous, Bad, Ugly, . . . “, 4214—“Affection”, 42141—“Like him, love him, Cute”, leading to threats (4212), and cycling back again-suggesting behavioral loops that may indicate manipulative or destabilizing communication strategies. A scatter plot (422) generated by the engine displays temporal clustering of utterances (Cluster 0 to Cluster 4), where each dot represents a categorized group of phrases aka a cluster representing a particular attack theme or category. Black circled regions denote clusters of similarity, allowing the system to identify not only individual attack types but also the dynamics of how they alternate. This clustering is based on linguistic similarity, enabling the Alternation Detector to track sudden or recurrent shifts in tone or category (e.g., from affection to slander and back), a phenomenon that can also inform the Mockery Detector when such shifts imply sarcasm, contradiction, or belittlement. So, first phrases are clustered around attack themes and then alternation among the themes is further assigned to a greater representative cluster formation. Overall, FIG. 42 exemplifies how the system performs sophisticated temporal and semantic analysis of verbal behavior, providing insight into a speaker's evolving modus operandi and enabling the detection of complex verbal manipulation patterns.

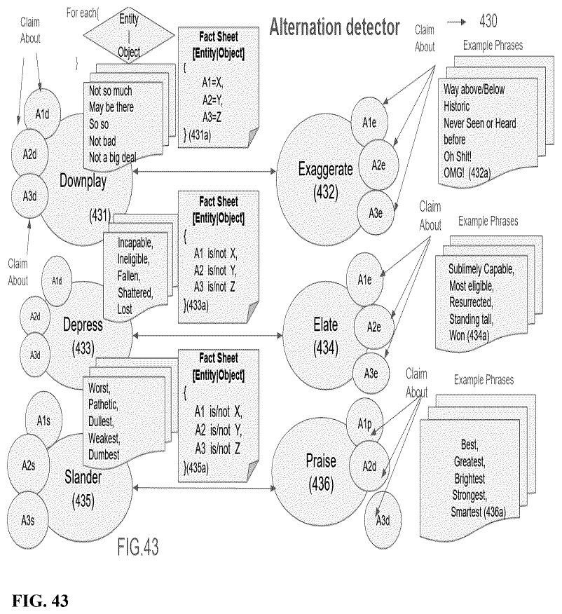

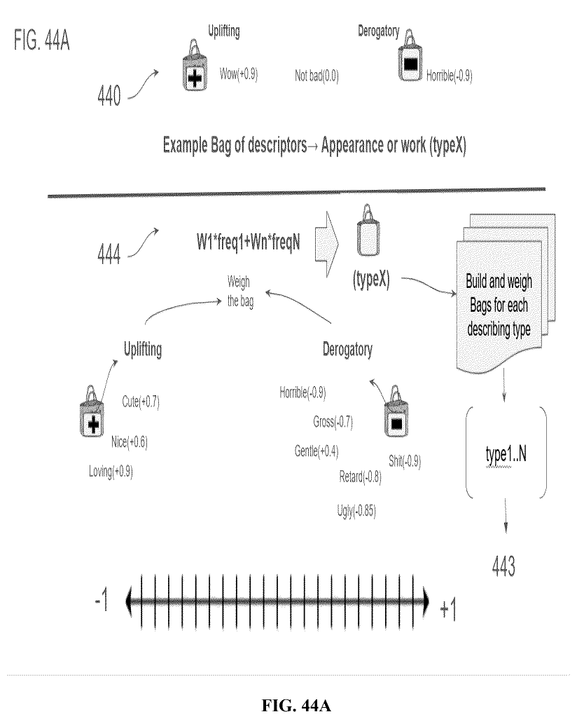

In another embodiment, as illustrated in FIG. 43, the logic of the Alternation Detector is detailed, showing how the system evaluates shifts in sentiment or characterization surrounding a claim about an entity or object—an essential process that also informs the Mockery Detector. At the center of the diagram is a general structure: a “Claim About” (430) a subject is followed by various possible types of responses that may indicate alternation. These include Downplay (e.g., “Not bad,” “So so”) (431), Exaggerate (e.g., “Historic,” “OMG!”) (432), Depress (e.g., “Failed,” “Shattered”) (433), Elate (e.g., “Resurrected,” “Standing tall”) (434), Slander (e.g., “Pathetic,” “Dullest”) (435), and Praise (e.g., “Smartest,” “Greatest”) (436). These alternations are interpreted against a contextual baseline or Fact Sheet for the entity or object in question (A1, A2, A3), which presumably reflects the neutral or objective attributes of the entity. By comparing a response's tone or intensity against the original claim and the Fact Sheet, the system can identify not only stylistic shifts but also potential distortions. Several of these alternation types—particularly Exaggerate, Depress, and Slander—are instrumental for the Mockery Detector, as they often reflect insincerity, sarcasm, or deliberate belittlement, especially when there's a pronounced contrast between the response and the actual facts. The alternation detector thus functions as a semantic pattern recognizer, monitoring repeated or abrupt tonal shifts that might signal manipulation in the form of aggrandizement or exaggeration or belittling, coercion, or mockery.

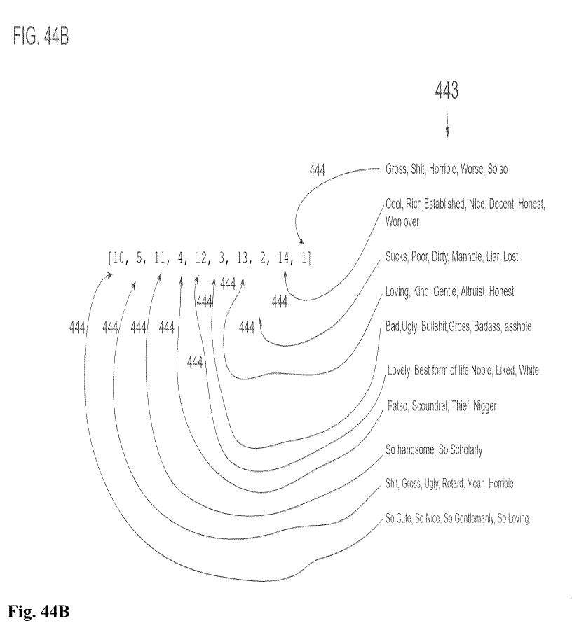

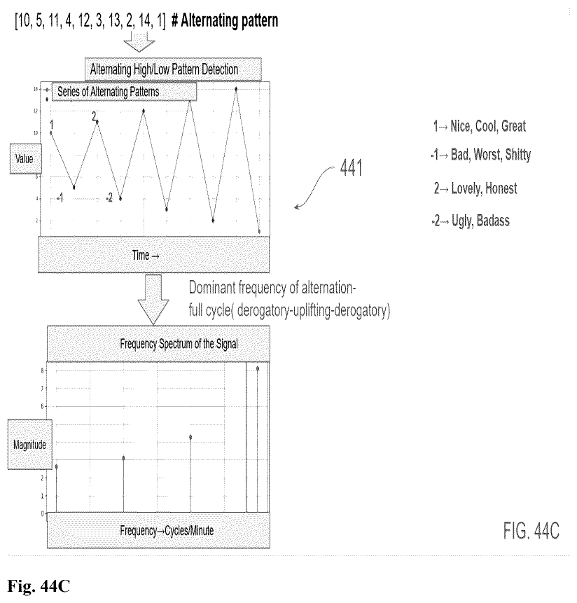

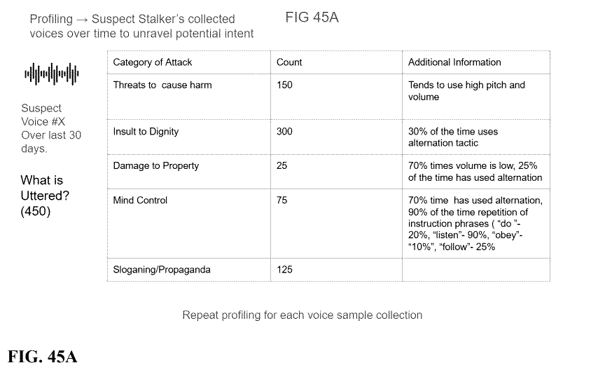

In another example embodiment, as illustrated in FIG. 44(A-C), a system for detecting alternating patterns of uplifting and derogatory language is disclosed. An input data series (FIG. 44B—443)—including [10, 5, 11, 4, 12, 3, 13, 2, 14, 1]—which represents measured sentiment (440) or linguistic attributes across time. The alternation detector processes this sequence to detect fluctuations between positive and negative states, visualized as a high-low oscillating line graph (441). These variations are further analyzed by the system to determine the dominant frequency of alternation, using a signal frequency spectrum (442) that highlights cyclical behavioral patterns, including a recurring praise-insult cycle. Parallel to this, a structured bag of descriptors is assembled, separating terms into Uplifting (e.g., “Beautiful,” “Honest,” “Scholarly” and the like) and Derogatory (e.g., “Ugly,” “Liar,” “Gross”, and the like) (443) categories, each weighted and scored accordingly. Arrows labeled “Weigh the bag” (444) indicate an aggregation of these terms over time. These linguistic features are cross-referenced by the mockery detector and mind control behavior analyzer to assess the presence of alternating manipulative tactics-including rapid shifts between affection and degradation or between reassurance and control. The resulting output is used to build tags for each recurring type, supporting future classification, profiling, or alerting. This embodiment illustrates how the system integrates frequency-based analysis with semantic categorization to detect patterned verbal alternation, aiding in the identification of subtle but deceptively methodical and harmful communicative behaviors. The weight vector as depicted in (440) is used to discover alternating or recurrent patterns of aggrandizing or belittling, by conversion to frequency domain where the increasing/decreasing resultant magnitudes reflect the tactic of alternation.

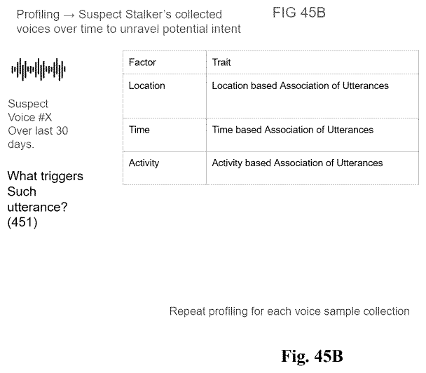

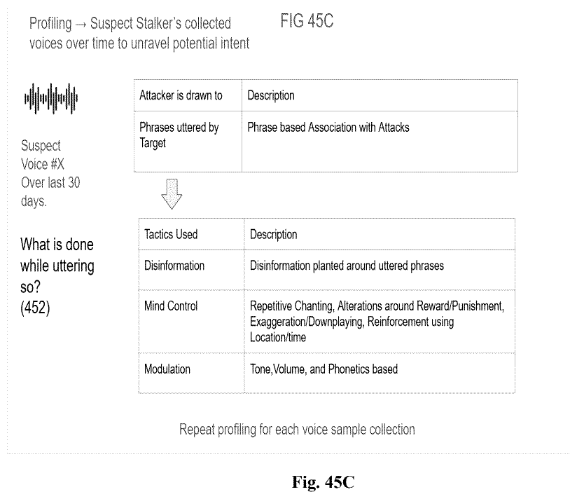

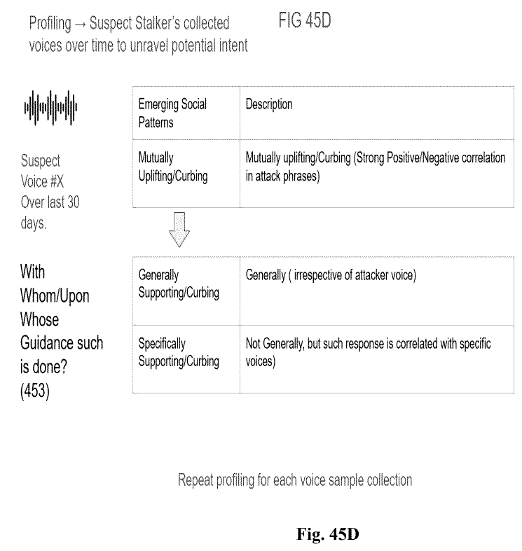

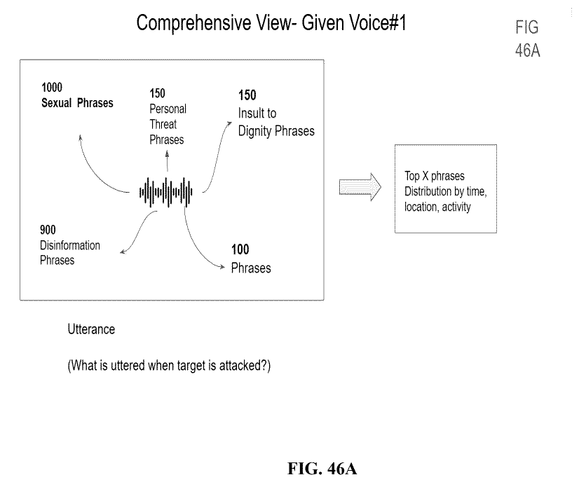

In another example embodiment, as illustrated in FIG. 45(A-D), a system for profiling a suspect stalker's verbal behavior over time to assess potential intent is disclosed. The FIG. 45A refers to a profiling engine-including the profile management module and the modus operandi detection module-processes voice data from “Suspect Voice #X” over a 30-day period, identifying what is uttered (FIG. 45A—450) including personal threat phrases, insults to dignity, damage to property phrases, mind control instructions, and propaganda/slogan phrases. The FIG. 45B refers to Data Analytics and Visualization Engine that maps these utterances against triggers (FIG. 45B—451)—including location, time, target activity, and specific phrases by the target.—and FIG. 45C depicts how this engine detects concurrent behaviors (FIG. 45C—452) like mind control chanting, alternation, reinforcement, and emotional modulation (exaggeration/downplaying). The FIG. 45D depicts a Social Behavior Mapper (FIG. 45D—453) which identifies other influencing or echoing voices (e.g., Voice #U), noting 90% phrase similarity, 60% co-occurrence, and behavioral dynamics like mutual control or general support/curbing. This profiling is repeated iteratively for each collected sample to construct behavior maps and infer the suspect's communicative and psychological intent.

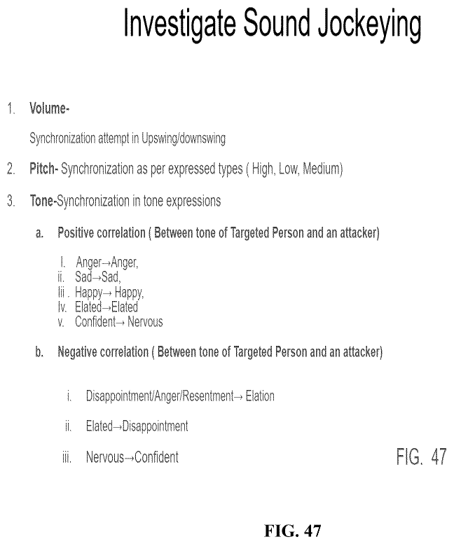

In an example embodiment, the Sound Jockeying Detector within the Modus Operandi Detection Module configured to identify manipulation patterns in vocal delivery—including volume, pitch, and tone—during verbal attacks is disclosed, as illustrated in FIG. 47. The analysis specifically focuses on detecting synchronization patterns and emotional correlations indicative of sound jockeying behaviors used to assert control, induce intimidation, or mock the target. As shown in FIG. 47, the detector evaluates multiple features: volume synchronization during upswing/downswing transitions to identify alignment with interactional cues; pitch synchronization based on expressed speech types including questions, commands, or exclamations; and tone synchronization in relation to emotional expressions embedded within the utterance. The detector further analyzes emotional correlation trends between targeted person's voice and attacker's voice, distinguishing between positive correlations (e.g., Anger→Anger, Sad→Sad) and negative correlations (e.g., Elation→Disappointment, Nervous→Confident). By interpreting these synchronized acoustic shifts and emotional mismatches, the Sound Jockeying Detector enables fine-grained recognition of manipulative vocal strategies, supporting both real-time detection and psychological impact profiling.

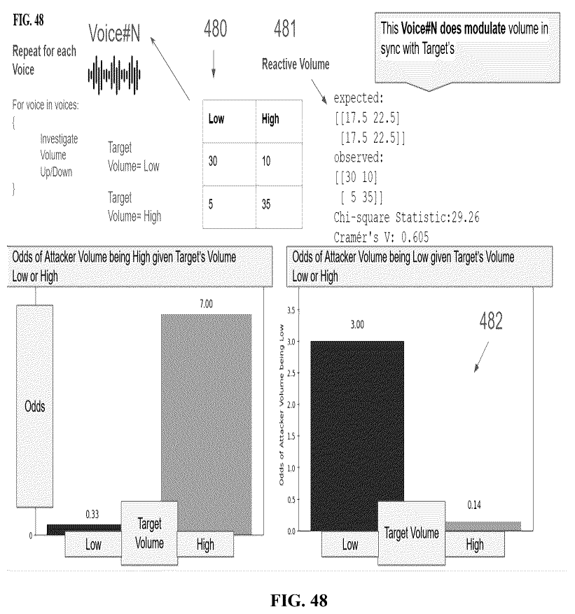

In an example embodiment, the Volume Modulation Detector within the Modus Operandi Detection Module configured to analyze volume synchronization patterns between an aggressor (e.g., Voice #N) and a target speaker is disclosed, as illustrated in FIG. 48. The detector evaluates whether Voice #N modulates volume levels in response to the target's volume, potentially indicating manipulative or mimicry-based interaction tactics. The audio signal analysis is repeated for each voice and investigates up/down shifts in Voice #N's volume corresponds to conditions where the target's volume is either Low or High. A contingency table (480) illustrates frequency distributions, where Voice #N exhibits High Volume 35 times when the target is loud, and only 10 times when the target is soft. Statistical testing (481) yields a Chi-square value of 29.26 and Cramer's V of 0.609, confirming a significant association. Accompanying bar charts (482) further demonstrate odds ratios: the odds of Voice #N having high volume rises from 0.33 when the target is quiet to 7.00 when the target is loudly speaking. These patterns suggest synchronized volume modulation. When interpreted as part of an intentional strategy, such synchronization is flagged by the Jockeying Detector as a potential control or mimicry-based verbal tactic, contributing to the behavioral profiling and real-time detection capabilities of the system.

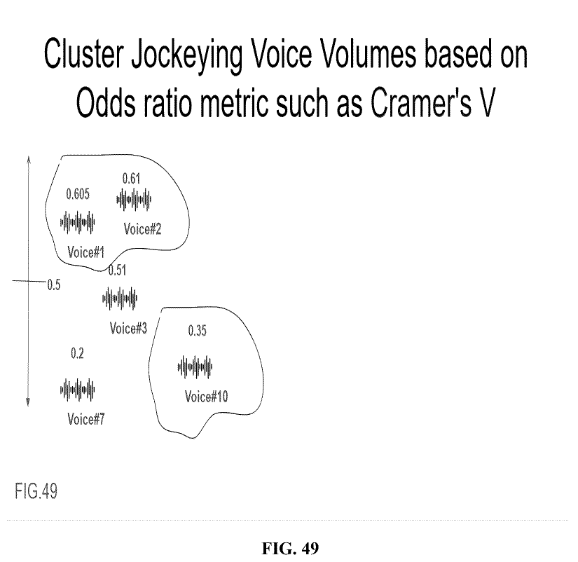

In another example embodiment, the Jockeying Detector within the Modus Operandi Detection Module configured to identify and cluster individuals based on their sound jockeying behavior is disclosed, as illustrated in FIG. 49. The detector uses statistical association metrics, including Cramer's V (490), to measure the associative strength of volume modulation exhibited by different voices in relation to contextual factors, including the target's vocal intensity. The Data Analytics and Visualization Engine processes these metrics and clusters voices with similar jockeying characteristics. Voices including Voice #1 (0.605) and Voice #2 (0.61) are grouped into a high-association cluster, indicating strong synchronization in volume modulation, and Voice #3 (0.51) and Voice #10 (0.35) form a moderate cluster. Voice #7 (0.2) remains isolated, reflecting a weaker association.

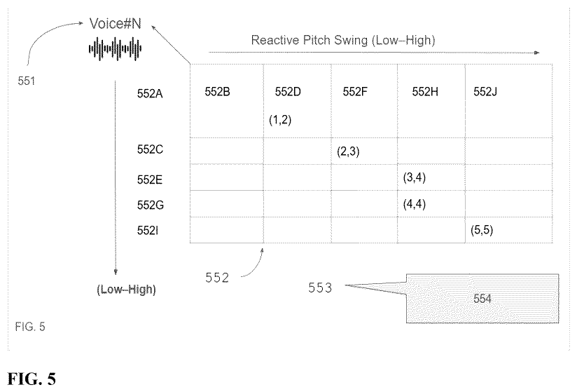

In an example embodiment, the pitch detector to assess whether any positive or negative correlation exists between reactive pitch swing behaviors of an aggressor and a target, is disclosed, as illustrated in FIG. 5. The system analyzes (551—“Repeat for each Voice”) reactive pitch swings across standardized segments, characterized by mean and standard deviation respectively of distribution representing each (#mean1, #sd1), to (mean #1, #sd5) for both Voice #N (#mean1, #sd1—551B, #mean2, #sd2—551D, #mean3, #sd3—551F, #mean4, #sd4—551H 3,mean #5, #sd5—551J) and the target (#mean1, #sd1)—551A, (#mean2, #sd2)—551C, (#mean3, #sd3)—551E, (#mean4, #sd4)—551G,mean #5, #sd5—551I) are visualized in a matrix where each cell indicates the observed rank of corresponding pitch levels and the diagonal entries reflect instances of pitch alignment, as provided in the table (552). A higher spearman's rank correlation score (553) of 0.975 confirms a strong positive monotonic relationship-indicating that as the target's pitch increases or decreases, Voice #N's pitch adjusts in sync. This synchronization is interpreted as intentional modulation (554), noted in the text as “Voice #N does modulate pitch in sync with Target's.”.

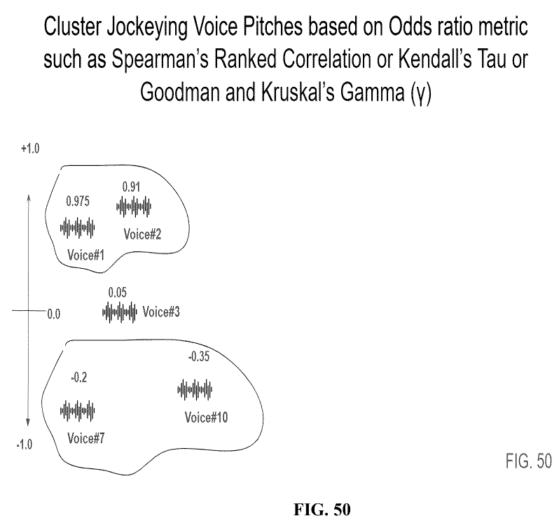

In an example embodiment, the Jockeying Detector within the Modus Operandi Detection Module, configured to identify and cluster pitch jockeying behaviors based on correlation metrics (500), is disclosed, as illustrated in FIG. 50. The system analyzes the strength and direction of the monotonic relationship between the pitch modulation of various voices and that of a reference speaker (e.g., the target), using statistical measures including Spearman's Rank Correlation, Kendall's Tau, or Goodman and Kruskal's Gamma (γ). As shown in the figure, voices are positioned along a Y-axis representing correlation values from −1.0 to +1.0 and are clustered based on similarity. For example, Voice #1 (0.975) and Voice #2 (0.91) form a top cluster exhibiting strong positive synchronization, and Voice #7 (−0.2) and Voice #10 (−—0.35) form a cluster with weak negative correlations, suggesting inverse modulation patterns. The Data Analytics and Visualization Engine visualizes these clusters, aiding in the detection of potential manipulative vocal strategies including mimicking or oppositional pitch modulation, which may signify jockeying behavior during verbal attacks. Ranked correlation method aids in detecting ordinal modulation patterns including low, medium, high in terms of volume amplitude, or pitch frequency, or emotional intensity in tone.

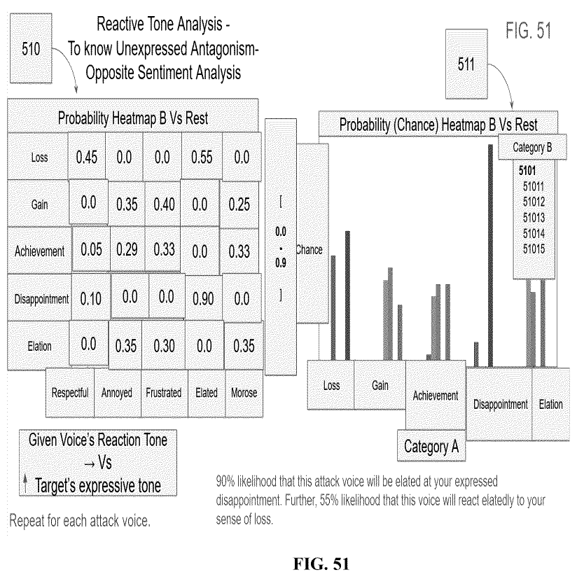

In an example embodiment, the Tone Detector within the Modus Operandi Detection Module, configured to analyze reactive tone patterns and identify instances of unexpressed antagonism through opposite sentiment analysis, is disclosed, as illustrated in FIG. 51. The analysis visualized by the Data Analytics and Visualization Engine includes a probability heatmap (510) and bar chart (511), showing how a “Given Voice's” reaction tone (e.g., Elated, Morose) relates to the “Target's” expressive tone (e.g., Disappointment, Loss). For instance, the heatmap (510) reveals a 90% probability that the Given Voice reacts with elation to the Target's disappointment, suggesting potential mockery or emotional antagonism. A 55% probability of reacting morosely to the Target's loss indicates a possible lack of empathy or calculated emotional mirroring. These patterns, extracted and visualized per attack voice, enhance the system's ability to detect manipulative behavior masked as neutral or positive, aiding both the Profiling Engine in behavior characterization and the Predictive Simulator in anticipating harmful response dynamics.

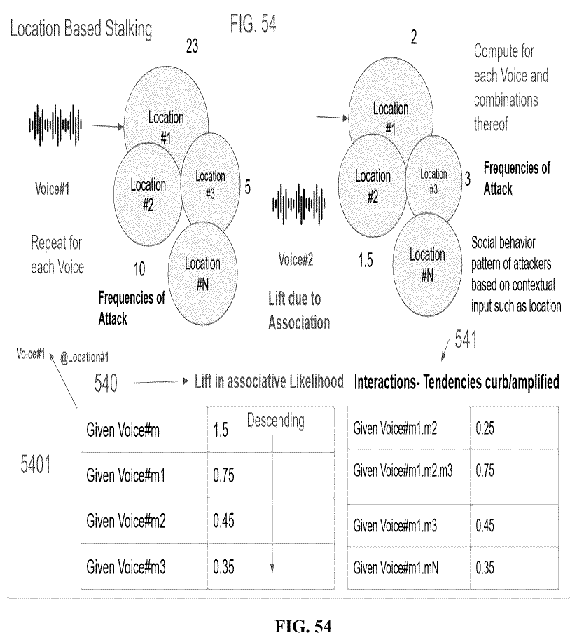

In another example embodiment, as illustrated in FIG. 54, a system for detecting location-based stalking patterns using the Modus Operandi Detector is disclosed. The interface maps each voice to multiple locations, showing how the frequency of attacks varies across these locations. For instance, Voice #1 is shown to frequently attack at Location #1 with a frequency of 23, and at Location #2 with a frequency of 5, among others. The system computes associative lift values between voices and locations, with a table (540) illustrating lift in likelihood for various voices and their respective locations. For example, Voice #m shows a lift value of 1.5, suggesting a given Voice #1 is 50% more likely to attack at a given location given presence of Voice #m but 25% less likely to attack in presence of Voice #m1. Such associative lifts in likelihoods are computed and arranged in lifts descending pattern. This illustrates the social encouraging or curbing effect on attackers, given the presence of other individuals who happen to hold influence on them. A table (541) showing its attack frequency at multiple locations and its associated behavior. The system uses a code snippet to calculate combinations of voices and locations, populating the lift values based on interaction tendencies, which are either amplified or curbed by contextual input including location. Additionally, representations are presented to show attack patterns in visual form, offering insights into the coordination of attackers' actions across different locations. This embodiment enhances the modus operandi detector by integrating geographic and social behavior patterns to better understand and identify location-based stalking.

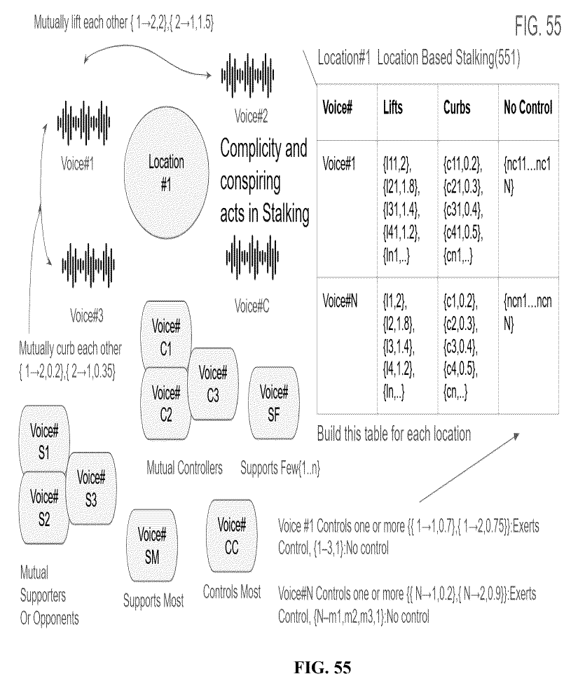

In yet another example embodiment, as illustrated in FIG. 55, the Modus Operandi Detector for analyzing location-based stalking and the relationships between voices in various locations is disclosed. The system captures how different voices interact and influence each other at specific locations, with each voice potentially lifting or curbing others in terms of support or control. For example, at Location #1 (550), Voice #1 may lift Voice #2 and vice versa, and Voice #1 may curb Voice #3. Additionally, the table (551) shows how each voice either lifts, curbs, or has no control over others, providing a quantified assessment of the dynamics between voices at each location. The table is built for each location, helping identify patterns of mutual support, opposition, and control. The system analyzes these relationships by tracking interactions across multiple locations, allowing the identification of which voice(s) control most of the interactions or support a select few (552). Representations for each voice, including Voice #1, Voice #2, Voice #3, and Voice #C, further visualize the vocal patterns and behaviors associated with each voice in the stalking network. This information enables the system to detect patterns of complicity and conspiring acts, providing detailed insights into the coordination and influence dynamics of stalkers based on location-specific behavior. For instance, which voice controls most others, likely a leader of the pack, or the curbing or calming one, which voices amplify each other in attacks, which voice/s support most of the attack and so forth.

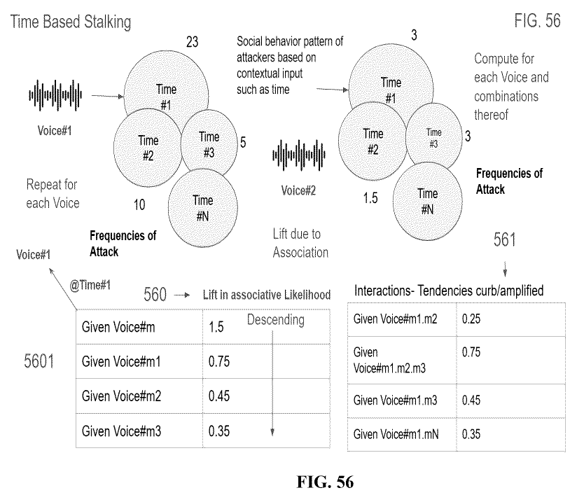

In another example embodiment, as illustrated in FIG. 56, a Modus Operandi Detector for identifying time-based stalking behaviors and influence dynamics between voices is disclosed. The system analyzes how specific voices engage in attacks across different time intervals, capturing frequencies of occurrence and mapping influence patterns. For instance, Voice #1 shows heightened activity at Time #1, with corresponding lift values indicating associative influence on or by other voices. The system computes combinations of voices appearing together across time brackets, populating lift values that quantify the strength of mutual amplification or curbing. FIG. 56-5601 depicts a code snippet to compute the associated lift for a given combination of attacking voices for each location:

```
For voice in voices:
  for location in locations
    {
    combinations=getCombinations(voices,voice)
    for comb in combinations:
      populateLift(voice, comb)
        }
    }
```

Tabular data (560) presents associative likelihoods for each voice, descending from strongest to weakest links, revealing structured interaction tendencies over time. A second analysis layer (561) reveals group-level behavior, identifying how clusters of voices jointly amplify or curb influence during specific periods. This includes interactions including Voice #m1.m2 showing moderate influence (0.25) or Voice #m1.m2.m3 exhibiting higher collaborative tendencies (0.75). These assessments uncover orchestrated and time-sensitive attack patterns. The quantitative representations support visual inspection of temporal behavioral traits per voice. Together, these outputs map recurring time-driven and location driven behaviors and corresponding phenomena of social encouragement or curbing of attacks, enabling detailed behavioral fingerprinting of suspect stalkers.

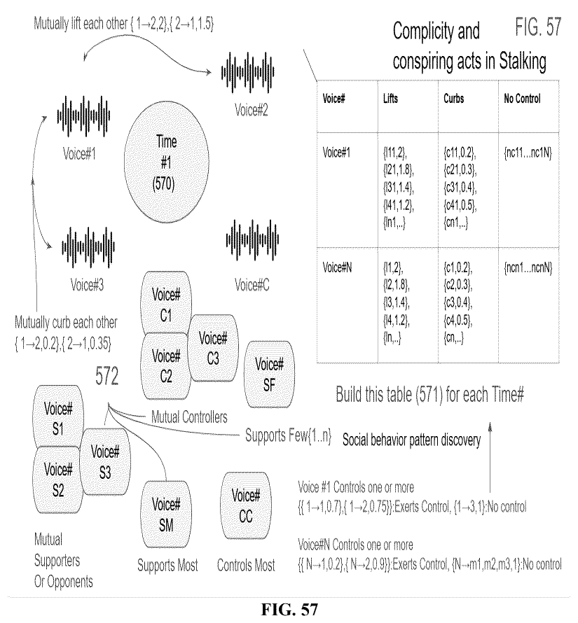

In another example embodiment, as illustrated in FIG. 57, the Modus Operandi Detector for identifying complicity and conspiring acts in stalking based on time-contextual behavior is disclosed. The system analyzes interactions among voices that appear around specific time brackets, focusing on mutual influence through lift, curb, and control dynamics. At Time #1 (570), Voice #1 lifts others including Voice #2 and Voice #21, with quantified values like (1.8, 1.4, 1.2), and curbing (lift magnitude<1) others including Voice #11 and Voice #21 with decreasing influence values. The system builds a detailed matrix (5701) for each time bracket, showing how voices influence or resist each other or maintain neutral positions. Mutual lifting and curbing relationships, including Voice #1 and Voice #2 influencing each other in both directions, revealing coordination or opposition. Patterns of support, opposition, and dominance are derived, including classifications (572) like mutual controllers, supporters of most, or those who control most. Representations for key voices, including Voice #1 through Voice #C, supplement the analysis by illustrating speech behaviors that reinforce these interactions. This enables temporal profiling of voice dynamics and uncovers orchestrated participation, helping detect conspiratorial formations behind recurring attacks.

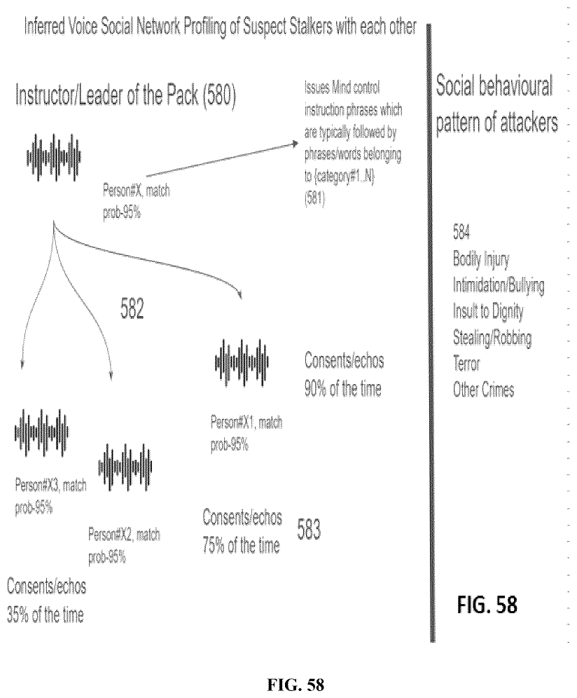

In yet another example embodiment, as illustrated in FIG. 58, a system for detecting coordinated attack patterns using the Modus Operandi Detector is disclosed. The interface presents an inferred voice social network profiling of suspected stalkers, and has recognized one voice as the Instructor (580) or “Leader of the Pack.” This leader (580) is shown to issue mind control instruction phrases (581) that precede phrases belonging to multiple harassment categories (584), including bodily injury, intimidation, insult to dignity, stealing, and terror. Voices labeled as Person #X1, X2, and X3 (582) are shown to echo the instructor's speech at varying consent probabilities—90%, 75%, and 35% respectivelγ-revealed through audio representation alignment for recognizing perpetrator voice uniquely, and semantic similarity to cluster based on nature of attack (583). The display includes directional arrows connecting the leader to followers, as they are discovered through measuring lifts in likelihoods of attacks, in situational context of place, time and activity of targeted person, accompanied by corresponding visuals. This visualization discloses a structured social pattern where the leader's influence triggers coordinated verbal aggression, allowing the system to uncover recurring roles, behavioral consistency, and influence distribution among attacking voices, the modus operandi detector enables mapping of these group dynamics, contributing to a deeper understanding of organized verbal assault strategies

In another embodiment, the reactive intervention unit is operatively connected to the profiling engine and is configured to initiate immediate and adaptive mitigation strategies in response to the detection of high-risk verbal behavior. The reactive intervention unit comprises a real-time response unit, a zap voice logic module, a cognitive firewall, and a timestamping unit. The real-time response unit is configured to automatically initiate instant intervention actions or responses based on the predefined tolerance thresholds that are adaptable based on user feedback, upon the identification of harmful or aggressive speech patterns, enabling prompt disruption of escalating verbal attacks. The zap voice logic module is configured to mute, censor, or block aggressive or harmful audio streams during live communication, which prevents the transmission of abusive content to the target. The zap voice logic module engages when a simultaneous threshold is met by at least two of: tone detection, phrase detection, or pitch modulation metrics. The cognitive firewall is configured to deploy both user defined policy driven rules as well as apply adaptive filtering rules that are dynamically informed by historical abuse patterns and real-time threat assessments, in order to suppress, redirect, or neutralize incoming harmful speech before it reaches the recipient. The Cognitive Firewall intelligently filters and manages incoming communication by identifying and blocking harmful content based on learned patterns, with user protection during interactions. The timestamping unit is configured to automatically mark the start and end points of each verbal abuse incident, storing associated metadata including time, participant identity, and detected behavior type—for forensic analysis and optional reporting and future reference.

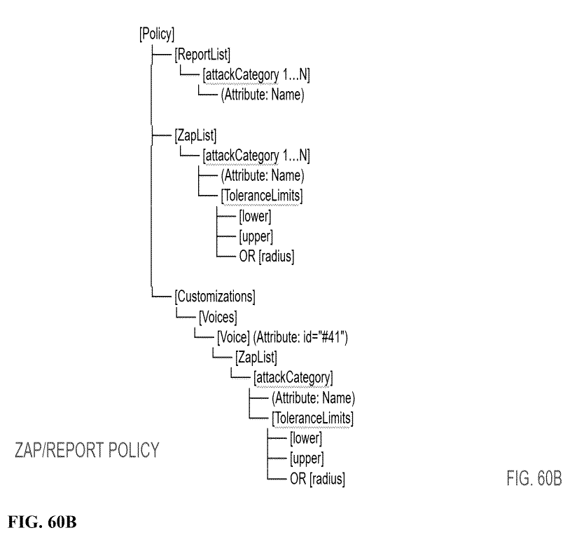

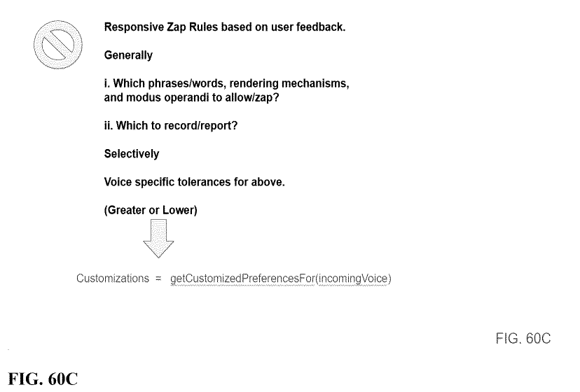

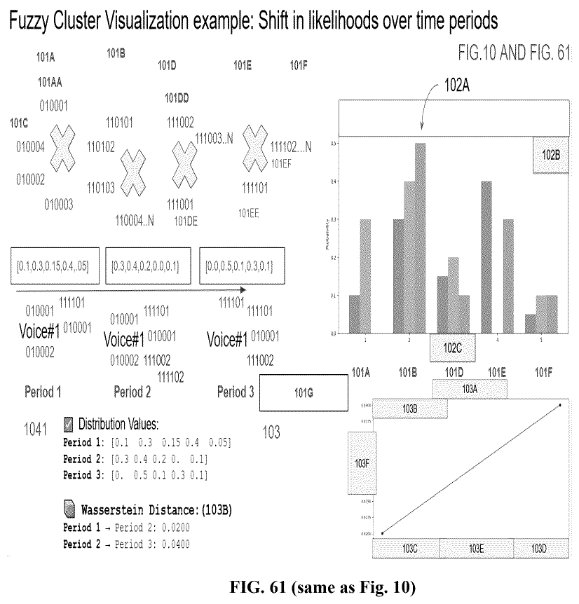

In another example embodiment, as illustrated in FIG. 60(A-C), the cognitive firewall for real-time management of incoming audio streams based on user defined policies, and user feedback provided from time to time, and corresponding customization of preferences is disclosed. The system as depicted in FIG. 60A, monitors audio from any listening device (FIG. 60A—600), including a standalone wearable audio sensor, a smartphone, or smart microphone installed in any wearable device including smart glasses, or earpods, or headphones or any other internet ready audio sensor which is installed externally in private properties of the user and accessible to the user, and applies a layered control mechanism to filter harmful content. FIG. 60B depicts Tthe innermost layer, Responsive Policy-Based Control (FIG. 60B), governs actions based on predefined policies for detecting harmful language or acoustic patterns. These policies are structured in an XML-like format (FIG. 60B) with <ZapList> for muting or blocking harmful speech and <ReportList> for logging and reporting certain categories of verbal attacks. FIG. 60C, depicts how User feedback allows for fine-tuning the system's behavior, including specifying which phrases, corresponding rendering mechanisms and corresponding modus operandi to zap, which to report, and adjusting voice-specific tolerances (FIG. 60C). This results in a highly personalized, responsive firewall that adapts over time to mitigate harmful interactions based on individual preferences and real-time input.

In yet another embodiment, the learning and memory module is operatively connected to all system components and is configured to support adaptive intelligence, continuous system improvement, and long-term behavioral understanding. The learning and memory module comprises an insights database, a predictive simulator, and a query generator. The insights database is configured to store aggregated and structured data collected across the system, including raw audio segments, attack behavioral annotations, contextual tags, and statistical analysis results. This centralized repository serves as the foundational knowledge base for retrospective review, model refinement, and evidence preservation. The predictive simulator is configured to analyze historical behavioral trends and speaker-specific patterns to anticipate and simulate potential future attacks or escalation scenarios, which enables proactive threat management and strategic intervention planning. The predictive simulator uses machine learning algorithms trained on profiles stored in the insights database to identify individuals at elevated risk of recurring verbal aggression, thereby enabling proactive threat management and targeted intervention planning. The query generator is configured to produce context-sensitive questions and prompts that can be used for conversational clarification, real-time profiling enhancement, or triggering internal system updates. The query generator further incorporates large language model (LLM) support to dynamically generate exploratory questions tailored to clarify ambiguous verbal content, improve interpretation accuracy, and assist in deeper behavioral analysis. It essentially generates curated queries that let users explore what kind of verbal attacks to anticipate, how they are expected to be rendered and what methods or cognitive process is used to design such attacks, what is the objective of such attacks and who is most likely to engage in so, during what kind of conversations, given location, time and activity and people in company or alone.

In one example embodiment, a system configured to detect, analyze, and respond to verbal attacks through real-time interruption and intelligent querying, is disclosed. The cognitive firewall identifies hostile utterances by monitoring voice input for phrases, tone, pitch, phonetics and volume patterns mapped to known harassment categories, classifies them, and detects shifts in attack types, frequency, and intensity. It distinguishes between banal and harmful content, captures recurring or alternating patterns, and adapts based on contextual variables including location, time, activity, and whether the target is alone or with others. Simultaneously, voice-specific profiles are maintained, tracking duration of engagement, emotional states expressed, attack variety, and group dynamics, building an evolving attack signature per voice. On detecting aggressive behavior, the system actively suppresses or mutes incoming hostile phrases through selective zapping and recording evidence. The query generator dynamically formulates investigation prompts including “Who targets during work hours using sexual slurs?” or “Which voices escalate attacks when the target is in public?” These queries draw from contextual patterns, voice profiles, and prior incidents to surface relevant recordings and insights. This continuous loop strengthens the system's ability to respond to live threats and extract high-level summaries of aggressor behavior and intent.

In another example embodiment, as illustrated in FIG. 61 (and FIG. 10), a predictive simulator for anticipating future use of harmful language based on historical fuzzy cluster data is disclosed, as illustrated in the FIG. 61 (and FIG. 10). The image presents a fuzzy cluster visualization to track the changing likelihoods of utterances aligning with various offensive categories across different time periods. (103—“ ”) This analysis begins with the categorization of utterances into clusters representing different threat types, including “(101A)—Threats, (101AA—“harm”), “(101B)—Sexual Slurs,” and “(101D)—Disinformation. Where (101DD—“Downplaying Phrase) and (101DE—“Exaggeration Phrase”), and the like. (101C—“Injure”), (101D—“Disinformation”), (101E—“Shaming/Degradation” where 101EE—“Retard”, 101EF—“Fatso”), (101F—“Other Custom Categories”). Individual utterances are then associated with these categories, and the strength of these associations is likely indicated by connecting lines and numerical values (4 vectorized embeddings) or weights attached. Initial probability distributions for some utterances provide a baseline assessment of their likelihood of belonging (1041—“Likelihoods of Voice #1 estimated for belonging to 1 or more categories,”) to each defined category. The core of the visualization focuses on how these likelihoods evolve across three distinct time periods (Period 1, Period 2, Period 3) (102B). The estimated likelihoods for a specific voice (“Voice #1”) belonging to various categories (101A—“Threats”), (101B—“Sexual Slurs”), (101D—“Disinformation”), (101E—“Shaming/Degradation”), (101F—“Other Custom Categories”) are tracked across these time periods (102B) as observations (102C), with corresponding probability distributions (102A) shown for comparison. The “Wasserstein Distance—(103B)” calculation is one way to shift in these probability distributions between successive (103C—“PERIOD 1,2”, 103D—“PERIOD 2,3”) time periods (103E). To further illustrate these changes, a bar chart (102A) compares the probability distributions of a specific utterance across the three periods (102B), and a line graph (103A—“Trend of shift in probability distributions”) visualizes the trend of an utterance's likelihood of belonging to broader categories (101A—“Threats”), (101B—“Sexual Slurs”), (101D—“Disinformation”), (101E—“Shaming/Degradation”), (101F—“Other Custom Categories”) over time. For instance, the bar chart (102A-“Comparison of probability distributions over 3 periods”) shows a steady increase in slurring over 3 successive time periods, while the engagement in disinformation attacks sees a growth and then decline in respective time periods 2 and 3. This comprehensive visualization suggests an underlying system capable of analyzing and categorizing utterances with fuzzy membership, tracking the temporal evolution of these categorizations, and potentially enabling a predictive simulator to forecast future trends in offensive content.

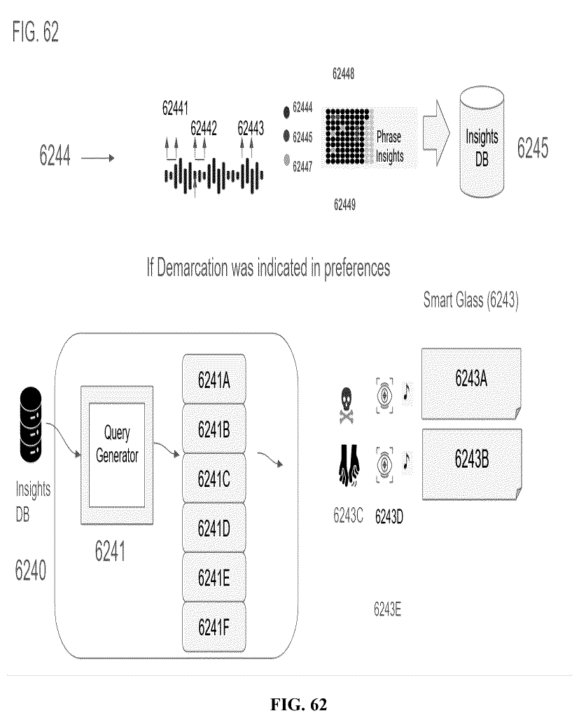

In another example embodiment, as illustrated in FIG. 62, the system incorporates a Insights DB (6240) and query generator (6241) for detecting and responding to harmful behaviors including disinformation, abusive language, sexual slurs, and threats, is disclosed. The image depicts a system for analyzing and presenting potentially harmful verbal attack insights in real time to a user via smart glasses. At its core is an “Insights DB” (6240) storing a variety of data points, including timestamps, user activities, and potentially tagged instances of harmful content. 6244—“{“As on”: “2025-03-27T10: 30:00Z”, “Collected at”: “Location XYZ”, “During Activity”: “Walking”, “Duration”: “00:45:00”, “Gender”: “Male”}' is one example depiction of a collection of such data points in a structured JSON format. A “Query Generator” (641) acts as an intermediary, taking user-defined filters related to attack type (6241A), attack timeline (6241B), rendition (6241C), attack's modus operandi (6241D), theme (6241E), and attack's social behavioral patterns (6241F) to formulate specific queries for the Insights DB (6240). The section on “Demarcation in Preferences” illustrates how different categories of harmful content, including disinformation (62441), sexual slurs (62442), slurs in general (62444) and threats (62443), insults to Dignity (62445) are identified and quantified within a data stream, providing a count for each category and highlighting “Phrase Insights.” The processed insights are then potentially stored in another “Insights DB”—(6240). The “Smart Glass”—(6243) serves as the user interface, featuring an interactive menu bar (6243C) with icons representing different information categories. Users can interact with the smart glasses via gaze or voice activation-(6243-D) to generate curated queries—(6243E), as exemplified by requests to “Play back all the threats I have received today”—(6243A) or to “Play back all the sexual slurs (62442). I have received in the last hour or so”—(6243B) with a contextual filter for phone conversations (6243B—“while I was speaking to someone on phone”). This system enables users to selectively review and understand (62448—“2 counts of disinformation, 1 count of abuse/curse word, 5 counts of sexual slur, 3 counts of threats.”) the harmful content they may have encountered based on various criteria and timeframes, presented directly through a wearable interface.

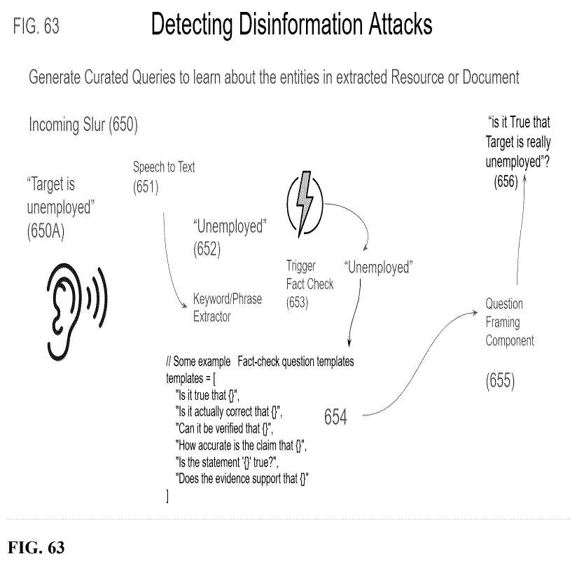

In another example embodiment, as illustrated in FIG. 63, a system for detecting disinformation attacks is disclosed, which focuses on generating curated queries to verify entities mentioned in extracted resources or documents. An “Incoming Slur,” (650) including the phrase “Target is unemployed,”—(650A) is detected and converted into text through a “Speech to Text” process (651), resulting in the phrase “Target is unemployed.” The “Keyword/Phrase Extractor” identifies the keyword “unemployed,” (652) which triggers a “Fact Check” process (653). The Query Generator or question framing component (655) uses predefined “Fact-check Question Templates” (654) to generate specific verification questions. These templates include: “Is it true that [entity]?”, “Is [it] actually correct that [entity]?”, “Can it be verified that [entity]?”, “How accurate is the claim that [entity]?”, “Is the statement ‘[entity]’ true?”, and “Does the evidence support that [entity]?” The placeholder “[entity]” is replaced with the extracted keyword, generating questions including: “Is it true that Target is unemployed?”, “Is it actually correct that Target is unemployed?”, “Can it be verified that Target is unemployed?”, “How accurate is the claim that Target is unemployed?”, “Is the statement ‘Target is unemployed’ true?”, and “Does the evidence support that Target is unemployed?” The Query Generator then frames the specific question: “Is it true that Target is really unemployed?” (656). This question is then used to query knowledge sources, databases, or search engines for evidence to verify the claim, enabling the efficient detection and validation of disinformation.

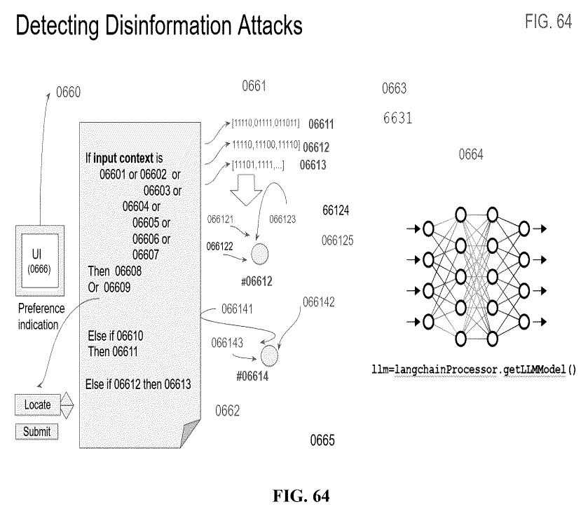

In another example embodiment, as illustrated in the FIG. 64, a system for detecting disinformation attacks by learning facts about a target's life from online sources is disclosed. This figure demonstrates the coordinated operation of several components, including the context classification module, the learning and memory module, and the query generator. The initial step in this disinformation detection strategy revolves around automatically compiling and organizing biographical details about a target individual by leveraging their publicly available social media profiles on platforms including Twitter (06613—“scrape content from (twitter.com/givenName)”), LinkedIn (06608—“scrap from URL: http://LinkedIn.com.in.givenName”), and Facebook (06611—scrape from (facebook.com/givenName or instagram.com/givenName)), alongside any professional experiences or qualifications (06604) they might list. The system determines the appropriate data extraction methods based on the user's specified information needs in the “Instruction Document Generation” phase (0660). For example, professional history (06602) prompts analysis of LinkedIn or resumes, personal details trigger scraping of Facebook or Instagram (06611), and opinions lead to the examination of Twitter content (06613). User interaction occurs through the UI elements (0666) labeled “Preference Indication,” “Locate” (to provide URLs or upload files)—(06609—“show interface to upload Resume”), and “Submit” (to initiate the process). Subsequently, the extracted textual data undergoes a transformation into meaningful numerical representations called “embeddings,” utilizing advanced natural language processing models like Word2Vec and BERT (0661). These embeddings, which capture the semantic essence of the information, are then grouped based on their similarity using clustering algorithms in the “Clustering of embeddings” block (0662). The original documents and their corresponding embeddings are subsequently stored in a “Vector Database” (6) for efficient retrieval and comparison (0663). Finally, the system contemplates integrating with sophisticated “Large Language Models” like OpenAI's offerings (0664), suggesting the potential for these models to further analyze the gathered information for a deeper understanding that can aid in identifying disinformation attacks targeting the individual. Fundamentally, this initial step aims to create a structured and semantically rich profile of the target's life based on their digital footprint (0665), thereby establishing a foundation for the subsequent detection of misleading information.

Here is a complete list of encodings associated with FIG. 64

```
Code | Description
06601 | “Career” or “Job”
06602 | “Work Experience”
06603 | ″Education″
06604 | “Professional Qualification”
06605 | “Certificates”
06606 | “Professional Recommendations”
06607 | “Professional Headline”
06608 | scrap from URL: http://Linkedin.com/in/givenName
06609 | show interface to upload Resume
06610 | input context is “Age”, or “Relationship Status” or “Interests” or
“Gender”
06611 | scrape from (facebook.com/givenName or
instagram.com/givenName)
06611 AND 066143 | → Experience
06612 | input context is “Views” or “Opinions”
06612 | Education
066121 | Certificates
066122 | Accreditations
066123 | Degree/Diploma
066124|from langchain.embeddings
import SentenceTransformerEmbeddins embeddings =
SentenceTransformerEmbeddings (model_name=″all-
MiniLM-L6-v2″)
066125 | OpenAI example
06613 | scrape content from (twitter.com/givenName)
06613 | Skill sets
06614 | Accomplishments
066141 | Number of Years
066142 | Current and Past Designations
066143 | →Experience
06631 | from langchain.vectorstores
    import Chroma
  db = Chroma.from_documents (doc, embeddings)
  db=langchainProcessor.storeVectorizedEmbeddings (docs, e
  mbeddings)
```

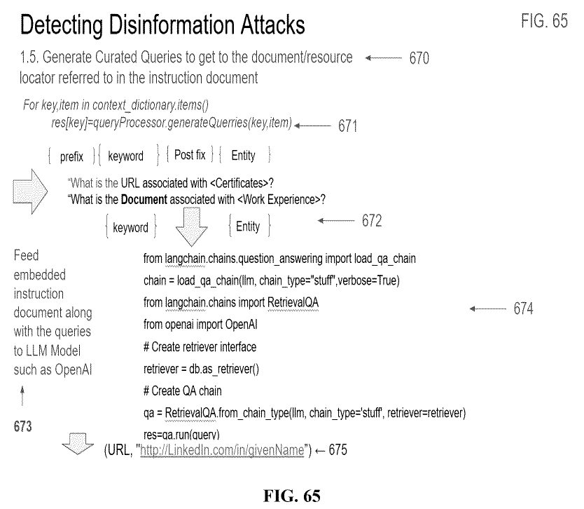

In yet another example embodiment, as illustrated in FIG. 65, a system for generating curated queries to retrieve document/resource locators referenced in an instruction document is disclosed. An instruction document (671), potentially containing disinformative content, is embedded into a format suitable for processing by a Large Language Model (LLM), including OpenAI. Along with this embedded document, initial queries are fed to the LLM. The Query Generator iterates through a context dictionary, where for each key and item, it generates queries that are stored in a result dictionary. These queries are structured based on predefined templates, including: “{Prefix} What is the URL associated with {Keyword}<Certificates>? {Postfix} {Entity}” and “{Keyword} What is the Document associated with {Entity}<Work Experience>?” (672) The system then uses the Langchain libraries, including a retrieval mechanism with a vector database like Chroma (674), to search for relevant information based on semantic similarity. The Query Generator produces queries that, when executed, return relevant document locators, including a LinkedIn URL (675) associated with a specific entity (e.g., “givenName”).

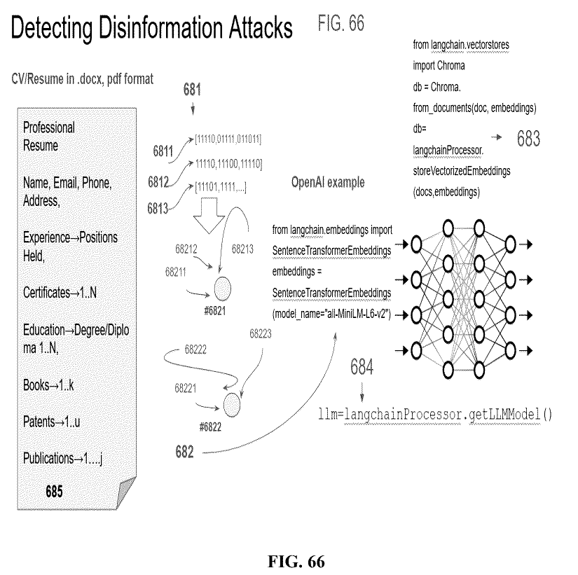

In another example embodiment, as illustrated in the FIG. 66, a system for detecting disinformation attacks through learning facts about a target's life, when social media data is restricted, is disclosed. This figure demonstrates the coordinated operation of several components, including the Context Classification Module, the Learning and Memory Module (Insights Database), and the potential use of Large Language Models (LLMs). When access to social media is not available, the system turns to digital or scanned documents, including a CV or resume (680), provided by the target. The Context Classification Module, through its Life Category Detector and Contextual Information Aggregator, processes the document to extract relevant information including name, contact details, job experience, education, and other qualifications. The Learning and Memory Module stores this extracted data (683) and its semantic embeddings in the Insights Database, enabling efficient retrieval and comparison. Using NLP models like BERT (681), the extracted text is converted into semantic embeddings, and similar information is clustered based on their cosine similarity (682). The system can also leverage LLMs (684) to reason over the information, inferring key facts about the target's history. This fallback mechanism ensures that even in the absence of social media profiles, the system can still gather factual data to build a baseline for detecting disinformation in future interactions (685).

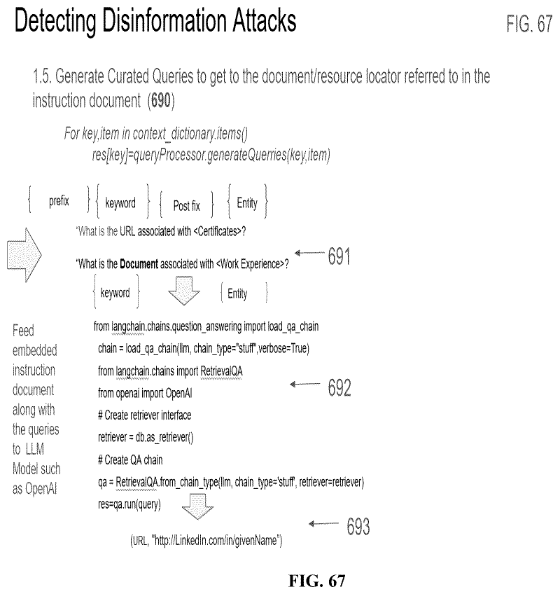

In another example embodiment, as illustrated in FIG. 67, a system for detecting disinformation attacks is disclosed, wherein the Query Generator is configured to generate curated queries for retrieving document or resource locators referred to within an embedded instruction document (690). The system accepts an instruction document that includes references to entities or claims and processes it using a large language model (LLM), including OpenAI. The Query Generator iterates through contextual elements extracted from the embedded document and constructs queries using predefined templates, including formats including “What is the URL associated with [Keyword]<Certificates>?” and “What is the Document associated with [Entity]<Work Experience>?”. These queries are executed through a retrieval mechanism powered by Langchain and a vector database like Chroma (691). The retriever interface semantically matches the generated queries against stored content, and a QA chain processes the results to return relevant document locators. For instance, the system may output a LinkedIn profile URL (e.g., “http://LinkedIn.com/in/givenName”) (693) corresponding to an entity mentioned in the instruction document. This embodiment demonstrates the system's ability to transform ambiguous or unverified claims into targeted queries that retrieve supporting documents, facilitating validation and deeper analysis in the context of disinformation detection.

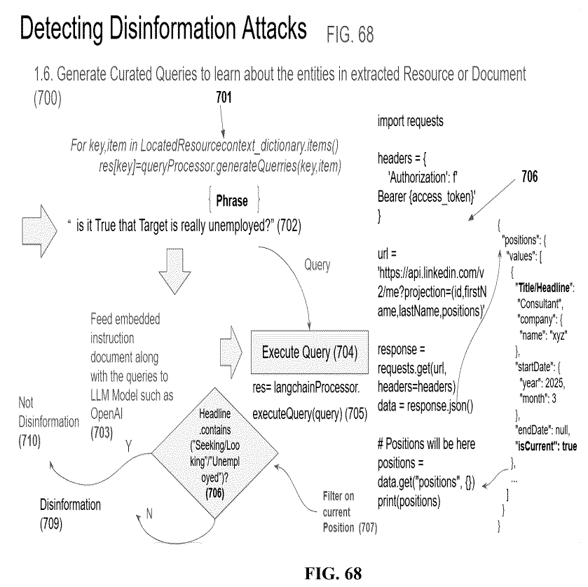

In another example embodiment, as illustrated in the FIG. 68, a system for detecting disinformation attacks through the generation and execution of curated queries to verify claims about a target's life is disclosed. The system performs the disinformation detection process to actively verify information about entities identified in earlier analysis. It involves “Generate Curated Queries” (700), where the system, as shown in the code (701), formulates specific questions based on a dictionary of contextual information using a queryProcessor. An example query (702) is, “is it True that Target is really unemployed?”. This query (703), along with the embedded instruction document (704), is then processed by a Large Language Model (LLM) (705). The “Execute Query” block (704) signifies the sending of this targeted question to an external data source, often through an API (706), including the demonstrated interaction with the LinkedIn API to retrieve employment history. The resulting data (711) is then filtered to focus on the “Filter on Current Position” (707). A conditional check (708) examines the job title (“Headline”) for indicators of unemployment, like “StillLooking” or “Unemployed”. The presence of such terms (709) suggests potential disinformation, while their absence (710) leads to a classification of not disinformation for this specific check. The core function of this step is to validate claims about entities by querying external sources and applying logical rules to detect inconsistencies.

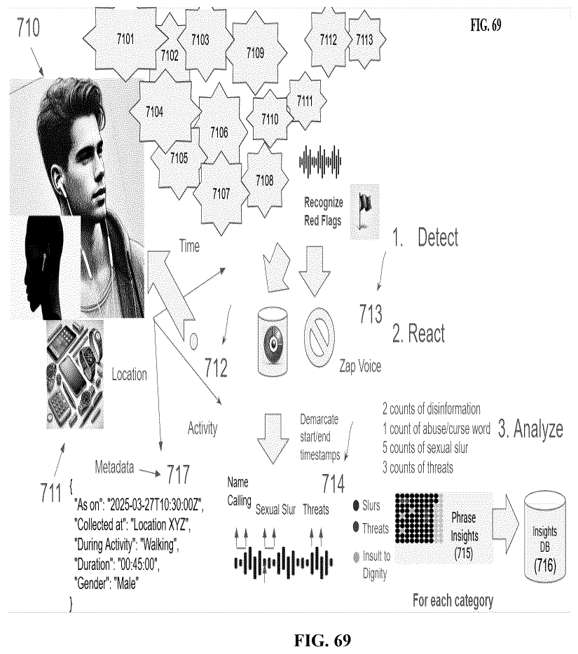

In another example embodiment, a three-stage process—detection, reaction, and analysis—that enables real-time monitoring, intervention, and evaluation of harmful verbal attacks using integrated audio processing and behavior analysis modules, is disclosed, as illustrated in the FIG. 69. In the detection phase, verbal attacks are captured through wearable audio sensors connected to the audio processing unit, which digitizes the incoming stream (711—Audio Sensors installed in a plurality of consumer electronics and household/workplace devices). The voice detector and attack behavior detection module analyze this input to identify red flags based on categories including identity fraud, hate speech (7101), body shaming (7103), disinformation (7109), threats (7113), mocking (7108), sexual slurs (7111), insults to dignity (7110) and the like (712). This detection leverages tone, pitch, volume, phrase patterns, and emotional cues. When a harmful signal is recognized, the reaction phase is initiated through the Zap Voice Logic Module, which automatically suppresses, censors, or blocks the offensive content (713). Simultaneously, the Timestamping Unit demarcates the incident's beginning and end. In the analysis phase, the system forwards the flagged segment to the Data Analytics and Visualization Engine, which correlates it with contextual metadata including time, location, inferred user activity (e.g., walking or calling), and user demographics. Visualizations—including annotated representation and category heatmaps—highlight harmful elements including “name calling” or “sexual slurs.” (714). The Phrase Insights Dashboard (715) displays a temporal breakdown of attack categories—including threats (7113), insults to dignity (7110), and sexual slurs (7111)—mapped against corresponding audio segments, offering insight into both intensity and timing. The insights generated include statistical summaries, including frequency and type of verbal abuse (e.g., 2 disinformation events, 5 sexual slurs), and are stored in the Insights Database (716) for profile updating and future predictions by the Profiling Engine, contributing to long-term behavioral mapping and threat forecasting. Here is a complete list of encodings and corresponding description as depicted in FIG. 69.

### Encoding—Description

711—Audio Sensors installed in plurality of consumer electronics and household/workplace devices
7101—Identity Based/Hate/Derogatory/Incendiary Phrases
7102—Alternation
7103—Body Shaming
7104—Enchanting Repetitions/Reinforcements
7105—Instructions/Commands
7106—Mind Control
7107—Reward/Punishments
7108—Mockery
7109—Disinformation
7110—Insult to Dignity
7111—Sexual Slurs
7112—Terror
7113—Threats

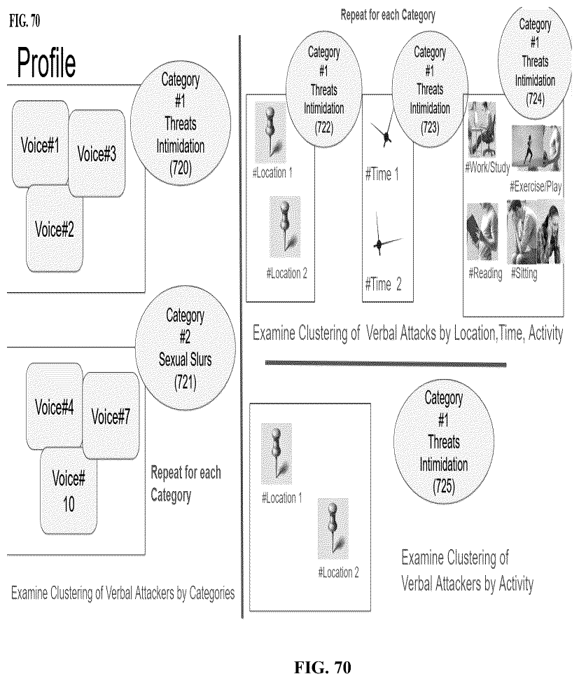

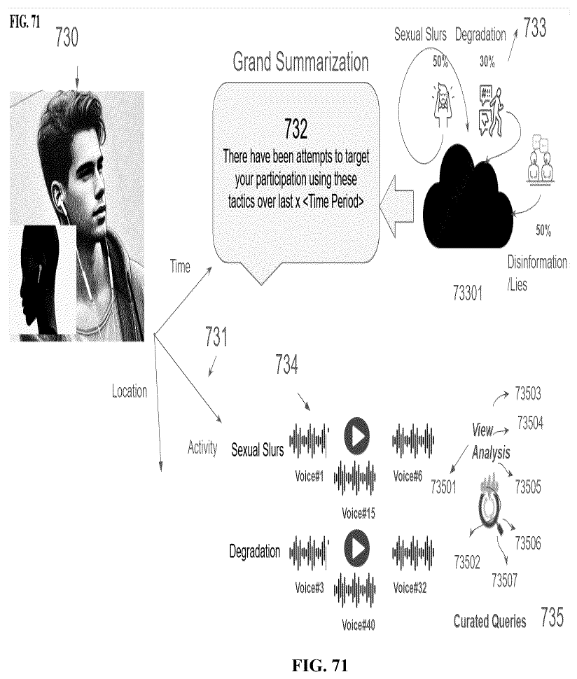

In another example embodiment, as illustrated in FIG. 70, a system for profiling verbal attackers based on the categories of harmful behavior and associated context is disclosed. The profiling engine, through its profile management module, clusters voice samples by attack type-including grouping Voices #1, #3, and #2 under “Threats and Intimidation,” (720) and Voices #4, #7, and #10 under “Sexual Slurs.” (721) Simultaneously, it associates each attack category with context data-including occurrences by location (e.g., #Location 1, #Location 2) (722), time (e.g., #Time 1, #Time 2) (723), and activity (e.g., Work/Study, Exercise/Play) (724, 725)—using insights from the Learning and Memory Module. The Data Analytics and Visualization Engine facilitates the analysis and graphical depiction of these clusters, revealing patterns of behavior across environments. This profiling process is repeated across all categories to generate behavioral profiles for each identified aggressor.

In an example embodiment, as illustrated in FIG. 71, a system for Grand Summarization of detected attacks (732) is disclosed, wherein the system identifies attempts to target the user through various attack tactics over a specified time frame (hours, days, weeks, months, or years). The system categorizes attacks into Sexual Slurs, Degradation, and Disinformation, visualized with icons and percentages in a cloud shape (733). For instance, Sexual Slurs account for 50%, Degradation for 30%, and Disinformation for 50%, with the total exceeding 100%, indicating overlapping attack types. The Contextual Attribution section explains the likelihood of these attacks based on user activity, location, and time, including higher frequencies in the workplace or at home, or when speaking with someone. The system provides Activity-Specific Examples, displaying labeled audio representation linked to specific attacks, with voices identified (734) during incidents of Sexual Slurs or Degradation. Through the Insights Database, the system accesses historical data to uncover patterns across various attacks, correlating them with time, location, and activity to further enhance understanding. The User Interface presents these insights to the user in an intuitive and accessible way, allowing them to interact with the data through visualizations, adjust settings, and view specific attack scenarios. Additionally, Curated Queries (735) are generated to guide the user in further investigation, with tailored questions like “Who harasses you when you are speaking to someone and how?”, “Who shames you when you are doing exercise or eating outside? And how?”—(73502), “Who are your relationship stalkers?”—(73503). “Who are you wealth/earnings stalkers?”—(73504), “Who harasses you when you work?”—(73505) or “Who threatens you when eating outside?” or “Who issues you threats?—(73507)”, or “Who harasses you when you are at home and how?—(73506)” These insights empower users to identify specific perpetrators, contexts, and recurring attack patterns, offering a comprehensive view (50% attribution to Spreading Disinformation (20% of the time) or Sexual Slurs (30% of the time) or Degradations (50% of the time) particularly when you are speaking or talking to someone. (2 times more likely than any other activity), and when you are at the workplace (5 times more likely), in public places (5 times more likely) or at home. (10 times more likely) of verbal attacks over time.

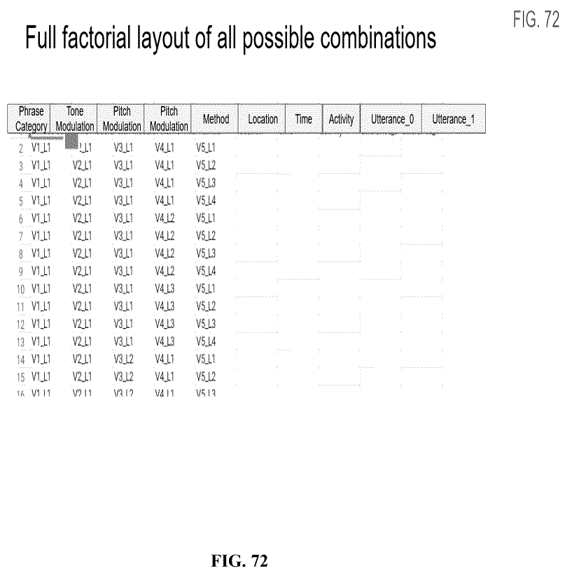

In another example embodiment, as illustrated in FIG. 72, a system for synthesizing verbal attack patterns using a full factorial layout of behavioral features is disclosed. The image presents a tabular structure in which each column represents a distinct factor-including phrase category (attack type detector), tone modulation (tone detector), pitch (pitch detector), volume (volume detector), and specific modus operandi methods (modus operandi detection module), along with contextual data from the context classification module (location, time, and activity). each row enumerates a unique combination of these features, forming the foundation for a factorial attack layout. The Modus Operandi Synthesizer analyzes these combinations to identify frequently co-occurring patterns that define an aggressor's predictive signature. By aggregating such combinations across interactions, the system forecasts likely future verbal aggression scenarios, enabling proactive behavioral analysis. All combinations and outcomes are stored and evaluated using data from the Learning and Memory Module

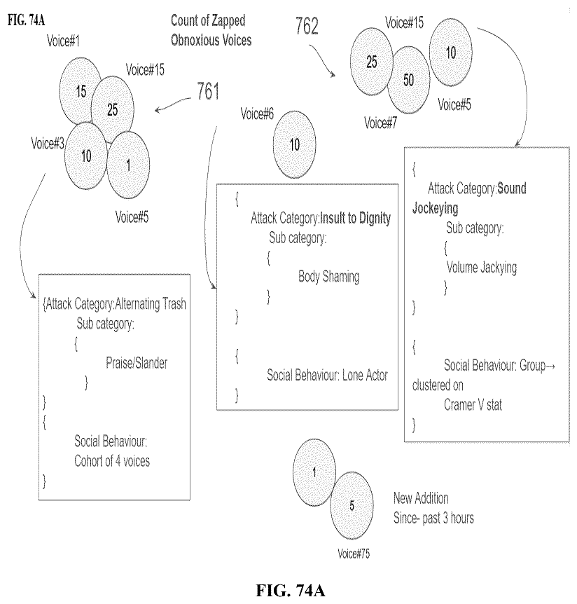

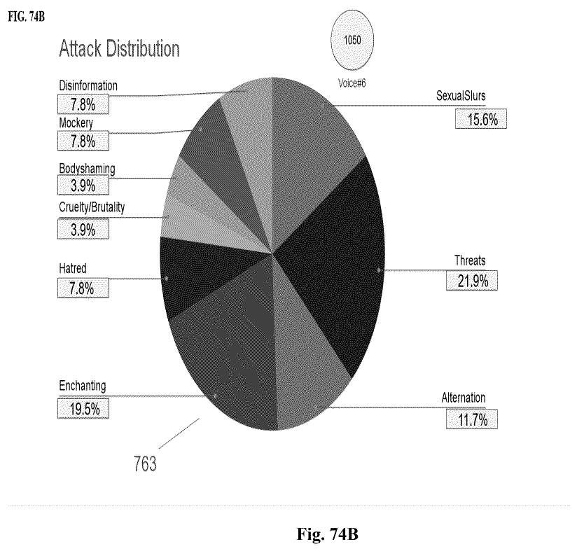

In another example embodiment, as illustrated in the figure, the Cognitive Firewall integrating selective audio profiling to enhance the handling of verbal attacks in real time, is disclosed, as illustrated in FIG. 74. The system contrasts a “blindly zapping all” method (760), where voices are indiscriminately muted or blocked, with a more refined approach based on detailed attack profiling. FIG. 74A further depicts Tthe visualization (761) illustrates a traditional method where voices like Voice #1, Voice #3, and Voice #15 are zapped due to frequent obnoxious behaviors, including alternating insults and trash talk. The visualization (762) a selective intervention strategy, where each attack is analyzed based on profiling data, including attack type (e.g., insults, sound jockeying), social context (e.g., lone actor or group behavior), and individual attack histories. By considering the nature and context of attacks, the cognitive firewall allows for more targeted interventions, minimizing the collateral effects of indiscriminate blocking and ensuring that harmful behaviors are addressed more effectively. The “Attack Distribution” pie chart as depicted in FIG. 74B (74B-763) visualizes the proportion of different types of attacks originating from habitual offenders. Each colored segment of the pie represents a specific category of harmful behavior, including “Threats,” “Sexual Harassment,” “Slurs,” “Alternation,” and others labeled around the chart. The size of each segment corresponds to the percentage or frequency of that particular attack type within the overall distribution of attacks from these habitual offenders. This provides a clear overview of which forms of harmful behavior are most prevalent among this group. The label “Habitual Attackers” and the associated high number “1050” emphasize that this distribution pertains to individuals with a history of repeated offenses.

In yet another embodiment, a user interface system is operatively connected to the learning and memory module and the reactive intervention unit and is configured to facilitate user interaction, system awareness, and real-time responsiveness. The user interface system comprises a wearable device display, an interactive menu bar, and a cross-platform interface. The wearable device display is configured to present visual and/or auditory alerts to a user through smart wearable devices, including but not limited to smart glasses or smartwatches. This display shows context-specific, color-coded alerts that correspond to severity levels determined by the attack type detection unit, enabling discreet and immediate awareness of potentially harmful verbal attacks. The interactive menu bar is configured to allow users to review recorded incidents, initiate playback of flagged audio segments, categorize behavioral patterns, and configure system preferences and thresholds based on their needs. The cross-platform interface is configured to support real-time monitoring and access to historical data from various devices, including mobile phones, desktop systems, or other integrated environments.

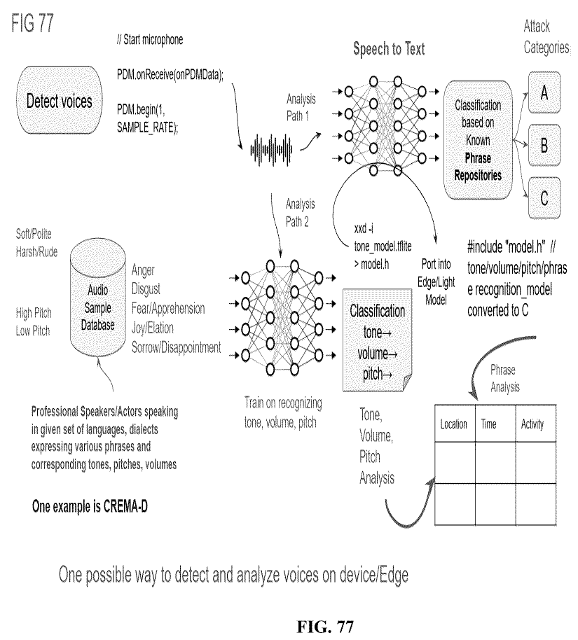

In another example embodiment, as illustrated in the FIG. 77, the system utilizes a TinyML-based firmware interface to process voice inputs on edge devices. The system detects voices (790) by initiating microphone input (791) with specified parameters. The incoming audio (792) is then processed through two parallel analysis paths. One path performs Speech to Text conversion (792), and the resulting text is classified based on known phrase repositories (794) associated with defined Attack Categories (A, B, C). The other path analyzes tone, volume, and pitch (796) using a neural network (792) trained on these vocal characteristics. An Audio Sample Database (793) containing diverse vocal expressions and emotions aids in training these models. Ultimately, Phrase Analysis (795) appears to integrate the textual classification with contextual information like location, time, and activity for a more comprehensive assessment of potential attacks.

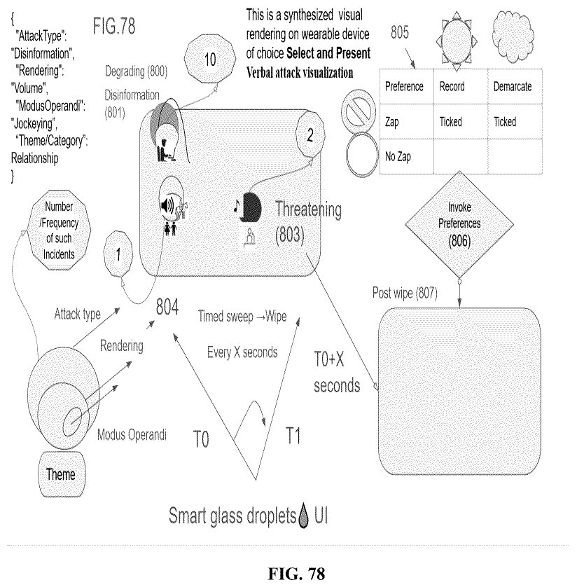

In another example embodiment, as illustrated in the FIG. 78, a visual rendering for the “Select and Present” stage of verbal attack detection is shown on smart glasses. The smart glass UI (814) displays a synthesized visual rendering (807) for presenting verbal attack visualizations. The central display area (802) shows categories of verbal attacks: “Degrading” (800) with a count of “10,” “Disinformation” (801) with a count of “1” and details (804) like attack type and modus operandi, and “Threatening” (803) with a count of “2.” Icons (801, 806) represent these attack types visually. A preference table (809) indicates user settings for handling attacks, with “Zap,” “Record,” and “Demarcate” currently enabled (“Ticked”). The system invokes these preferences (806), which likely affect the “Post wipe” state (807) of the display. A timed visual sweep or wipe effect (816) refreshes the UI periodically (every X seconds). The characteristics of an attack break down into “Attack type,” “Rendering,” “Modus Operandi,” and “Theme” (815). Overall, the smart glass interface actively presents and manages verbal attack information based on user preferences and a timed display refresh.

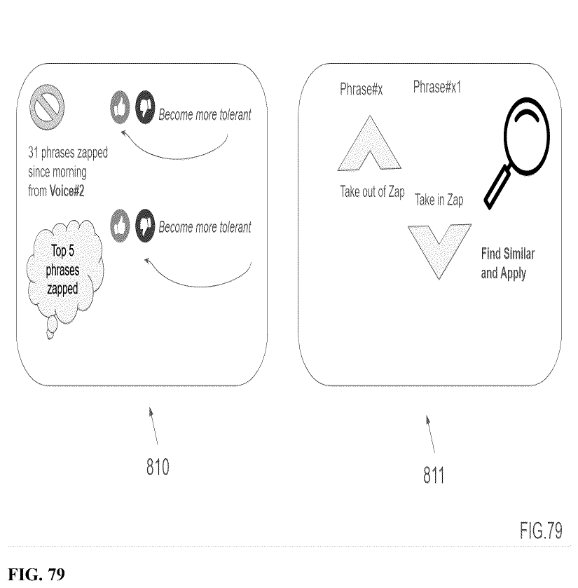

In yet another example embodiment, as illustrated in the FIG. 79, an interface for managing “zapped” phrases and adjusting tolerance levels is disclosed. The left panel (810) displays a summary of phrases automatically muted or removed by the system, with options to adjust tolerance for specific voices. A feedback mechanism allows users to express whether the system should be more lenient or stricter on certain voices, with “thumbs-up” and “thumbs-down” icons to indicate user satisfaction with present level of tolerance. The panel also provides transparency by listing the top 5 phrases that were blocked. The right panel (811) offers more granular control, allowing users to manage individual zapped phrases. It includes options to “take out of zap” or “take in zap,” letting users adjust specific phrases as needed. Additionally, a “Find Similar and Apply” feature allows users to apply the zapping rule to similar phrases, ensuring more efficient management of abusive language patterns. This system supports a feedback loop, where user input helps refine the detection process and ensure the system adapts to user preferences, preventing over-blocking and maintaining effectiveness.

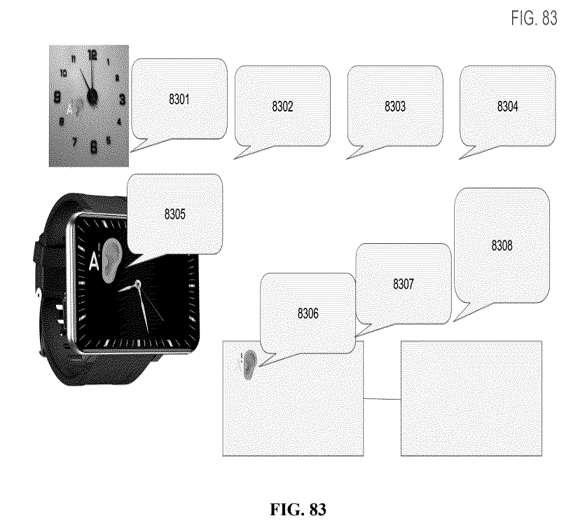

In yet another example embodiment, as illustrated in the FIG. 83, the system provides fragmented, context-driven insights to the user through a series of notifications or summaries. The insights are visualized on a device like a smartwatch, offering real-time feedback on verbal attacks. The system tracks the frequency of phonetic attacks, noting patterns in the user's activities, social context, and location. For instance, a statistic might show that 25% of attacks (8301—“Generally you have suffered from phonetic attacks 25% of the time”). happen during phone calls or meetings (8302—“About 25% of them occur when you are speaking on the phone, or attending a meeting”), with a higher likelihood of occurrence when the user is alone (8303—“3 times more likely to happen when you are alone rather than with someone else.”), or in a specific location (8304—“Twice more likely to happen when you are in Location #X versus elsewhere”). The system also highlights dominant types of attacks, including phrases attempting to imply intoxication or sleaze in normal conversations (8305—“65% of the attacks are using phrases that seek to infuse intoxication, inebriation or sleaze in normal conversations”), and identifies specific instances, like a suggestive remark (8307—“When you are at the sea, at 4 μm today, a suggestive remark of “see yeah” was heard”) made at a particular time and place. The insights also track recent events, including a series of phonetic attacks or degrading references (8308—“When you uttered “morning”, a suggestive remark of “moaning” or a different meaning word of “mourning” was heard in reply 3 days ago at 11 am”). within a short time frame. Additionally, the system detects potential misinterpretations or malicious alterations of the user's speech, offering detailed contextual information about the event, including time and location. This collection of insights (8306—“5 phonetic attacks in last 20 mins. 3 degrading references. All were meant to change interpretation”) is presented in a snackable manner, providing clear, relevant, and timely information and allowing the user to understand the nature and context of attacks.

A method of a multifaceted and comprehensive system for detecting, analyzing, and responding to harmful verbal attacks, as illustrated in the FIGS. 2 and 3 comprises the steps of:

### Step 1: Voice Detection

a) the audio processing unit captures ambient verbal attacks and digitizes them into real-time audio streams.
b) the voice detector analyzes the digitized audio to isolate distinct voice signatures and differentiate between individual speakers.

### Step 2: Voice Identification and Grouping

c) Profile Management Module checks each isolated voice against entries in the Insights Database to determine if the voice matches a known profile.
c1) If the voice matches an existing voice signature in the Insights Database, the profile management module associates the detected voice with the corresponding existing profile, grouping it under a known identity.
c2) if the voice is not found in the database, the profile management module generates a new unique voice ID, where a new voice profile is initialized in the Insights Database with associated time, location, context, and any immediate behavioral markers, which is now available for future comparison and behavioral aggregation

### Step 2A: Person Differentiation and Identity Correlation

c3) the speaker identification module processes isolated voice signatures to identify and distinguish individual speakers using unique vocal characteristics.
c4) the aggressor-target differentiation module classifies each speaker as either an aggressor or a target based on verbal content, tone patterns, user feedback including situational cues, and any previously recorded behavioral history.
c5) the voice signature matcher compares the live voice data with stored profiles to determine if the speaker is a recurring participant in past flagged interactions.
c6) the speaker role tracker logs any changes in speaker behavior, including transitions between aggressor and target roles within a conversation.
c7) the identity correlation engine associates speaker identities with contextual metadata including device ID, location, timestamps, and environment data, enabling tracking and context-aware behavior modeling.

### Step 3: Attack Content Analysis

d) the red flag recognizer scans the voice segments for predefined verbal abuse indicators including threats, slurs, and harassment patterns.
e) the phrase detector identifies psychological abuse markers or intent-based trigger words from the speech content.
f) the tone detector classifies the emotional undertone including anger, sarcasm, mockery and the like, based on speech inflection and sentiment analysis.
g) the pitch detector evaluates pitch frequency modulations to detect manipulative or escalating vocal behavior.
h) the volume detector measures amplitude variations to flag yelling, loud speech, or forceful tone shifts indicative of aggression.

### Step 4: Contextual Categorization

i) the life category detector determines whether the interaction relates to personal, professional, social, or transactional contexts based on semantic and behavioral cues
j) the contextual information aggregator collects additional metadata including timestamp, location, environmental conditions, and whether the target is alone or in company.

### Step 5: Tactical Pattern Analysis

k) Modus Operandi Detection Module compares the detected verbal characteristics against known behavioral patterns including phrase repetition, Emotional alternation, sarcasm, mind control techniques.
l) the sound jockeying detector evaluates interruptions, vocal dominance, and overlapping or riding on pitch, volume and tone for controlling or locking on or intimidating or thwarting targeted person's communication.
m) the pitch/frequency and phonetic modulation detects erratic, exaggerated, echoing, or contradictory shifts in vocal frequency and articulation patterns associated with emotional destabilization, manipulation, or mockery, and applies filtering to isolate or suppress segments exhibiting such modulations.
n) the volume Modulation Detector identifies volume surges intended to overpower or intimidate.
o) the tone modulation analyzer highlights emotionally incongruent expressions like mockery or disdain or opposite sentiment use inflation elation at sorrow or respect at loss.
p) the repetition detector tracks harmful repetitive phrases indicating verbal conditioning or harassment.
q) the mockery detector identifies exaggeration as well as belittlement patterns using tonal shifts and sentiment reversals.
r) the mind control behavior analyzer spots subconscious control language including repeated directives or reinforcement loops.
s) the alternation detector monitors pitch/tone flipping used to confuse or destabilize.

### Step 6: Social Dynamics Evaluation

t) the social behavior mapper maps out aggression patterns to determine if the speaker is acting alone, following or supporting others, or leading a coordinated verbal attack, also whether such voice is curbing attacks by others instead.

### Step 7: Cross-Reference and Contextual Alignment

u) the modus operandi synthesizer aggregates behavioral cues and compares them with theme-specific repositories including but not limited to workplace abuse, financial stalking, relationship aggression.
v) the attack type detection unit classifies the verbal interaction into a specific attack type using a combination of linguistic, acoustic, and behavioral features.
w) the attack rendering detection unit determines the structural delivery of the verbal attack, identifying escalation or jockeying tactics.

### Step 8: Profile Update and Learning

x) the profile management module updates the voice profile in the Insights Database with new or dropped attack types, role transformation including lone actor to group leader, drift or escalation in modus operandi, associated metadata including location, time, context.

### Step 9: Response and Intervention

y) the real-time response unit initiates mitigation if harmful behavior crosses critical thresholds including send alert, report to law enforcement, and isolate/flag voice.
z) the zap voice logic module mutes or filters aggressive audio segments in real-time based on policy configurations.
aa) the cognitive firewall applies adaptive rules to suppress, delay, or redirect abusive speech patterns dynamically.
bb) the timestamping unit logs the start and end of each verbally aggressive incident, linked to voice ID and context metadata.

### Step 10: Knowledge Building and Forecasting

cc) the insights database stores audio segments, annotations, metadata, and behavioral models for learning and reporting.
dd) the predictive simulator analyzes historical trends from voice profiles to forecast future behavior, and present in real time, including potential escalation.
ee) the query generator prepares context-driven queries to help refine future recognition, profiling, and user feedback loops.

### Step 11: User Notification and Interaction

ff) the wearable device display provides real-time alerts and incident information on smart glasses or watches.
gg) the interactive menu bar enables manual review, feedback, categorization, and configuration by the user.
hh) the cross-platform interface allows access to real-time alerts and historical logs across smartphones, desktops, or other connected devices.

This invention provides multiple advantages in detecting, analyzing, and mitigating harmful verbal attacks in real time. Its comprehensive behavioral analysis integrates multiple detection modules including tone, pitch, and volume-providing nuanced insights into verbal aggression. By incorporating contextual data like location and activity, the system enhances detection accuracy and adapts to various environments, profiling allows for ongoing monitoring of aggressors and targets, improving predictive capabilities. The user-centric interface delivers real-time alerts through wearable devices, empowering users to manage interactions effectively. Additionally, the adaptive learning module continuously refines the system based on historical data, while multi-platform support ensures accessibility across devices. Predictive modeling forecasts potential future attacks, enhancing user safety and well-being. Overall, the system promotes a safer communication environment by effectively addressing harmful verbal attacks and allowing for customizable user experiences tailored to individual preferences.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, and the embodiments herein have been described in terms of preferred embodiments, those skilled in the art will recognize that the embodiments herein can be practiced with modification within the spirit and scope of the embodiments as described herein.

1. A multifaceted and comprehensive system for detecting, analyzing, and responding to harmful verbal attacks, comprising:
a wearable device intended/adapted to be worn by a user; and
a computing device having a controller and a memory for storing one or more instructions and a plurality of modules executable by the controller,
wherein,
the wearable device and the computing device are in communication with a server via a network, the controller is configured to execute the one or more instructions to perform operations using the plurality of modules,
wherein the plurality of modules and detectors include
a sound acquisition unit, comprising:
an audio processing unit that includes at least one microphone and a signal digitization circuit configured to capture verbal attacks in real time and convert them into digital audio streams;
a voice detector communicatively coupled to the audio processing unit, configured to isolate and identify distinct voice signatures to distinguish between aggressors and targets within the captured audio stream;
an attack behavior detection module operatively connected to the sound acquisition unit, comprising:
a red flag recognizer configured to scan incoming audio data for predefined verbal abuse indicators, including threats, slurs, disinformation, or harassment patterns;
a phrase detector configured to detect trigger words or phrases associated with psychological abuse or harmful intent;
a tone detector configured to extract and classify emotional tone features including anger, sarcasm, or fear from the audio data;
a pitch detector configured to analyze frequency modulation in voice signals to detect manipulative or escalating vocal behavior;
a volume detector configured to monitor amplitude fluctuations and measure loudness trends over time for identifying yelling or aggressive voice modulation;
a context classification module operatively connected to the attack behavior detection module, comprising:
a life category detector configured to determine whether the conversation pertains to personal, professional, or social contexts based on semantic and behavioral cues;
a contextual information aggregator configured to retrieve and correlate metadata from internal or external sensors, including time stamps, geolocation, and environmental noise context;
a person detector, operatively connected to the sound acquisition unit and attack behavior detection module, comprising:
a speaker identification module configured to detect and differentiate individual speakers based on unique voice characteristics;
an aggressor-target differentiation module configured to classify speakers as aggressors or targets based on verbal patterns, tone, and historical data;
a voice signature matcher configured to match detected voiceprints against stored profiles to identify repeat individuals;
a speaker role tracker configured to monitor and record role changes during interactions;
an identity correlation engine configured to associate speaker identities with contextual metadata including device identifiers, timestamps, and geolocation;
a data analytics and visualization engine operatively connected to the attack behavior detection module, configured to analyze and categorize the data to detect trends, patterns, and variations in behavior, and visualize these insights to support interpretation and decision-making, wherein, the engine further comprises
a computational unit configured to execute clustering algorithms, trend analysis, and outlier detection based on temporal and behavioral patterns;
a statistical engine configured to perform various types of associative and correlation analysis, odds ratio calculation to identify relationships between target's contextual variables and aggressive voice attack behaviors;
a profiling engine operatively connected to the data analytics and visualization engine, comprising:
a profile management module configured to generate, update, and maintain behavior profiles for identified aggressors and targets, including recorded speech history and behavioral markers;
a modus operandi detection module configured to detect repeated aggression tactics used by an individual, including phrase repetition, pitch alternation, jockeying for vocal dominance, echoing, and mocking, comprising:
a sound jockeying detector configured to identify overlapping, interruptive, or dominance-seeking vocal behavior by analyzing timing overlaps, escalation in voice volume, and speaker transition patterns;
a pitch/frequency and phonetic modulation analyzer configured to detect aggressive or erratic shifts in pitch, frequency, and phonetic articulation, including alternations in pronunciation, enunciation, or speech clarity indicative of sarcasm, mocking, disguise, or emotional destabilization;
a volume modulation detector configured to measure loudness variations and abrupt fluctuations, detect volume surges used to overpower the target, and analyze speaker-target volume interactions to infer vocal dominance attempts;
a tone modulation analyzer configured to assess the emotional tone of speech through sentiment analysis, tone gradient shifts, and detection of emotionally incongruent expressions including sarcasm or mockery;
a repetition detector configured to detect repeated phrases, commands, insults, or name-calling patterns, utilizing lexical frequency models and historical utterance matching to identify harassment intent or cognitive conditioning strategies;
a mockery detector configured to identify patterns of belittlement, sarcasm, and exaggeration by analyzing vocal tone, pitch alternations, sentiment polarity reversals, and emotionally mismatched responses;
a mind control behavior analyzer configured to detect the use of subconscious control language, including repeated directive statements, imperative phrasing, and linguistic reinforcement tactics intended to dominate or manipulate the target's behavior;
an alternation detector configured to detect high-frequency pitch and tone shifts indicative of destabilizing or confusing communication patterns, including forced empathy reversal or emotional manipulation;
a social behavior mapper configured to detect patterns of social cohort formation, including leader-follower aggression dynamics, mutual encouragement in group-based harassment, and lone actor behavior analysis;
a modus operandi synthesizer configured to aggregate detected behavioral features across interactions to build a predictive signature of each aggressor's verbal attack strategies, and to forecast likely future patterns or escalation based on distributional behavior modeling and factorial attack layouts;
an attack rendering detection unit, configured to identify the structure and delivery of verbal attacks, including escalation patterns and aggression-rendering tactics based on linguistic, tonal, and behavioral data;
an attack type detection unit configured to classify the nature of the verbal attack using linguistic, acoustic, and behavioral feature sets;
a reactive intervention unit operatively connected to the profiling engine, comprising:
a real-time response unit configured to initiate immediate mitigation responses upon detection of high-risk verbal behavior;
a zap voice logic module configured to mute, censor, or block aggressive or harmful audio streams during live communication;
a cognitive firewall configured to apply adaptive filtering rules based on historical abuse patterns and live threat levels to suppress or divert incoming harmful speech;
a timestamping unit configured to automatically demarcate the start and end of verbal abuse incidents and store metadata for each occurrence;
a learning and memory module operatively connected to all system components, comprising:
an insights database configured to store aggregated and structured data, including raw audio segments, behavioral annotations, contextual tags, and statistical results;
a predictive simulator configured to analyze historical trends and speaker behavior to anticipate future attacks or escalation scenarios;
a query generator configured to produce context-sensitive questions and prompts for use in conversational clarification, profiling, or system updates;
a user interface system operatively connected to the learning and memory module and the reactive intervention unit, the user interface system comprising:
a wearable device display configured to present visual and/or auditory alerts to a user on a smart wearable including glasses or a smartwatch;
an interactive menu bar configured to allow users to review incidents, initiate playback, categorize flagged behavior, and configure system settings;
a cross-platform interface configured to support real-time monitoring and historical data access from mobile devices, desktops, or integrated systems.

2. The multifaceted and comprehensive system as claimed in claim 1, audio processing unit further comprises a directional microphone array configured to isolate voices in multi-speaker environments and reduce background noise.

3. The multifaceted and comprehensive system as claimed in claim 1, wherein the query generator incorporates large language model support to dynamically form exploratory questions for clarification of ambiguous verbal content.

4. The multifaceted and comprehensive system as claimed in claim 1, wherein the real-time response unit automatically initiates responses based on predefined thresholds for harmful verbal behavior, thereby enhancing user safety.

5. The multifaceted and comprehensive system as claimed in claim 1, the wearable device screen displays context-specific color-coded alerts corresponding to severity levels determined by the attack type detection unit.

6. The multifaceted and comprehensive system as claimed in claim 1, wherein the predictive simulator uses machine learning algorithms trained on profiles stored in the insights database to identify individuals at elevated risk of recurring verbal aggression.

7. The multifaceted and comprehensive system as claimed in claim 1, wherein the zap voice logic module engages when a simultaneous threshold is met by at least two of: tone detection, phrase detection, pitch or phonetic modulation metrics.

8. The multifaceted and comprehensive system as claimed in claim 1, wherein the context classification module includes a geolocation input that dynamically adjusts behavioral thresholds based on location-specific risk factors.

9. The multifaceted and comprehensive system as claimed in claim 1, wherein the Cognitive Firewall intelligently filters and manages incoming communication by identifying and blocking harmful content based on learned patterns, with user protection during interactions.

10. The multifaceted and comprehensive system as claimed in claim 1, wherein the voice detector decomposes audio into tone, pitch, phonetics, volume, and content for filtering, identity matching, and profiling.

11. The multifaceted and comprehensive system as claimed in claim 1, wherein the data analytics and visualization engine employ statistical methods, including variety of associative and correlation techniques and logistic regression, to analyze the relationship between contextual factors and the likelihood of different types of verbal attacks.

12. A method of a multifaceted and comprehensive system for detecting, analyzing, and responding to harmful verbal attacks, comprising the steps of:
a) capturing ambient verbal attacks and digitizing them into real-time audio streams via the audio processing unit.
b) analyzing the digitized audio to isolate distinct voice signatures and differentiate individual speakers using the voice detector.
c) checking each isolated voice against entries in the insights database to determine if the voice matches a known profile using the profile management module.
c1) associating the detected voice with a corresponding existing profile if a match is found in the insights database.
c2) generating a new unique voice ID and initializing a new voice profile with associated time, location, context, and behavioral markers if no match is found.
c3) identifying and distinguishing individual speakers using unique vocal characteristics via the speaker identification module.
c4) classifying each speaker as an aggressor or target based on verbal content, tone patterns, behavioral cues, and past behavior using the aggressor-target differentiation module.
c5) comparing live voice data with stored profiles to detect recurring participants in past flagged interactions using the voice signature matcher.
c6) tracking changes in speaker behavior, including transitions between aggressor and target roles using the speaker role tracker.
c7) correlating speaker identities with contextual metadata including device ID, location, timestamps, and environmental data using the identity correlation engine.
d) scanning voice segments for predefined verbal abuse indicators, including threats, slurs, and harassment patterns using the red flag recognizer.
e) identifying psychological abuse markers or intent-based trigger words using the phrase detector.
f) classifying emotional undertones including anger, sarcasm, or mockery using the tone detector.
g) evaluating pitch frequency modulations to detect manipulative or escalating vocal behavior using the pitch detector.
h) measuring amplitude variations to flag yelling, loud speech, or forceful tone shifts using the volume detector.
i) determining the interaction category including personal, professional, social, or transactional, using the life category detector.
j) collecting additional contextual metadata including timestamp, location, environmental conditions, and whether the target is alone or accompanied using the contextual information aggregator.
k) comparing detected verbal characteristics against known behavioral patterns including phrase repetition, emotional alternation, sarcasm, and mind control using the modus operandi detection module.
l) evaluating interruptions, vocal dominance, and overlapping speech to detect controlling behavior using the sound jockeying detector.
m) detecting erratic pitch or frequency shifts linked to emotional destabilization using the pitch/frequency modulation analyzer.
n) identifying volume surges intended to intimidate or overpower using the volume modulation detector.
o) highlighting emotionally incongruent expressions including mockery or disdain using the tone modulation analyzer.
p) tracking harmful repetitive phrases indicating verbal conditioning or harassment using the repetition detector.
q) identifying belittlement patterns using tonal shifts and sentiment reversals via the mockery detector.
r) spotting subconscious control language, including repeated directives or reinforcement loops using the mind control behavior analyzer.
s) monitoring pitch or tone flipping used to confuse or destabilize using the alternation detector.
t) mapping aggression patterns to determine whether a speaker is acting alone, following others, or leading a coordinated attack using the social behavior mapper.
u) aggregating behavioral cues and comparing them with theme-specific repositories including workplace abuse, financial stalking, relationship aggression using the modus operandi synthesizer.
v) classifying the verbal interaction into a specific attack type using combined linguistic, acoustic, and behavioral features via the attack type detection unit.
w) determining the structural delivery of the attack, including escalation and jockeying tactics using the attack rendering detection unit.
x) updating the voice profile with new or dropped attack types, role transformations, behavioral trends, and metadata using the profile management module.
y) initiating mitigation actions including sending alerts or isolating voices when thresholds are crossed using the real-time response unit.
z) muting or filtering aggressive audio segments in real time based on policy rules using the zap voice logic module.
aa) applying adaptive rules to suppress, delay, or redirect abusive speech using the cognitive firewall.
bb) logging the start and end of each verbally aggressive incident linked to voice ID and context using the timestamping unit.
cc) storing audio segments, annotations, metadata, and behavioral models for ongoing learning and reporting using the insights database.
dd) analyzing historical voice profile trends to forecast future behavior using the predictive simulator.
ee) preparing context-driven queries to refine recognition, profiling, and user feedback loops using the query generator.
ff) providing real-time alerts and incident information on smart glasses or watches via the wearable device display.
gg) enabling manual review, feedback, categorization, and user configuration via the interactive menu bar.
hh) allowing access to real-time alerts and historical logs across devices using the cross-platform interface.

13. The method of claim 12, wherein analyzing the digitized audio further comprises
a) isolating speech from overlapping speakers using a directional microphone array;
b) applying noise reduction algorithms to improve voice signal clarity before processing by the voice detector.

14. The method of claim 12, wherein scanning voice segments for predefined verbal abuse indicators comprises:
a) using machine learning techniques to adaptively improve the red flag recognizer's ability to detect new forms of verbal abuse based on historical interaction data.
